(19) United States
(12) Patent Application Publication
(10) Pub. No.: US 2026/0035093 A1
(43) Pub. Date: Feb. 5, 2026

(54) VEHICLE FOR TOWING AIRCRAFT

(71) Applicant: Oshkosh Corporation, Oshkosh, WI (US)

(72) Inventors: Nick Heemskerk, Oshkosh, WI (US); William Lunt, Oshkosh, WI (US)

(73) Assignee: Oshkosh Corporation, Oshkosh, WI (US)

(21) Appl. No.: 19/287,408

(22) Filed: Jul. 31, 2025

Related U.S. Application Data
(60) Provisional application No. 63/678,258, filed on Aug. 1, 2024.
(60) Provisional application No. 63/678,358, filed on Aug. 1, 2024.
(60) Provisional application No. 63/678,301, filed on Aug. 1, 2024.
(60) Provisional application No. 63/678,429, filed on Aug. 1, 2024.
(60) Provisional application No. 63/678,412, filed on Aug. 1, 2024.
(60) Provisional application No. 63/678,368, filed on Aug. 1, 2024.
(60) Provisional application No. 63/678,353, filed on Aug. 1, 2024.
(60) Provisional application No. 63/678,267, filed on Aug. 1, 2024.
(60) Provisional application No. 63/678,219, filed on Aug. 1, 2024.
(60) Provisional application No. 63/678,404, filed on Aug. 1, 2024.
(60) Provisional application No. 63/678,424, filed on Aug. 1, 2024.

(51) Int. Cl. B64F 1/18; B64F 1/225

(52) U.S. Cl. CPC B64F 1/18; B64F 1/225

(57) ABSTRACT

A vehicle for towing an airplane includes a chassis, a body coupled to the chassis, the body and the chassis having a first side and a second side opposite the first side, a tractive assembly, a tow mechanism configured to engage with a nose landing gear of the airplane, a light system including a first lighting element positioned along the first side and a second lighting element positioned along the second side, and a control system configured to monitor a direction of travel of the vehicle and control operation of the light system to selectively illuminate the first lighting element and the second lighting element to provide an indication of the direction of travel of the vehicle, thereby making the direction of travel of the vehicle perceivable to an operator positioned outside of the vehicle.

### CROSS-REFERENCE TO RELATED PATENT APPLICATIONS

This application claims the benefit of and priority to (a) U.S. Provisional Patent Application No. 63/678,219, filed Aug. 1, 2024, (b) U.S. Provisional Patent Application No. 63/678,258, filed Aug. 1, 2024, (c) U.S. Provisional Patent Application No. 63/678,267, filed Aug. 1, 2024, (d) U.S. Provisional Patent Application No. 63/678,301, filed Aug. 1, 2024, (e) U.S. Provisional Patent Application No. 63/678,353, filed Aug. 1, 2024, (f) U.S. Provisional Patent Application No. 63/678,358, filed Aug. 1, 2024, (g) U.S. Provisional Patent Application No. 63/678,368, filed Aug. 1, 2024, (h) U.S. Provisional Patent Application No. 63/678,404, filed Aug. 1, 2024, (i) U.S. Provisional Patent Application No. 63/678,412, filed Aug. 1, 2024, (j) U.S. Provisional Patent Application No. 63/678,424, filed Aug. 1, 2024, and (k) U.S. Provisional Patent Application No. 63/678,429, filed Aug. 1, 2024, all of which are incorporated herein by reference in their entireties.

### BACKGROUND

A tow vehicle or tractor is typically used to tow an aircraft by coupling to a nose landing gear of the aircraft.

### SUMMARY

One embodiment relates to a vehicle for towing an airplane. The vehicle includes a chassis, a body coupled to the chassis, the body and the chassis having a first side and a second side opposite the first side, a tractive assembly, a tow mechanism configured to engage with a nose landing gear of the airplane, a light system including a first lighting element positioned along the first side and a second lighting element positioned along the second side, and a control system configured to monitor a direction of travel of the vehicle and control operation of the light system to selectively illuminate the first lighting element and the second lighting element to provide an indication of the direction of travel of the vehicle, thereby making the direction of travel of the vehicle perceivable to an operator positioned outside of the vehicle.

Another embodiment relates to a vehicle system. The vehicle system includes one or more processing circuits configured to monitor a direction of travel of a tow vehicle configured to tow an airplane. The tow vehicle includes a body having a first side and a second side opposite the first side, a first lighting element positioned along or proximate the first side of the body, and a second lighting element positioned along or proximate the second side of the body. The one or more processing circuits are configured to selectively illuminate the first lighting element and the second lighting element to provide a first indication of the direction of travel of the tow vehicle and a second indication of a mode of operation of the tow vehicle.

Still another embodiment relates to an airport ground support equipment. The airport ground support equipment includes a chassis, a body coupled to the chassis, a front tractive assembly, a rear tractive assembly, a light system, and a control system. The body and the chassis have a first side and a second side opposite the first side. At least one of the front tractive assembly or the rear tractive assembly is a steerable tractive assembly. The light system includes a first lightbar extending longitudinally along the first side between the front tractive assembly and the rear tractive assembly, and a second lightbar extending longitudinally along the second side between the front tractive assembly and the rear tractive assembly. The first lightbar includes a first housing and a first plurality of lights disposed within the first housing. The second lightbar includes a second housing and a second plurality of lights disposed within the second housing. The control system is configured to monitor a direction of travel of the airport ground support equipment and control operation of the light system to selectively illuminate the first lightbar in a first color or pattern and the second lightbar in a second color or pattern to provide an indication of the direction of travel of the airport ground support equipment.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a tractor towing an airplane, according to an exemplary embodiment.

FIG. 2 is a front, left perspective view of the tractor of FIG. 1, according to an exemplary embodiment.

FIG. 3 is a detailed rear, left perspective view of a seating area of the tractor of FIG. 2, according to an exemplary embodiment.

FIG. 4 is a detailed view of the seating area of FIG. 3, according to an exemplary embodiment.

FIG. 5 is a detailed view of a capture system of the tractor of FIG. 2, according to an exemplary embodiment.

FIG. 6 is a perspective view of the airplane supported by and coupled with the tractor of FIG. 1 using the capture system of FIG. 5, according to an exemplary embodiment.

FIGS. 7-9 show various views of a tractor without an occupant seating area and having a hands-free capture system, according to an exemplary embodiment.

FIGS. 10-14 show various views of the hands-free capture system of FIGS. 7-9, according to an exemplary embodiment.

FIG. 15 is a top view of a cam slot of the hands-free capture system of FIGS. 7-9, according to an exemplary embodiment.

FIG. 16 is a bottom view of a retention cutout of the hands-free capture system of FIGS. 7-9, according to an exemplary embodiment.

FIG. 17 is a side view of the hands-free capture system of FIGS. 7-9 in a lifted position, according to an exemplary embodiment.

FIGS. 18 and 19 show top views of the hands-free capture system of FIGS. 7-9 including a side-shift actuator, according to an exemplary embodiment.

FIGS. 20 and 21 show front views of the hands-free capture system of FIGS. 7-9 tilting about atilt axis, according to an exemplary embodiment.

FIG. 22 is a side view of the hands-free capture system of FIGS. 7-9 including a tilt actuator, according to an exemplary embodiment.

FIG. 23 is a perspective view of the hands-free capture system of FIGS. 7-9 receiving a nose landing gear, according to an exemplary embodiment.

FIGS. 24-29 show various views of the hands-free capture system of FIGS. 7-9 capturing a nose landing gear with a first size, according to an exemplary embodiment.

FIGS. 30-35 show various views of the hands-free capture system of FIGS. 7-9 capturing a nose landing gear with a second size, according to an exemplary embodiment.

FIG. 36 is a schematic block diagram of the tractor of FIGS. 1 and 7-9, according to an exemplary embodiment.

FIG. 37 is a schematic illustration of a side view of the tractor of FIGS. 7-9 including a linkage lift assembly, according to an exemplary embodiment.

FIG. 38 is a schematic illustration of a top view of the tractor of FIGS. 7-9 including a linkage lift assembly, according to an exemplary embodiment.

FIG. 39 is a schematic illustration of a side view of the tractor of FIGS. 7-9 including a scissor lift assembly, according to an exemplary embodiment.

FIG. 40 is a schematic illustration of a top view of the hands-free capture system of FIGS. 7-9 including a torque sensor, according to an exemplary embodiment.

FIG. 41 is perspective view of the hands-free capture system of FIGS. 7-9 including a rear gate assembly and torque sensors, according to an exemplary embodiment.

FIG. 42 is a schematic illustration of a side view of the hands-free capture system of FIG. 38, according to an exemplary embodiment.

FIG. 43 is a schematic block diagram of the tractor with the hands-free capture system of FIGS. 37-39, according to an exemplary embodiment.

FIG. 44 is a schematic block diagram of the tractor with the hands-free capture system of FIGS. 7-9 including pressure sensors, according to an exemplary embodiment.

FIG. 45 is perspective view of the hands-free capture system of FIGS. 7-9 including a tilt actuator assembly, according to an exemplary embodiment.

FIG. 46 is schematic illustration of the tilt actuator assembly of FIG. 45, according to an exemplary embodiment.

FIG. 47 is schematic block diagram of the hands-free capture system of FIGS. 7-9 including the tilt actuator assembly of FIG. 45, according to an exemplary embodiment.

FIG. 48 is a perspective view of an aircraft recognition system, according to an exemplary embodiment.

FIG. 49 is a block diagram of a method for recognizing an aircraft, according to exemplary embodiments.

FIG. 50 is a schematic block diagram of the tractor of FIGS. 2 and 7-9, according to exemplary embodiments.

FIG. 51 is a block diagram of a method for operating the tractor of FIGS. 2 and 7-9 as the tractor approaches an aircraft, according to exemplary embodiments.

FIG. 52 is a block diagram of a method for operating the tractor of FIGS. 2 and 7-9 as the tractor captures a nose landing gear, according to exemplary embodiments.

FIG. 53 is a block diagram of a method for operating the tractor of FIGS. 2 and 7-9 as the tractor moves the aircraft, according to exemplary embodiments.

FIG. 54 is a schematic illustration of the tractor of FIGS. 2 and 7-9 autonomously operating during a pushback or return operation, according to exemplary embodiments.

FIG. 55 is a block diagram of a system for remotely controlling operation of the tractor of FIGS. 2 and 7-9, according to an exemplary embodiment.

FIG. 56 is a sequence diagram illustrating communication between components of the system illustrated in FIG. 55, according to an exemplary embodiment.

FIGS. 57 and 58 are rear views of the tractor of FIGS. 2 and 7-9 including a light system, according to an exemplary embodiment.

FIGS. 59 and 60 are left, side views of the tractor of FIGS. 2 and 7-9 including the light system of FIGS. 57 and 58, according to an exemplary embodiment.

FIG. 61 is a side view of the light system of FIGS. 57 and 58, according to an exemplary embodiment.

FIG. 62 is a flowchart of a method for collision avoidance, according to an exemplary embodiment.

FIG. 63 is a depiction of an airport showing a variety of airport objects having associated airport beacons, according to an exemplary embodiment.

FIG. 64 is a depiction of a display device showing a graphical user interface associated with the method for collision avoidance of FIG. 62, according to an exemplary embodiment.

FIG. 65 is a schematic representation of a GSE coordination system, according to an exemplary embodiment.

FIG. 66 is a schematic representation of GSE used to service or support an airplane and airport operations, according to an exemplary embodiment.

FIG. 67 is a schematic representation of the GSE of FIG. 66 in communication via a server, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

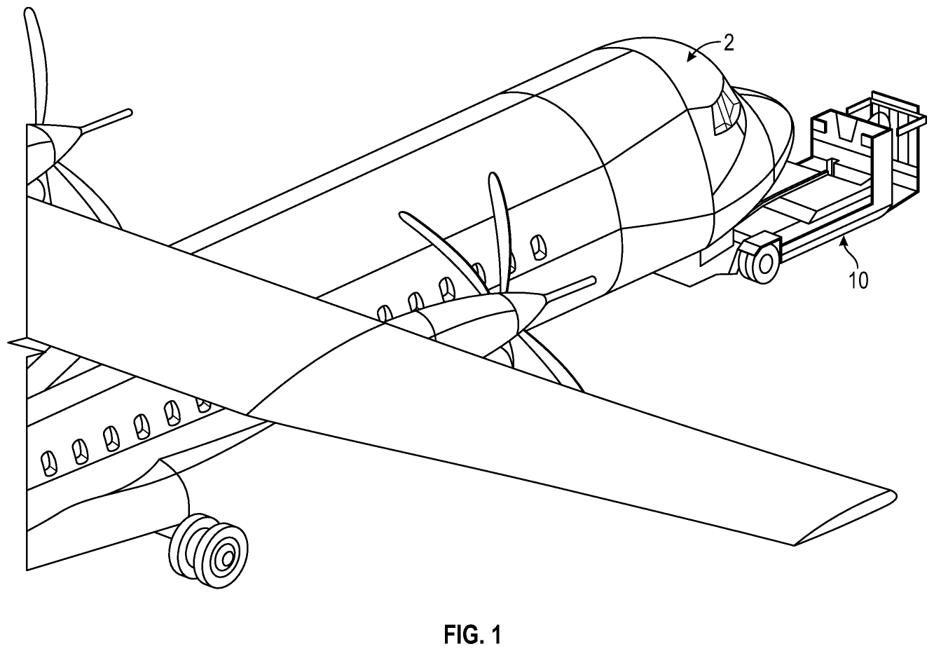

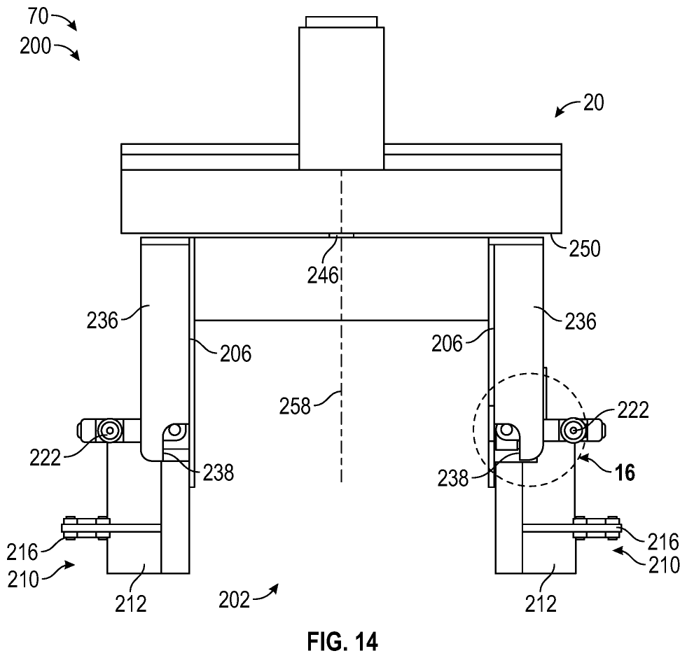

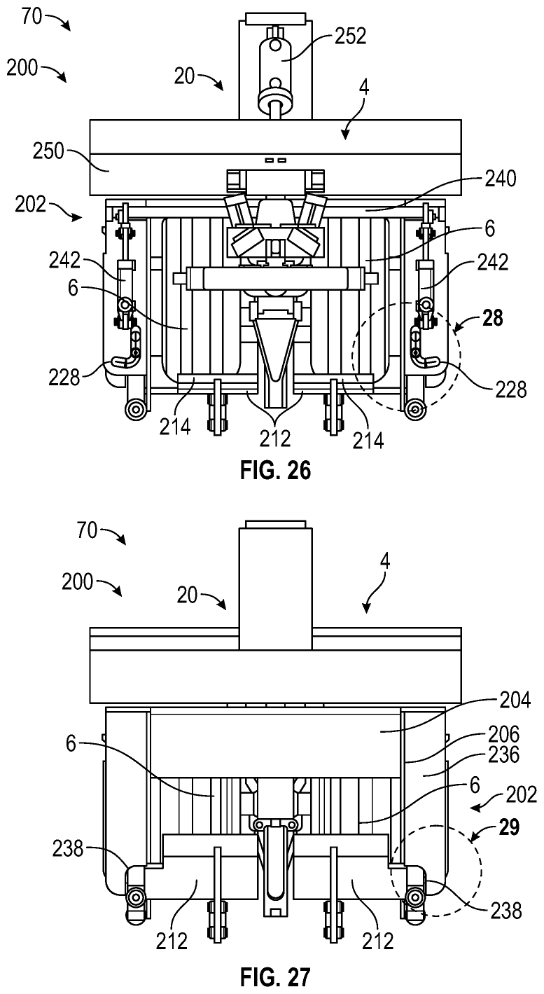

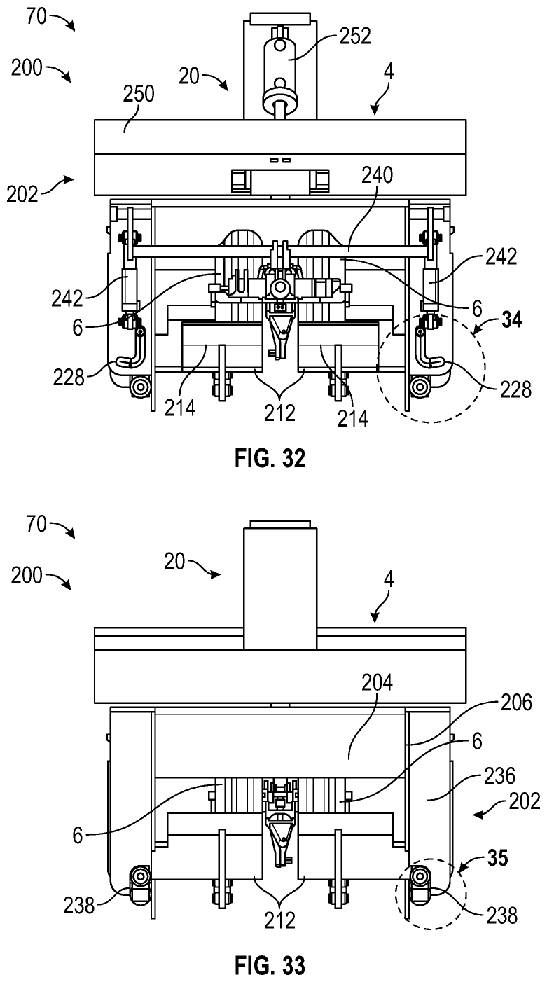

As shown in FIGS. 1-36, a tow vehicle (e.g., an aircraft tow vehicle, a tow-bar-less tow vehicle, an aircraft tractor, etc.), shown as tractor 10, is configured to couple with and support at least a portion (e.g., a nose gear, a landing gear, a nose landing gear, etc.) of an aircraft, show as airplane 2, to tow, pushback, or otherwise manipulate the airplane 2. According to an exemplary embodiment, the tractor 10 is used for one or more operations at an airport including pushing the airplane 2 during pushback operations (e.g., departing from a gate), towing the airplane 2 between locations (e.g., between gates, hangars, fueling areas, maintenance areas, de-icing areas, etc.), positioning the airplane 2 (e.g., into proper alignment at a gate with a bridge), and/or other operations.

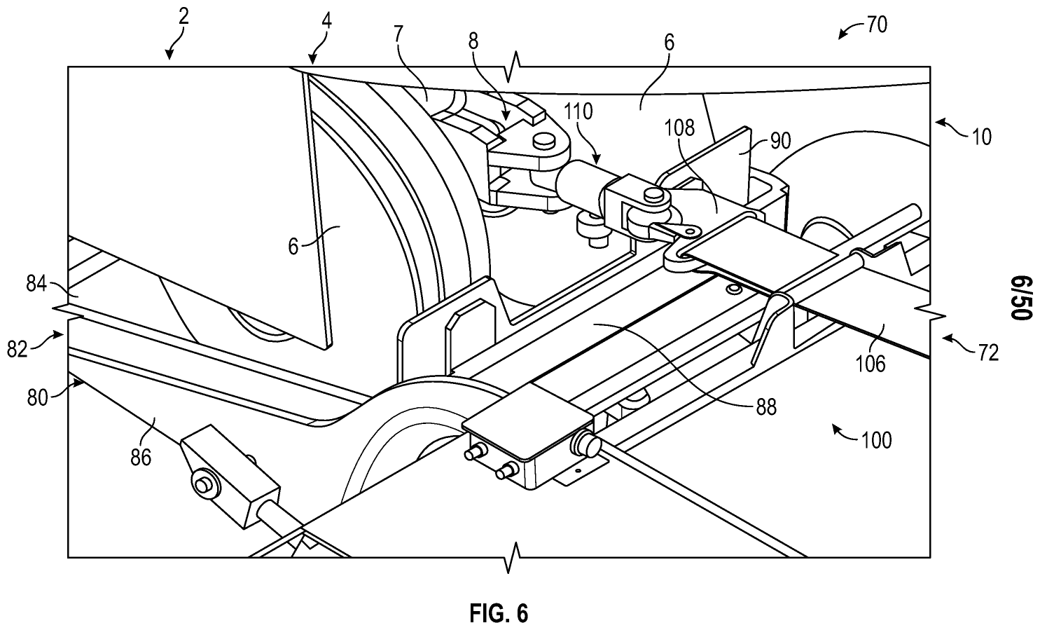

As shown in FIG. 6, the airplane 2 includes a nose gear assembly, shown as nose landing gear 4. The nose landing gear 4 includes two tractive elements, shown as wheels 6, and a shaft member (e.g., a strut, post, rod, etc.), shown as pivot 7, coupled between the wheels 6 and a fuselage of the airplane 2. The wheels 6 are rotatably coupled with the pivot 7 and are configured to engage a ground surface (e.g., tarmac, road, etc.). The nose landing gear 4 is steerable to facilitate steering the airplane 2. In some embodiments, the nose landing gear 4 includes more or fewer than two wheels 6. As shown in FIG. 6, the nose landing gear 4 includes a securing element (e.g., a mechanical linkage, a towing adapter, a tow ball, a hook, a tow eye, etc.), shown as tow element 8, coupled with the pivot 7, and configured to facilitate a coupling between the nose landing gear 4 and the tractor 10 (e.g., the winch-capture system 72). In some embodiments, the nose landing gear 4 does not include the tow element 8 and coupling between the nose landing gear 4 and the tractor 10 is accomplished in another manner (e.g., by a coupling between the wheels 6 and the winch-capture system 72 and/or the hands-free capture system 200, directly between the pivot 7 and the tractor 10 by securing a strap around the pivot 7, etc.).

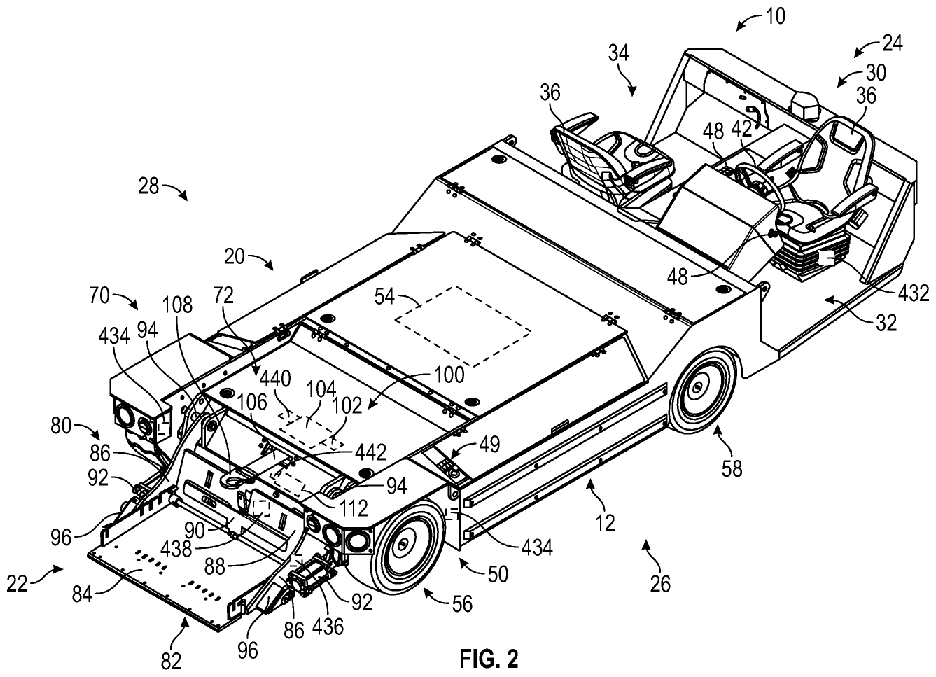

As shown in FIGS. 2-9 and 36, the tractor 10 includes a chassis, shown as frame 12; a body assembly, shown as body 20, coupled to the frame 12 and having an occupant portion or section, shown as occupant seating area 30; first operator input and output devices, shown as first operator controls 40, that are disposed within the occupant seating area 30; second operator input and output devices, shown as second operator controls 49, that are disposed outside of the occupant seating area 30; a drivetrain, shown as driveline 50, coupled to and/or supported by the frame 12; a braking assembly, shown as braking system 60, coupled to one or more components of the driveline 50 to facilitate selectively braking the one or more components of the driveline 50; an aircraft capture system, shown as capture system 70, coupled to the frame 12 and/or the body 20; and/or a control system, shown as tractor control system 400, coupled to the first operator controls 40, the second operator controls 49, the driveline 50, the braking system 60, and the capture system 70. In some embodiments, the tractor 10 includes more or fewer components.

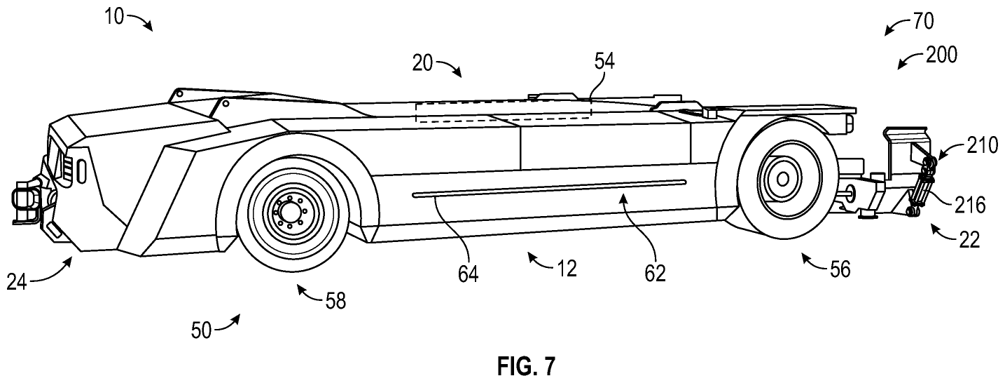

As shown in FIGS. 2, 3, 5, and 7-9, the tractor 10 has a first end, shown as front end 22, a second end, shown as rear end 24, opposite the front end 22, a first side, shown as left side 26, and a second side, shown as right side 28, opposite the left side 26. According to the exemplary embodiment shown in FIGS. 2-4, the occupant seating area 30 includes a plurality of operator compartments including a first operator compartment, shown as forward travel compartment 32, and a second operator compartment, shown as rearward travel compartment 34. In some embodiments, the occupant seating area 30 includes a third operator compartment positioned forward, rearward, or between the forward travel compartment 32 and the rearward travel compartment 34. In some embodiments, the occupant seating area 30 does not include the rearward travel compartment 34. According to an exemplary embodiment shown in FIGS. 7-9, the tractor 10 does not include the occupant seating area 30 (e.g., does not include the forward travel compartment 32 and the rearward travel compartment 34), the first operator controls 40, or the second operator controls 49. In these embodiments, the tractor 10 may be autonomously operated, remotely operated, and/or semi-autonomously operated (e.g., remote and autonomous operation). In other embodiments, the tractor 10 of FIGS. 7-9 includes the occupant seating area 30, the first operator controls 40, and/or the second operator controls 49 to provide the operator the ability to manually control one or more operations of the tractor 10.

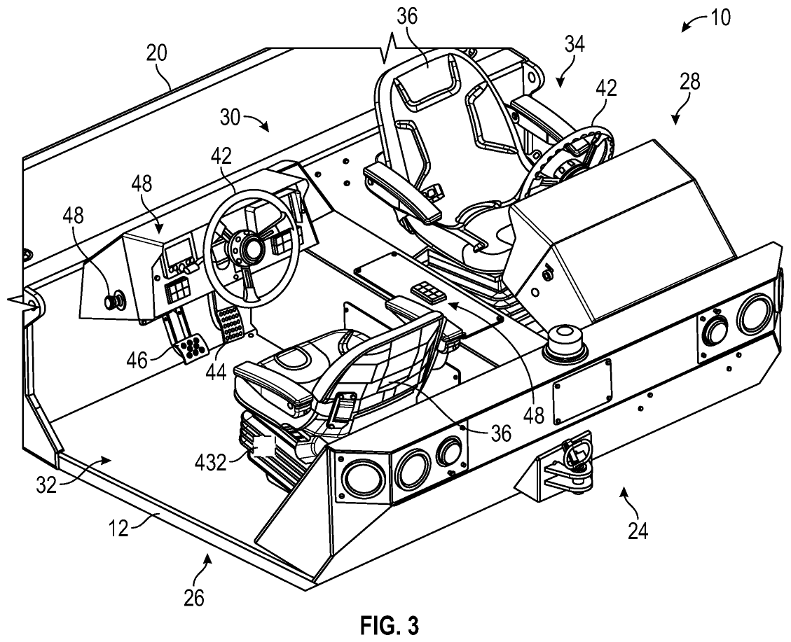

As shown in FIGS. 2-4, each of the forward travel compartment 32 and the rearward travel compartment 34 include an operator seat, shown as seat 36. As shown in FIGS. 2 and 3, the seat 36 of the forward travel compartment 32 is oriented facing the front end 22 such that an operator can control operation of the tractor 10 while facing the front end 22. The seat 36 of the rearward travel compartment 34 is oriented facing the rear end 24 such that an operator can control operation of the tractor 10 while facing the rear end 24. In other embodiments, the forward travel compartment 32 and the rearward travel compartment 34 face the same direction (e.g., in a direction towards the front end 22 or the rear end 24). In some embodiments, the seat 36 of the forward travel compartment 32 and the seat of the rearward travel compartment 34 are movable (e.g., rotatable, repositionable, etc.) to change a direction in which the seats 36 are facing (e.g., depending on a direction of travel of the tractor 10). As shown in FIGS. 2 and 3, the forward travel compartment 32 is positioned along the left side 26 of the tractor 10 and the rearward travel compartment 34 is positioned along the right side 28 of the tractor 10. In other embodiments, the forward travel compartment 32 is positioned along the right side 28 of the tractor 10 and the rearward travel compartment 34 is positioned along the left side 26 of the tractor 10.

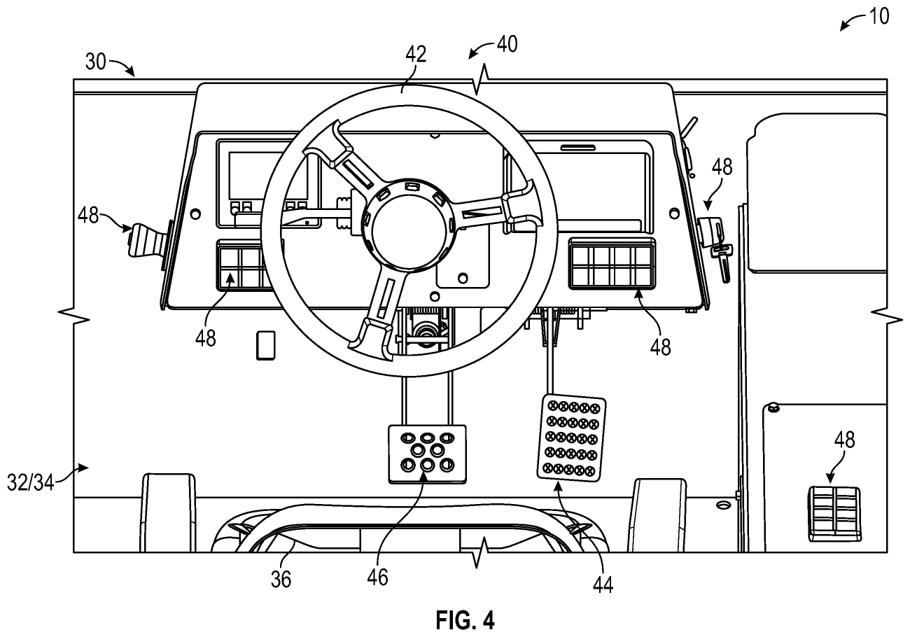

According to an exemplary embodiment, the first operator controls 40 are configured to provide an operator with the ability to control one or more functions of and/or provide commands to the tractor 10 and the components thereof (e.g., turn on, turn off, drive, turn, brake, engage various operating modes, raise/lower the cradle 82 of the cradle assembly 80, payout or take-up the winch strap 106 of the winch-capture system 72, etc.). As shown in FIGS. 3 and 4, the first operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a liquid crystal display (“LCD”), a light emitting diode (“LED”) display, a speedometer, gauges, warning lights, etc. The one or more displays are configured to display information and/or warnings relating to the operation of the tractor 10. The one or more input devices may be or include buttons, switches, knobs, levers, dials, etc.

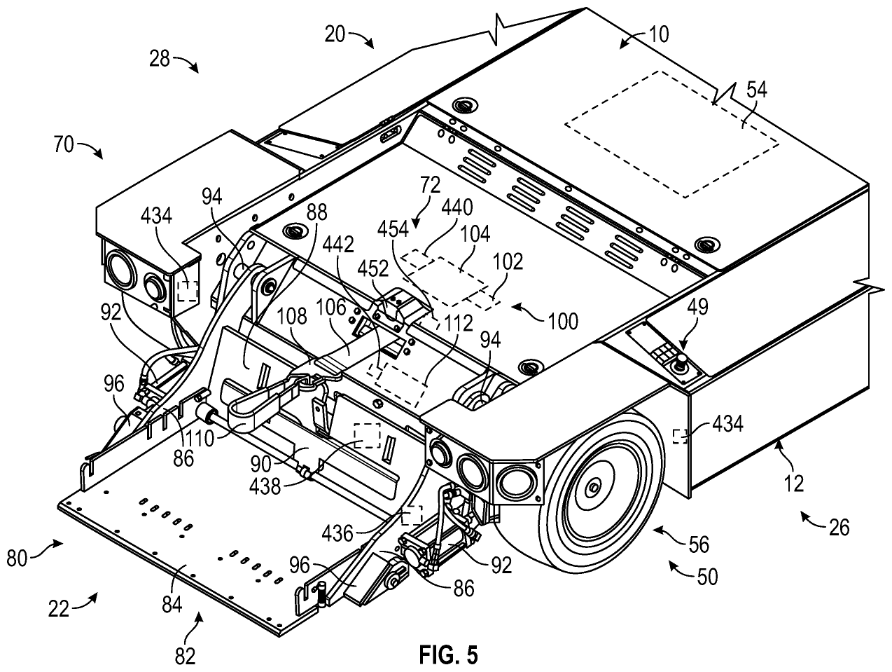

As shown in FIGS. 4 and 5, each of the forward travel compartment 32 and the rearward travel compartment 34 include the first operator controls 40. The first operator controls 40 of the forward travel compartment 32 may be used to control operation of the tractor 10 (e.g., driving, steering, and braking operations, cradle operations, winching operations, etc.) when the tractor 10 is in a first mode of operation (e.g., a forward travel mode, an approach mode, a capture mode, a pushback mode, etc.) and the first operator controls 40 of the rearward travel compartment 34 may be used to control operation of the tractor 10 when the tractor 10 is in a second mode of operation (e.g., a rearward travel mode, a tow mode, a return mode, etc.). In some embodiments, one of the forward travel compartment 32 or the rearward travel compartment 34 does not include the first operator controls 40. In such embodiments, the seats 36 may face the same direction or be replaced with a single, bench-style seat. An operator may provide an input to the first operator controls 40 (e.g., to the operator interface 48) to switch between the first mode of operation in which operation of the tractor 10 is controlled by the forward travel compartment 32 and the second mode of operation in which operation of the tractor 10 is controlled by the rearward travel compartment 34.

According to an exemplary embodiment, the second operator controls 49 are configured to provide an operator with the ability to control one or more functions of and/or provide commands to the tractor 10 and the components thereof (e.g., turn on, turn off, engage various operating modes, raise/lower the cradle 82 of the cradle assembly 80, payout or take-up the winch strap 106 of the winch-capture system 72, operate the hands-free capture system 200, etc.). The second operator controls 49 may include one or more displays and one or more input devices. The one or more displays may be or include a touchscreen, a LCD display, a LED display, a speedometer, gauges, warning lights, etc. The one or more displays are configured to display information and/or warnings relating to the operation of the tractor 10. The one or more input devices may be or include buttons, switches, knobs, levers, dials, etc. As shown in FIGS. 2 and 5, the second operator controls 49 are positioned along an exterior of the body 20 proximate the front end 22 of the tractor 10. The second operator controls 49 are positioned outside of the forward travel compartment 32 and the rearward travel compartment 34, and are separate from the operator interface 48 of the first operator controls 40 such that an operator can control operation of the tractor 10 while positioned outside of the forward travel compartment 32 and the rearward travel compartment 34. The position of the second operator controls 49 makes it easier for the operator to control the capture system 70 because the operator is positioned closer thereto (and therefore, less obstructions are positioned between the operator and the winch-capture system 72 and/or the hands-free capture system 200). In some embodiments, each of the second operator controls 49 and the operator interface 48 control the same components of the tractor 10 (e.g., operation of the braking system 60). Additionally or alternatively, in some embodiments, the second operator controls 49 control a first subset of components of the tractor 10 (e.g., operation of the capture system 70) and the operator interface 48 controls a second subset of components of the tractor 10 (e.g., operation of the driveline 50).

According to an exemplary embodiment, the driveline 50 is configured to propel the tractor 10. As shown in FIGS. 2, 5, 7-9, and 36, the driveline 50 includes a primary driver, shown as prime mover 52, an energy storage device, shown as energy storage 54, a first tractive assembly (e.g., axles, wheels, tracks, differentials, etc.), shown as front tractive assembly 56, and a second tractive assembly (e.g., axles, wheels, tracks, differentials, etc.), shown as rear tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIGS. 2, 5, and 7-9, the front tractive assembly 56 includes front tractive elements and the rear tractive assembly 58 includes rear tractive elements that are configured as wheels. In some embodiments, the front tractive elements and/or the rear tractive elements are configured as tracks.

According to an exemplary embodiment, the prime mover 52 is configured to provide power to drive the front tractive assembly 56 and/or the rear tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the front tractive assembly 56 and/or the rear tractive assembly 58. The front tractive assembly 56 and/or the rear tractive assembly 58 may include a drive shaft, a differential, and/or an axle. In some embodiments, the front tractive assembly 56 and/or the rear tractive assembly 58 include two axles or a tandem axle arrangement. In some embodiments, the front tractive assembly 56 and/or the rear tractive assembly 58 are steerable (e.g., using the steering wheel 42). In some embodiments, both the front tractive assembly 56 and the rear tractive assembly 58 are fixed and not steerable (e.g., employ skid steer operations).

In some embodiments, the driveline 50 includes a plurality of prime movers 52. By way of example, the driveline 50 may include a first prime mover 52 that drives the front tractive assembly 56 and a second prime mover 52 that drives the rear tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 56, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 58, a second prime mover 52 that drives a first one of the front tractive elements, and a third prime mover 52 that drives a second one of the front tractive elements.

In some embodiments, the tractor 10 includes a suspension system including one or more suspension components (e.g., shocks, dampers, springs, etc.) positioned between the frame 12 and one or more components (e.g., tractive elements, axles, etc.) of the front tractive assembly 56 and/or the rear tractive assembly 58. In some embodiments, the tractor 10 does not include the suspension system.

According to an exemplary embodiment, the braking system 60 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 56 (e.g., the front axle, the front tractive elements, etc.) and (ii) one or more rear braking components positioned to facilitate braking one or more components of the rear tractive assembly 58 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking system 60 is configured to facilitate braking one or more components of the driveline 50 responsive to an input received from the first operator controls 40. By way of example, responsive to interfacing with (e.g., engaging, depressing, pushing, etc.) the brake 46, the braking system 60 may be configured to facilitate braking one or more components of the driveline 50. By way of another example, responsive to interfacing with (e.g., engaging, pressing, turning, pulling, etc.) one or more input devices of the operator interface 48, the braking system 60 may be configured to engage a parking brake to brake the front tractive elements and/or the rear tractive elements. In such an example, responsive to engaging the parking brake, the one or more displays of the operator interface 48 may provide an indication (e.g., flash a light, play a sound, display a message, play a message, etc.) that the parking brake is engaged. In some embodiments, electric regenerative braking is employed (e.g., via the prime mover 52, an electric motor, etc.) in combination with or instead of using the braking system 60 to facilitate braking of one or more components of the driveline 50. By way of example, the prime mover 52 may be back-driven by the front axle of the front tractive assembly 56 and/or the rear axle of the rear tractive assembly 58 though an axle interface during a braking event.

### Capture System

According to the exemplary embodiment shown in FIGS. 1, 2, 5, and 6, the tractor 10 is configured as a towbarless tractor that couples with the airplane 2 using a “soft-capture” or “winch-capture” system/mechanism. According to the exemplary embodiment shown in FIGS. 7-9, the tractor 10 is configured as a towbarless tractor that couples with the airplane 2 using a “hard-capture” or “hands-free” capture system/mechanism. In other embodiments, the tractor 10 is configured as a conventional pushback tractor (e.g., a non-towbarless tractor) that couples with the airplane 2. As shown in FIGS. 2, 5-9, and 36, the capture system 70 includes either (i) a winch-capture mechanism, shown as winch-capture system 72, or (ii) a hands-free capture mechanism, shown as hands-free capture system 200.

### Winch-Capture System

As shown FIGS. 2, 5, 6, and 36, the winch-capture system 72 includes a first aircraft support assembly (e.g., bucket assembly, ramp assembly, etc.), shown as cradle assembly 80, and a towing mechanism, shown as winch assembly 100. According to an exemplary embodiment, the winch assembly 100 is configured to engage with the nose landing gear 4 of the airplane 2 to pull the cradle assembly 80 under the nose landing gear 4 (or pull the airplane 2 on top of the cradle assembly 80) and the cradle assembly 80 is configured to support the nose landing gear 4 of the airplane 2 and lift the front end of the airplane 2 to facilitate towing, pushing, or otherwise repositioning the airplane 2 with the tractor 10. By way of example, the cradle assembly 80 is configured to space or lift the nose landing gear 4 of the airplane 2 from a ground surface and carry the nose landing gear 4 as the tractor 10 is driven to reposition the airplane 2. As shown in FIGS. 2, 5, and 6, the cradle assembly 80 and the winch assembly 100 are positioned at or proximate the front end 22 of the tractor 10. In some embodiments, the cradle assembly 80 and/or the winch assembly 100 are otherwise positioned about the tractor 10 (e.g., at or proximate the rear end 24).

As shown in FIGS. 2, 5, and 6, the cradle assembly 80 includes an aircraft support (e.g., a bucket, a ramp, etc.), shown as cradle 82, having a support deck, shown as bottom plate 84, side supports (e.g., side gates), shown as sidewalls 86, and a rear support (e.g., rear gate), shown as back wall 88. Collectively, the bottom plate 84, the sidewalls 86, and the back wall 88 define an area configured to load/unload the nose landing gear 4 of the airplane 2 onto/from the cradle 82, space the nose landing gear 4 from the ground surface, and support the nose landing gear 4 during transportation of the tractor 10 and the airplane 2 being towed or pushed thereby.

As shown in FIGS. 2, 5, and 6, the bottom plate 84 extends within a substantially horizontal plane (e.g., when the cradle 82 is positioned to receive or unload the airplane 2 therefrom). The bottom plate 84 is configured to support the wheels 6 of the nose landing gear 4 of the airplane 2 during towing and pushback operations of the tractor 10. The bottom plate 84 provides a surface (e.g., a ramp) for the wheels 6 of the nose landing gear 4 to contact during winching operations to facilitate loading the nose landing gear 4 of the airplane 2 onto and unloading the nose landing gear 4 of the airplane 2 from the cradle 82. In some embodiments, the cradle assembly 80 includes a wear plate positioned between the bottom plate 84 and the ground surface. The wear plate may be configured to contact the ground surface (e.g., instead of the bottom plate 84 contacting the ground surface) to prevent wear on the bottom plate 84. The wear plate may be selectively coupled to the bottom plate 84 or another component of the cradle 82 to facilitate replacing the wear plate after repeated use thereof (e.g., the wear plate may wear away or be damaged due to repeated contact with the ground surface). The wear plate may be manufactured from steel (e.g., abrasion resistant steel, hardened steel, carbon steel, stainless steel, etc.,), a polymer (e.g., ultra-high molecular weight polyethylene, fiberglass-reinforced plastics, etc.), and/or any other material suitable for withstanding abrasions, scrapes, and impacts against the ground surface.

As shown in FIGS. 2, 5, and 6, the sidewalls 86 are coupled to the bottom plate 84 along opposing lateral sides thereof (e.g., the sidewalls 86 are laterally spaced apart from each other by the bottom plate 84) and extend in a substantially vertical direction from the bottom plate 84. The sidewalls 86 may provide support to lateral sides of the nose landing gear 4 and may provide a barrier (e.g., a stop) to limit rotation of the nose landing gear 4 (e.g., about the pivot 7) within the cradle 82. By way of example, the sidewalls 86 may be laterally spaced apart (e.g., in a direction between the left side 26 and the right side 28) by a distance at least greater than a lateral width of the nose landing gear 4 to facilitate loading and unloading the nose landing gear 4 of the airplane 2 onto and from the cradle 82. In some embodiments, positions of the sidewalls 86 are adjustable to vary the lateral distance therebetween to accommodate for varying sizes of the nose landing gear 4 of different airplanes 2 (e.g., the lateral distance can be made smaller or larger for an airplane 2 with a smaller or larger nose landing gear 4). In other embodiments, the cradle 82 includes side plates separate from the sidewalls 86 that are adjustable to vary the lateral distance therebetween to accommodate for variously sized nose landing gears 4.

As shown in FIGS. 2 and 5, the back wall 88 extends from the bottom plate 84 in a lateral direction between the sidewalls 86. The back wall 88 is configured to provide a barrier (e.g., a stop) to limit longitudinal translation (e.g., in a direction between the front end 22 and the rear end 24) of the nose landing gear 4 within the cradle 82. By way of example, contact between the nose landing gear 4 (e.g., the wheels 6 of the nose landing gear 4) and the back wall 88 limits movement of the nose landing gear 4 and the airplane 2 in a direction towards the rear end 24. In some embodiments, the cradle 82 includes a front gate pivotably coupled to a front or free edge of the cradle 82 (e.g., a front or free edge of the bottom plate 84) such that (i) when the airplane 2 is supported by the cradle 82, the front gate pivots to a position to limit movement of the nose landing gear 4 and the airplane 2 off of the cradle 82 (e.g., in a direction away from the front end 22) and (ii) during loading and unloading operations, the front gate pivots to a position to permit movement of the nose landing gear 4 (e.g., does not block or limit the nose landing gear 4 of the airplane 2 from being loaded or unloaded from the cradle 82). In some embodiments, the front gate provides a ramped surface to facilitate (i) loading the nose landing gear 4 of the airplane 2 onto the bottom plate 84 from the ground surface and (ii) unloading the nose landing gear 4 of the airplane 2 off of the bottom plate 84 and onto the ground surface.

As shown in FIGS. 2 and 5, the cradle assembly 80 includes a winch shutoff plate, shown as switch plate 90, pivotably coupled to the cradle 82 at or proximate the back wall 88. The switch plate 90 may be coupled with a limit switch (e.g., the sensor 438, a position sensor, a mechanical switch, etc.) configured to detect a position of the switch plate 90. By way of example, when the nose landing gear 4 comes into contact with the switch plate 90, the switch plate 90 pivots and comes into contact or otherwise engages with the limit switch. In such an example, responsive to engagement of the limit switch, a determination may be made that the nose landing gear 4 is fully loaded onto the cradle 82 and winching operations may be stopped (e.g., automatically stopped). In some embodiments, the cradle assembly 80 does not include the switch plate 90 and/or the limit switch.

As shown in FIGS. 2 and 5, the cradle assembly 80 includes one or more actuators (e.g., hydraulic cylinders, pneumatic cylinders, electric actuators, motor-driven leadscrews, etc.), shown as lift actuators 92, configured to extend and retract to selectively raise (e.g., and thus raise the nose landing gear 4 when received by the cradle 82) and lower (e.g., and thus lower the nose landing gear 4 when received by the cradle 82) the cradle 82. As shown in FIGS. 2 and 5, the cradle 82 is pivotably coupled with the body 20 of the tractor 10 by one or more pivot pins (e.g., a shaft, a fastener, etc.), shown as pins 94. A first one of the pins 94 is configured to extend through an aperture of a first one of the sidewalls 86 and a second one of the pins 94 is configured to extend through an aperture of a second one of the sidewalls 86 to rotatably couple the cradle 82 with the body 20. In some embodiments, a single pin 94 is configured to extend through each of the aperture of the first one of the sidewalls 86 and the aperture of the second one of the sidewalls 86 to rotatably couple the cradle 82 with the body 20. In other embodiments, the cradle 82 is otherwise rotatably coupled with the body 20.

As shown in FIGS. 2 and 5, the lift actuators 92 are coupled between the cradle 82 and the frame 12. Specifically, one end (e.g., an outer end) of the lift actuators 92 is coupled (e.g., pivotably coupled) to exterior facing surfaces of the sidewalls 86 (e.g., surfaces of the sidewalls 86 facing the left side 26 and the right side 28, respectively) by a bracket, shown as actuator bracket 96, and an opposite end (e.g., a base end) of the lift actuators 92 is coupled to the frame 12. In this manner, extension of the lift actuators 92 to an extended position, which corresponds with a first, raised position of the cradle 82, pivots the cradle 82 relative to the frame 12 and the body 20 about the pins 94 and raises the cradle 82 to space the bottom plate 84 from the ground surface. Similarly, retraction of the lift actuators 92 to a retracted position, which corresponds with a second, lowered position of the cradle 82, pivots the cradle 82 relative to the frame 12 and the body 20 about the pins 94 (e.g., from the first, raised position to the second, lowered position) and lowers the cradle 82 such that the bottom plate 84 (e.g., or the wear plate) contacts the ground surface. In some embodiments, gravity and/or a weight of the cradle 82 retracts the lift actuators 92. In some embodiments, the cradle assembly 80 includes more or fewer than two of the lift actuators 92. The tractor 10 may include various components to drive the lift actuators 92 (e.g., pumps, valves, compressors, motors, batteries, voltage regulators, powered by electricity provided by the energy storage 54, etc.).

As shown in FIGS. 2, 5, and 6, the winch assembly 100 includes a drive system (e.g., electric motor, internal combustion engine, a hydraulically-operated motor, etc.), shown as motor 102, a drum (e.g., reel, spool, spindle, etc.), shown as winch drum 104, operatively coupled with the motor 102, a cable (e.g., tow rope, chain, tow strap, etc.), shown as winch strap 106, configured to wind about and unwind from the winch drum 104, a coupler (e.g., engagement feature), shown as winch hook 108, positioned at a free end of the winch strap 106 (e.g., a free end of the winch strap 106 opposite an end coupled to the winch drum 104), an airplane engagement feature (e.g., nose gear coupler, strut strap, linkage, etc.), shown as airplane coupler 110, coupled with the winch hook 108, and a hook and coupler storage compartment (e.g., bin, rack, hook, etc.), shown as storage compartment 112.

The motor 102 is configured to provide rotational energy to the winch drum 104 to rotate the winch drum 104. The winch strap 106 is coupled with the winch drum 104 (e.g., at an end of the winch strap 106 opposite the free end at which the winch hook 108 is positioned) and configured to wind around and unwind from the winch drum 104 as the winch drum 104 is driven by the motor 102. By way of example, responsive to the motor 102 providing rotational energy to rotate the winch drum 104 in a first direction, the winch strap 106 is unwound (e.g., paid out, let out, etc.) from the winch drum 104. By way of another example, responsive to the motor 102 providing rotational energy to rotate the winch drum 104 in a second direction opposite the first direction, the winch strap 106 is wound around (e.g., taken up by) the winch drum 104. In some embodiments, the motor 102 is configured to vary the rate at which the winch strap 106 is wound or unwound from the winch drum 104 by adjusting the rotational energy (e.g., the voltage) supplied to the winch drum 104. In some embodiments, the winch-capture system 72 includes a gear box (e.g., a transmission) configured to facilitate adjusting the output speed and torque for rotating the winch drum 104.

As shown in FIGS. 2 and 5, the motor 102 and the winch drum 104 are positioned within an interior chamber of the body 20. The winch strap 106 is configured to extend outside of the body 20 from the winch drum 104. As shown in FIGS. 2 and 5, the free end of the winch strap 106 to which the winch hook 108 is coupled extends outside of the body 20 through a winch aperture defined thereby. The winch hook 108 is configured as a hook (e.g., a carabiner) defining an interface configured to selectively couple with the airplane coupler 110. As shown in FIG. 5, the airplane coupler 110 is configured as a strut strap where ends thereof are configured to be engaged by the interface of the winch hook 108 such that the ends of the airplane coupler 110 are received within an aperture of the winch hook 108 to couple the airplane coupler 110 with the winch hook 108. One of the ends of the airplane coupler 110 may be released from the aperture (e.g., not coupled with the winch hook 108) to facilitate securing the airplane coupler 110 and the winch-capture system 72 to the airplane 2. By way of example, after decoupling a respective end of the airplane coupler 110 from the winch hook 108, the airplane coupler 110 may be wrapped around the pivot 7 of the airplane 2 and the respective end of the airplane coupler 110 may be coupled with the winch hook 108 to couple the nose landing gear 4 of the airplane 2 with the winch-capture system 72 (e.g., at which point the nose landing gear 4 of the airplane 2 can be loaded onto or unloaded from the cradle 82). In some embodiments, the airplane coupler 110 is configured as a bracket assembly or a mechanical linkage to engage with the tow element 8 of the airplane 2 to couple the airplane 2 with the winch-capture system 72. In other embodiments, the airplane coupler 110 is otherwise configured to couple with the winch hook 108 to facilitate coupling the airplane 2 with the winch-capture system 72. In yet other embodiments, the winch-capture system 72 omits the airplane coupler 110 and the winch hook 108 engages directly with the tow element 8 or the pivot 7 to couple the nose landing gear 4 of the airplane 2 with the winch-capture system 72. In some embodiments, the winch-capture system 72 does not include the winch hook 108 such that the airplane coupler 110 is configured to couple the nose landing gear 4 of the airplane 2 with the winch-capture system 72. In such embodiments, the airplane coupler 110 may be coupled with (e.g., integrally formed with) the winch strap 106 at the free end thereof.

As shown in FIG. 5, the storage compartment 112 is configured to provide a space (e.g., a pocket, a hook, a compartment, etc.) to store or otherwise secure the winch hook 108 and/or the airplane coupler 110 when not in use. The storage compartment 112 facilitates securing the winch hook 108 and/or the airplane coupler 110 to prevent unintentional movement thereof during driving operations of the tractor 10, for example. In some embodiments, the storage compartment 112 is configured to store or otherwise secure a portion of the winch strap 106 (e.g., a portion of the winch strap 106 extending outside of the body 20 and not wound around the winch drum 104) when not in use.

The cradle assembly 80 is configured to operate with the winch assembly 100 to facilitate coupling the airplane 2 with the tractor 10 using the capture system 70. To capture (e.g., couple and secure) the airplane 2, the tractor 10 is driven to position the cradle 82 in front of the nose landing gear 4, and the cradle 82 is actuated by the lift actuators 92 to the second, lowered position. In the second, lowered position, the cradle 82 (i) is positioned such that the bottom plate 84 (e.g., or the wear plate) contacts the ground surface and (ii) provides a surface (e.g., a ramp) for the nose landing gear 4 to contact. The motor 102 of the winch assembly 100 drives the winch drum 104 to payout the winch strap 106 with the winch hook 108 and/or the airplane coupler 110 coupled thereto. The winch drum 104 pays out a sufficient length of the winch strap 106 therefrom such that the winch hook 108 and/or the airplane coupler 110 can reach the nose landing gear 4 and be coupled therewith (e.g., by a coupling with the tow element 8, by a direct coupling with the pivot 7, etc.). With the airplane 2 coupled with the tractor 10 by the winch-capture system 72, and with the cradle 82 in the second, lowered position, the motor 102 drives the winch drum 104 to retract the winch strap 106. Retraction of the winch strap 106 pulls the cradle 82 in a direction towards the airplane 2. In other words, the airplane 2 remains stationary and the tractor 10 travels forward in a direction towards the airplane 2 as the winch strap 106 is retracted such that the bottom plate 84 of the cradle 82 is pulled underneath the wheels 6 of the nose landing gear 4. In some embodiments, the prime mover 52 provides power to drive the front tractive assembly 56 and/or the rear tractive assembly 58 as the winch strap 106 is being retracted. The motor 102 may continue to provide rotational energy to the winch drum 104 to retract the winch strap 106 until the nose landing gear 4 is supported and fully received by the cradle 82 (e.g., when the wheels 6 are positioned over the bottom plate 84, when the wheels 6 contact the switch plate 90, when the winch strap 106 is fully retracted, etc.).

In some embodiments, instead of retracting the winch strap 106 such that the airplane 2 remains stationary and the tractor 10 travels forward in a direction towards the airplane 2, retraction of the winch strap 106 pulls the airplane 2 in a direction towards the cradle 82. In other words, the tractor 10 remains stationary and the airplane 2 travels in a direction towards the tractor 10 as the winch strap 106 is retracted such that the wheels 6 of the nose landing gear 4 are pulled over the top of the bottom plate 84 of the cradle 82. In such embodiments, prior to retracting the winch strap 106 to pull the airplane 2, the braking system 60 may be engaged to prevent rotation of the tractive elements of the front tractive assembly 56 and/or the rear tractive assembly 58 to prevent movement of the tractor 10.

After the nose landing gear 4 is received by and loaded onto the cradle 82, the lift actuators 92 may extend to transition the cradle 82 from the second, lowered position to the first, raised position. In the first, raised position, the cradle 82 lifts and spaces the nose landing gear 4 from the ground surface. With the airplane 2 secured to the tractor 10 by the winch-capture system 72 and the cradle assembly 80 supporting the nose landing gear 4 off of the ground surface, and when the tractor 10 is driven, the winch-capture system 72 facilities pushing or pulling the airplane 2 with the tractor 10 to tow, push, and otherwise reposition the airplane 2. In this manner, responsive to the tractor 10 being driven, the winch-capture system 72 (e.g., the winch hook 108, the airplane coupler 110, the cradle 82, etc.) exerts a force on the airplane 2 such that the airplane 2 is driven at the same speed, in the same direction, and is maintained at a fixed distance from the tractor 10. In some embodiments, when the tractor 10 turns, the wheels 6 pivot relative to the fuselage of the airplane 2 and exert a force on the airplane 2 to pull the airplane 2 in the direction of the tractor 10. In other embodiments, when the tractor 10 turns, the wheels 6 remain fixed relative to the fuselage of the airplane 2.

To unload the airplane 2 from the tractor 10, the cradle 82 is transitioned (e.g., lowered) from the first, raised position to the second, lowered position. The winch-capture system 72 may disengage such that rotation of the winch drum 104 is not inhibited (e.g., the winch drum 104 is free to rotate and pay out the winch strap 106 therefrom). When the winch-capture system 72 is disengaged, and the cradle 82 is in the second, lowered position, the tractor 10 may drive in a direction away from the airplane 2 (e.g., rearward in a direction toward the rear end 24) such that the nose landing gear 4 is unloaded from the cradle 82. In other words, the airplane 2 remains stationary and the tractor 10 travels rearward or away from the nose landing gear 4. In some embodiments, the winch strap 106 is paid out by the motor 102 from the winch drum 104 before the nose landing gear 4 is unloaded from the cradle 82 or as the nose landing gear 4 is being unloaded from the cradle 82. The airplane coupler 110 can then be decoupled from the nose landing gear 4.

### Hands-Free Capture System

In some embodiments, the tractor 10 does not include the winch-capture system 72, but rather the tractor 10 includes the hands-free capture system 200. The hands-free capture system 200 may include a second aircraft support assembly or cradle assembly, a shaft, a plurality of arms, and a plurality of actuators. Such components may be used to engage with and secure the nose landing gear 4 to the tractor 10 without requiring an operator to manually interact with the nose landing gear 4 of the airplane 2. The plurality of arms may be pivotably coupled to opposing ends of the shaft. The plurality of actuators may be configured to pivot, extend, and retract the plurality of arms relative to the tractor 10 and the shaft. The plurality of arms may be configured to selectively engage with the nose landing gear 4 to couple the nose landing gear 4 with the tractor 10 with the airplane 2. By way of example, the plurality of arms and the cradle may include engagement features configured to engage with the rear and/or front of the wheels 6.

FIGS. 7-9 show an exemplary embodiment of the tractor 10 including the hands-free capture system 200. In general, the hands-free capture system 200 includes an actuator assembly that is configured to control various components of the hands-free capture system 200 so that the components of the hands-free capture system 200 efficiently align with, engage, and support the nose landing gear 4. As shown in FIGS. 7-14, 22-27, and 30-33, the hands-free capture system 200 includes an aircraft support (e.g., a bucket, a ramp, etc.), shown as cradle 202, having a support deck, shown as bottom plate 204, side supports (e.g., side gates), shown as sidewalls 206, and a rear support (e.g., rear gate), shown as back wall 208. In some embodiments, the bottom plate 204 defines a sloped or ramped surface that slopes downwardly as it extends away from the back wall 208. The ramped surface defined by the bottom plate 204 aids in the bottom plate 204 forming a contact point with the nose landing gear 4 (e.g., with the wheels 6 of the nose landing gear 4). In general, the features of the cradle 202 and the sidewalls 206 are symmetric about a center plane (e.g., a plane extending through a lateral centerline or through the tilt axis 258 of the cradle 202). It follows that any description herein relating to a feature of the sidewalls 206 or a feature formed in or coupled to the sidewalls 206 applies symmetrically to the opposing sidewall, with similar features identified using the same reference numerals.

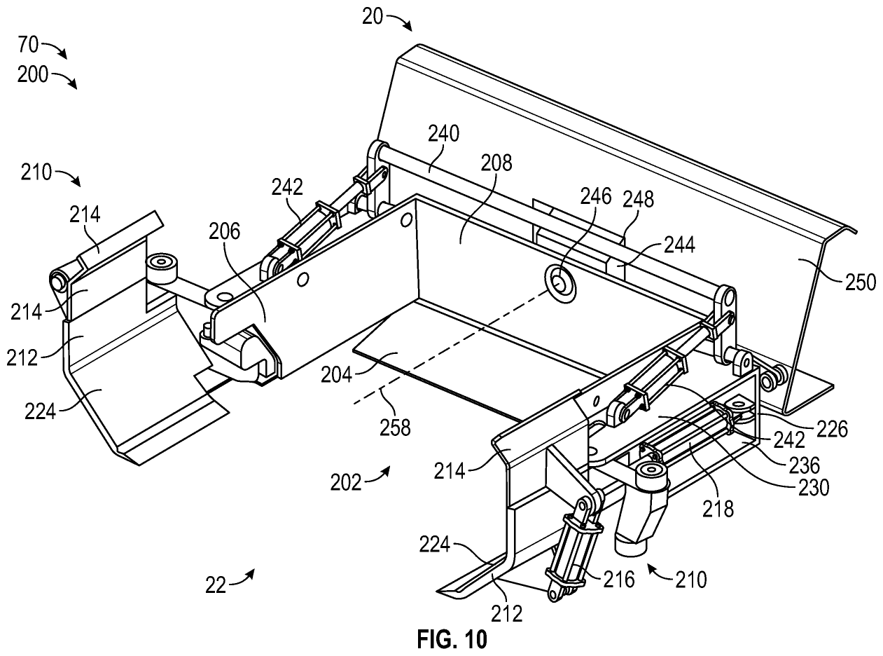

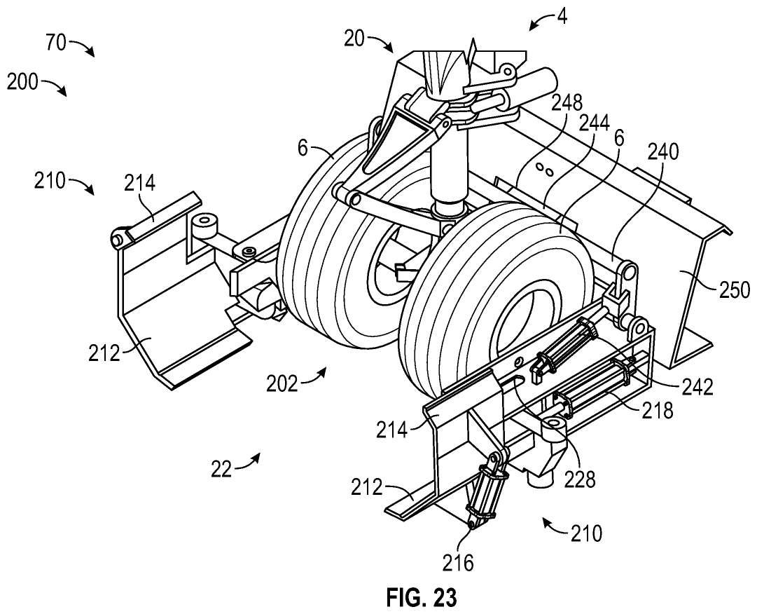

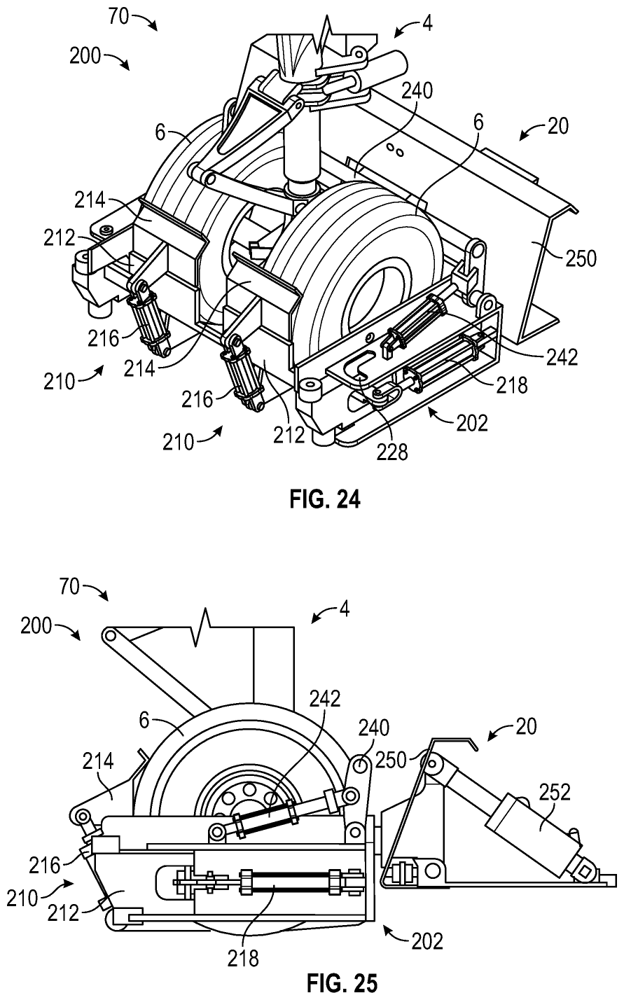

As shown in FIGS. 7-14, 22-27, and 30-33, a front retention assembly, shown as front gate assembly 210, is pivotably coupled to the cradle 202 adjacent or proximate to a distal end of each of the sidewalls 206 (e.g., an end closest to the front end 22). In general, each of the front gate assemblies 210 is pivotably coupled to the cradle 202, so that the front gate assemblies 210 may selectively pivot inwardly (e.g., toward the bottom plate 204) to a closed or retention position and engage a wheel 6 of the nose landing gear 4 (see, e.g., FIG. 24), or pivot outwardly (e.g., away from the bottom plate 204) to an open or receiving position to allow the nose landing gear 4 to be received by the cradle 202 (see, e.g., FIGS. 10 and 23). Both of the front gate assemblies 210 include similar components and functionality, with like components identified using the same references numerals. It follows that any description herein relating to a single one of the front gate assemblies 210, or a single component or feature of the front gate assembly 210, applies symmetrically about a center plane (e.g., a plane extending through a lateral centerline of the cradle 202) to the other of the front gate assemblies 210. Each of the front gate assemblies 210 includes a bottom framework, retainer, or plate, shown as front gate 212, a top framework or plate, shown as top retainer 214, a top pivot actuator 216 (e.g., a piston-cylinder actuator that operates hydraulically, electrically, or electrohydraulically), a bottom pivot actuator 218 (e.g., a piston-cylinder actuator that operates hydraulically, electrically, or electrohydraulically), a first bearing or cam pin 220, and a second bearing or follower pin 222.

As shown in FIG. 10, the front gate 212 includes a sloped or ramped surface 224 (e.g., that is configured to engage lower, rear portions of the wheels 6 of the nose landing gear 4). According to an exemplary embodiment, the top retainer 214 is pivotally coupled to the front gate 212 and the top pivot actuator 216 is pivotally coupled between interfaces protruding from exterior facing sides of the front gate 212 and the top retainer 214 so that extension and retraction of the top pivot actuator 216 results in the top retainer 214 pivoting relative to the front gate 212. In general, the pivotal movement of the top retainer 214 relative to the front gate 212 enables the front gate assemblies 210 and the hands-free capture system 200 to engage the nose landing gear 4 (e.g., lower and upper rear portions of the wheels 6 of the nose landing gear 4) and to adjust to varying sizes defined by the nose landing gear 4 and the wheels 6 thereof.

As shown in FIGS. 10, 11, 17, 22-25, 30, and 31, the bottom pivot actuator 218 is coupled between the cradle 202 and the front gate 212. In some embodiments, the bottom pivot actuator 218 is arranged on a laterally outward side of the sidewall 206 and is coupled at one end to an outer rear wall 226 of the cradle 202 that extends laterally outwardly from a rear end of the sidewall 206 (e.g., an end arranged furthest from the front end 22), and to the front gate 212 at an opposing end (e.g., a rod side). In general, the bottom pivot actuator 218 is pivotally coupled to the front gate 212 so that movement of the bottom pivot actuator 218 pivots the front gate 212, and the top retainer 214 coupled thereto, relative to the cradle 202 (e.g., relative to the sidewall 206) in a direction either toward the bottom plate 204 or away from the bottom plate 204. In some embodiments, retraction of the bottom pivot actuator 218 is configured to pivot the front gate 212 and the top retainer 214 inwardly toward the bottom plate 204, and extension of the bottom pivot actuator 218 is configured to pivot the front gate 212 and the top retainer 214 outwardly away from the bottom plate 204.

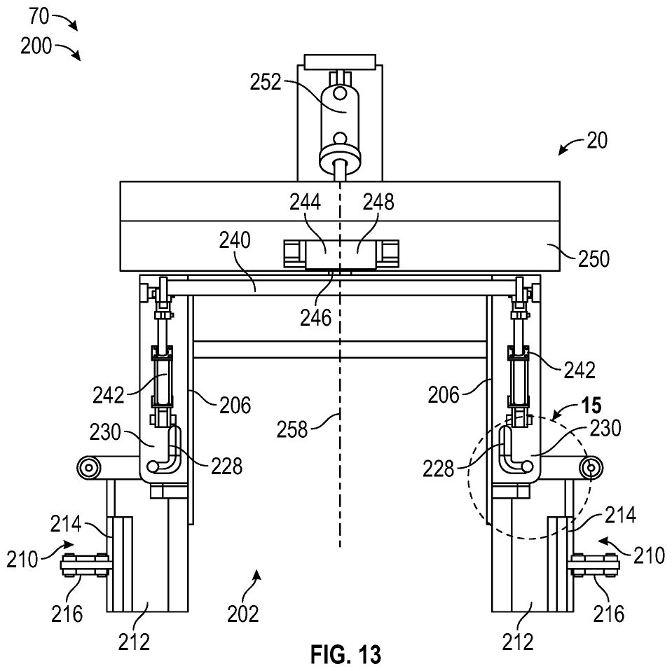

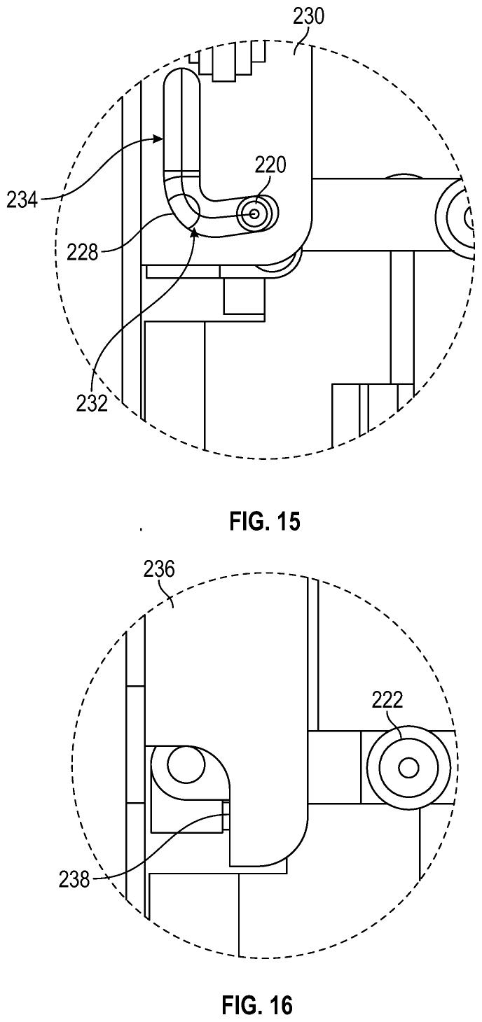

According to an exemplary embodiment, the pivotal movement of the front gate 212 and the top retainer 214 in response to movement of the bottom pivot actuator 218 is enabled by a cam mechanism that is configured to convert linear movement of the bottom pivot actuator 218 into rotary or pivotal movement of the front gate 212 and top retainer 214. As shown in FIGS. 13, 15, 23, 24, 26, 28, 30, 32, and 34, the cradle 202 includes a guide, track, or cam slot 228 formed in an outer top wall 230 that extends laterally outwardly from the sidewall 206. In some embodiments, the outer top wall 230 extends in a direction that is perpendicular to the outer rear wall 226. In some embodiments, the cam slot 228 is arranged adjacent to a distal end of the outer top wall 230 (e.g., an end closest to the front end 22). As shown in FIGS. 15, 28, and 34, the cam slot 228 includes an actuate or curved portion 232 and a linear portion 234. The cam pin 220 extends into and engages with the cam slot 228 to form the pivotal coupling between the front gate 212 and the cradle 202. Specifically, the movement of the front gate 212 provided by the bottom pivot actuator 218 moves the cam pin 220 along the cam slot 228 and results in the front gate 212 and the top retainer 214 moving relative to the cradle 202. In general, as the cam pin 220 moves along the curved portion 232 of the cam slot 228, the front gate 212 and the top retainer 214 pivot relative to the cradle 202 (e.g., inwardly toward the bottom plate 204 or outwardly away from the bottom plate 204) and, as the cam pin 220 moves along the linear portion 234, the front gate and the top retainer 214 move linearly relative to the cradle 202 (e.g., toward or away from the bottom plate 204).

As shown in FIGS. 10, 14, 16, 27, 29, 33, and 35, the cradle 202 includes an outer bottom wall 236 that extends laterally outwardly from the sidewall 206. In some embodiments, the outer bottom wall 236 is arranged approximately parallel to the outer top wall 230 and is spaced from the outer top wall 230 in a vertical direction (e.g., a direction perpendicular to the ground on which the tractor 10 travels). As shown in FIGS. 16, 29, and 35 distal end of the outer bottom wall 236 (e.g., an end closest to the front end 22) includes a retention notch or retention cutout 238 formed on a laterally-inner side of the outer bottom wall 236. The retention cutout 238 is configured to receive the follower pin 222, once the front gate 212 and the top retainer 214 pivot inwardly toward the bottom plate 204, and aids in retaining the front gate 212 and the top retainer 214 in a pivoted position (e.g., a retention position) once the cradle 202 receives the nose landing gear 4 and the wheels 6 thereof.

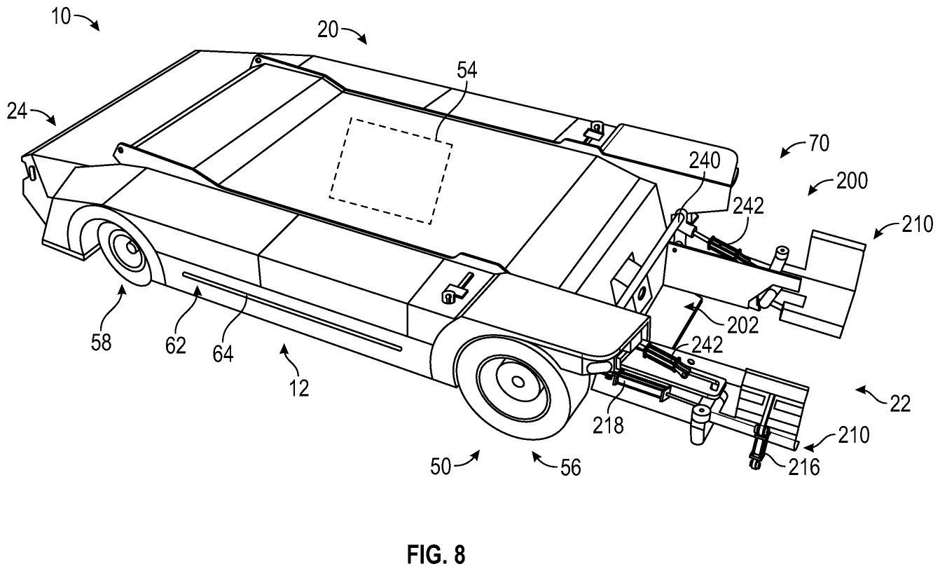

As shown in FIGS. 8-13, 17, 20-26, and 30-32, a rear retention assembly, shown as rear retention bar 240, is coupled to a rear end of the cradle 202 (e.g., an end furthest away from the front end 22). The rear retention bar 240 extends laterally across the rear end of the cradle 202 and each lateral end of the rear retention bar 240 is pivotally coupled to a respective one of the outer top walls 230 and/or a respective one of the sidewalls 206 so that the rear retention bar 240 is pivotable relative to the cradle 202. Each lateral end of the rear retention bar 240 is coupled to a retention bar actuator 242 (e.g., a piston-cylinder actuator that operates hydraulically, electrically, or electrohydraulically). The retention bar actuators 242 are coupled between the outer top wall 230 and the rear retention bar 240. Specifically, each of the retention bar actuators 242 is coupled at one end to a respective one of the outer top walls 230 and to a respective lateral end of the rear retention bar 240 at an opposing end. The retention bar actuators 242 are configured to extend and retract to pivot the rear retention bar 240 relative to the cradle 202. In some embodiments, retraction of the retention bar actuators 242 pivots the rear retention bar 240 in a direction toward the bottom plate 204, and extension of the retention bar actuators 242 pivots the rear retention bar 240 in a direction away from the bottom plate 204. In general, the pivotal movement of the rear retention bar 240 in a direction toward the bottom plate 204 is configured to move the rear retention bar 240 into engagement with the front, top portions of the wheels 6 of the nose landing gear 4 and provide contact points therewith.

According to an exemplary embodiment, the hands-free capture system 200 includes one or more actuators that are configured to reposition, lift, and/or rotate the cradle 202 relative to the body 20 of the tractor 10 to aid in receiving, carrying, and navigating the nose landing gear 4. As shown in FIGS. 10-13 and 17, the cradle 202 is pivotally or rotatably coupled to a knuckle or lift body 244. The cradle 202 includes a rod or cradle pin 246 that extends rearwardly away from the back wall 208. The cradle pin 246 is at least partially received within a bore or aperture formed in the lift body 244, so that the cradle 202 is allowed to pivot or rotate relative to the body 20, as described herein. In some embodiments, at least a portion of the lift body 244 extends through a cutout or window 248 formed in a body front wall 250 positioned at the front end 22 of the body 20.

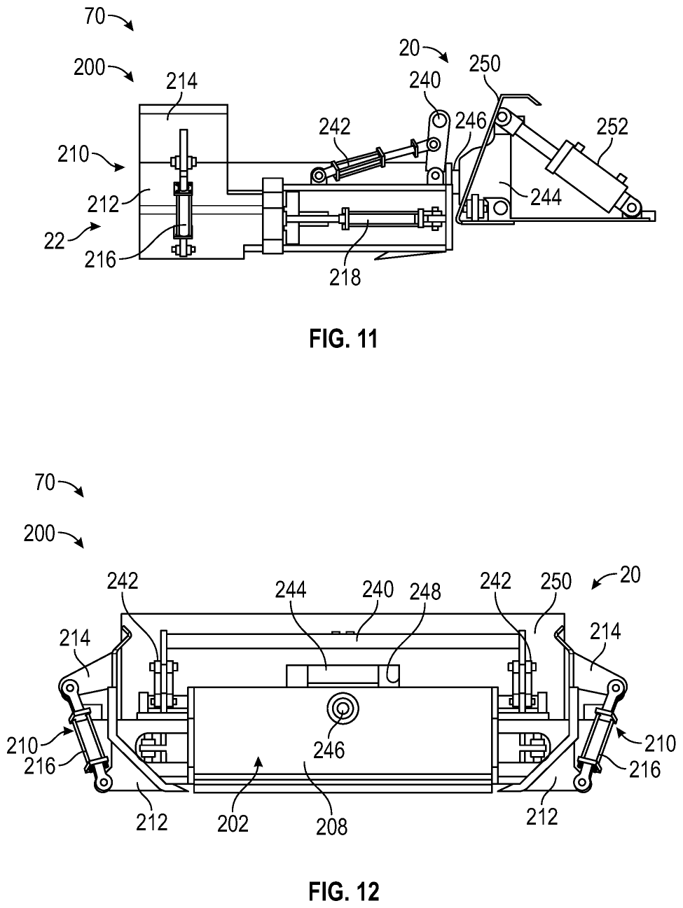

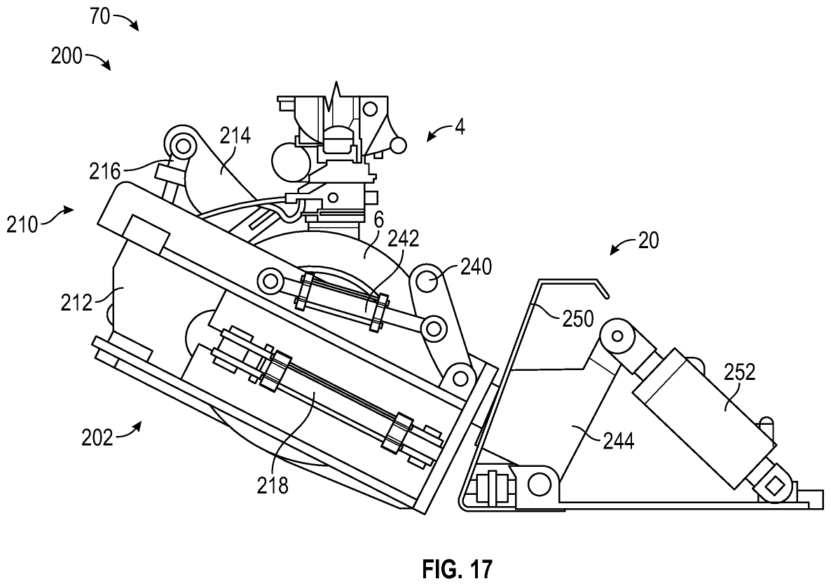

A first end of the lift body 244 (e.g., a bottom end from the perspective of FIG. 11) is pivotally coupled to the body 20 and/or the frame 12 of the tractor 10 and a second end of the lift body (e.g., a top end from the perspective of FIG. 11) is pivotally coupled to a lift actuator 252 (e.g., a piston-cylinder actuator that operates hydraulically, electrically, or electrohydraulically). One end of the lift actuator 252 is pivotally coupled to the lift body 244 and an opposing end of the lift actuator 252 is pivotally coupled to the body 20 and/or the frame 12 of the tractor 10. Because the lift body 244 is pivotally coupled to the body 20 at one end and to the lift actuator 252 at another end, extension and retraction of the lift actuator 252 generates a torque on the lift body 244, and the cradle 202 coupled thereto, which results in the cradle 202 being raised or lowered relative to the body 20 (and a ground surface on which the tractor 10 travels). In some embodiments, the cradle 202, and all the components coupled thereto (e.g., the front gate assemblies 210, the rear retention bar 240, the retention bar actuators 242, etc.), is configured to move between a lowered position (see, e.g., FIG. 11) where the bottom plate 204 is positioned to receive the nose landing gear 4 (e.g., the bottom plate 204 is arranged on or adjacent to a ground on which the tractor 10 travels), and a raised or lifted position (see, e.g., FIG. 17) where cradle 202 is raised relative to the body 20 and the bottom plate 204 is raised off of the ground. In some embodiments, retraction of the lift actuator 252 moves the cradle 202 in a direction toward the lifted position, and extension of the lift actuator 252 moves the cradle 202 in a direction toward the lowered position. According to the exemplary embodiment shown in FIGS. 11 and 17, the lift actuator 252 is configured to pivotally raise and lower the cradle 202. In other embodiments, the lift actuator 252 is configured to linearly raise and lower the cradle 202 (e.g., so that the cradle 202 is raised and lowered in a direction that is perpendicular or substantially perpendicular to the ground).

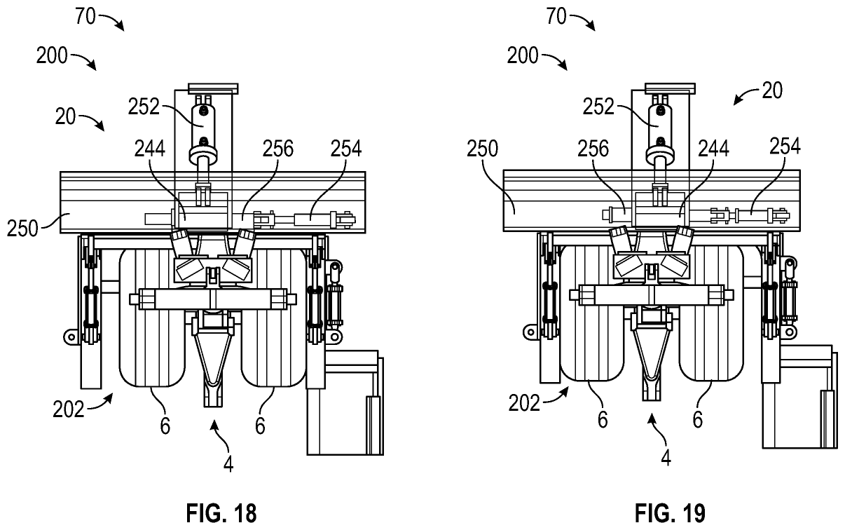

As shown in FIGS. 18 and 19, the hands-free capture system 200 includes a side-shift actuator 254 (e.g., a piston-cylinder actuator that operates hydraulically, electrically, or electrohydraulically) coupled between the cradle 202 (e.g., the lift body 244) and the body 20 and/or the frame 12 of the tractor 10. In general, the side-shift actuator 254 is configured to move the cradle 202, and all the components coupled thereto (e.g., the front gate assemblies 210, the rear retention bar 240, the retention bar actuators 242, etc.), laterally relative to the body 20, which aids in aligning the cradle 202 with the nose landing gear 4. In some embodiments, the side-shift actuator 254 is mounted on the body front wall 250 and is coupled to a tube or shift rod 256. The shift rod 256 may be coupled to the cradle 202 so that movement of the side-shift actuator 254 results in movement of the shift rod 256, and thereby the cradle 202, relative to the body 20. In some embodiments, the shift rod 256 extends through the lift body 244 so that the shift rod 256 slides within the lift body 244 in response to actuation of the side-shift actuator 254.

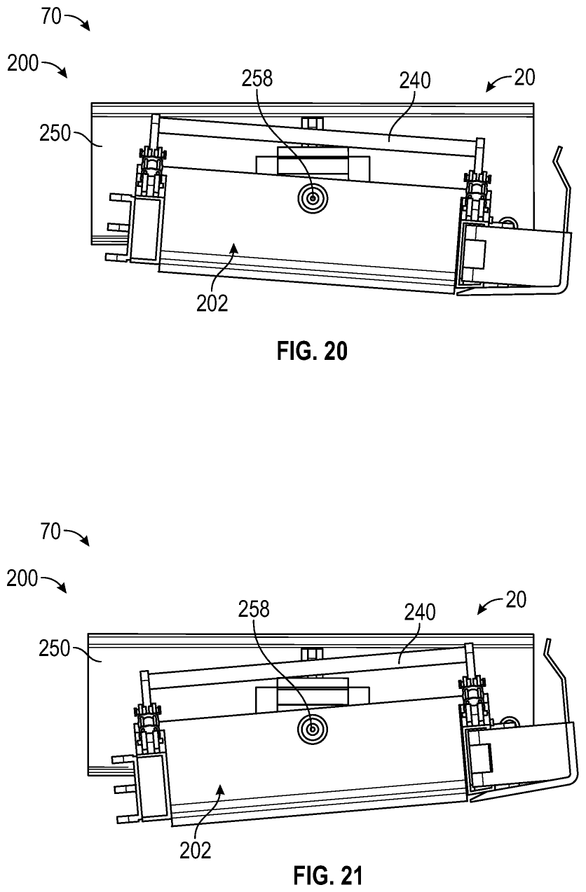

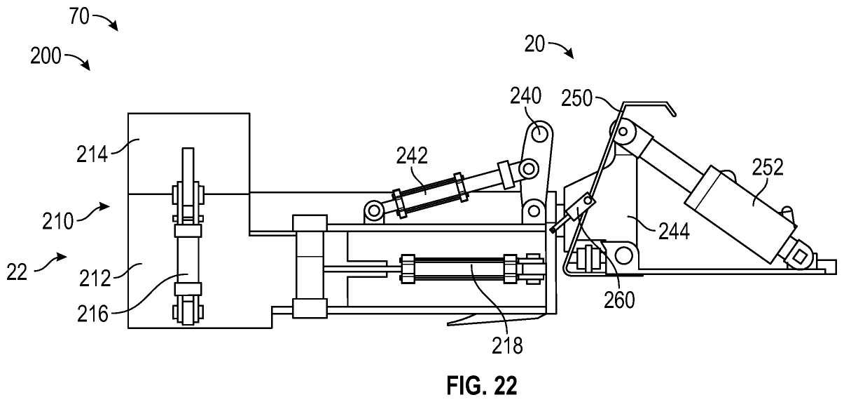

According to the exemplary embodiment shown in FIGS. 20 and 21, the cradle 202 is configured to tilt (e.g., rotate about an axis that intersects a lateral center of the cradle 202). In some embodiments, the hands-free capture system 200 includes a tilt actuator or a tilt motor that is coupled between the body 20 and the cradle 202 or between the lift body 244 and the cradle 202. For example, a tilt motor may be coupled between the cradle pin 246 and the lift body 244 to selectively rotate the cradle 202 about a tilt axis 258 (see, e.g., FIGS. 10, 13, and 14). As shown in FIG. 22, a tilt actuator 260 (e.g., a piston-cylinder actuator that operates hydraulically, electrically, or electrohydraulically) is coupled between the body 20 (e.g., the body front wall 250) and the cradle 202. For example, a first end of the tilt actuator 260 is pivotally coupled to the body 20 (e.g., to the body front wall 250) and an opposing second end of the tilt actuator 260 is pivotally coupled to the cradle 202. In some embodiments, the hands-free capture system 200 includes a single tilt actuator 260 positioned laterally between the cradle pin 246 and a lateral end of the cradle 202. In some embodiments, the hands-free capture system 200 includes two tilt actuators 260, with one of the tilt actuators 260 arranged between the cradle pin 246 and a first lateral end of the cradle 202 and another of the tilt actuators 260 arranged between the cradle pin 246 and a second lateral end of the cradle 202, opposite to the first lateral end.

In general, the lift actuator 252, the side-shift actuator 254, and the tilt actuator 260 enable the cradle 202 to move in three different directions relative to the body 20. For example, the lift actuator 252 is configured to lift the cradle 202 in a lift direction (e.g., a direction perpendicular to the ground), the side-shift actuator 254 is configured to translate or move (e.g., linearly) the cradle 202 in a lateral direction (e.g., a direction perpendicular to the lift direction), and the tilt actuator 260 is configured to rotate the cradle 202 about the tilt axis 258, which is perpendicular to the lateral direction. The various movement directions for the cradle 202 provided by the hands-free capture system 200 aid in the tractor 10 receiving, carrying, and traveling with the nose landing gear 4, as described herein.

As described herein, the hands-free capture system 200 is configured to enable the tractor 10 to efficiently capture the nose landing gear 4 and secure the nose landing gear 4 within the cradle 202. An exemplary operation, method, or process of capturing the nose landing gear 4 using the hands-free capture system 200 will be described with reference to FIGS. 10, 17, and 23-29. Initially, as the tractor 10 approaches the nose landing gear 4, the cradle 202 is in the lowered position (see, e.g., FIG. 10). If the cradle 202 is in the lifted position, the lift actuator 252 is engaged to actuate the cradle 202 from the lifted position to the lowered position. If the cradle 202 is already in the lowered position, the lift actuator 252 maintains the cradle 202 in the lowered position as the nose landing gear 4 approaches.

In some embodiments, the side-shift actuator 254 is engaged to make lateral adjustments to the position of the cradle 202, as the nose landing gear 4 approaches toward the cradle 202, to center the cradle 202 with the wheels 6 of the nose landing gear 4 (e.g., so that both of the wheels 6 are arranged laterally between the sidewalls 206). FIG. 23 shows the nose landing gear 4 received within the cradle 202, with the front gate assemblies 210 in the open position. In the open position, the bottom pivot actuator 218 is actuated so that the front gate assemblies 210, and specifically the front gates 212 and the top retainers 214, are pivoted outwardly away from the bottom plate 204 so that the front gates 212 and the top retainers 214 are arranged laterally outwardly from the respective one of the sidewalls 206. In this way, for example, the front gates 212 and the top retainers 214 are arranged to provide clearance for the nose landing gear 4 to be received within and engaged by the cradle 202, as shown in FIG. 23. With the nose landing gear 4 received within the cradle 202, the wheels 6 are positioned laterally between the sidewalls 206 and the ramped surface defined by the bottom plate 204 ensures that the bottom plate 204 forms a point of contact with the bottom, front portions of each of the wheels 6.

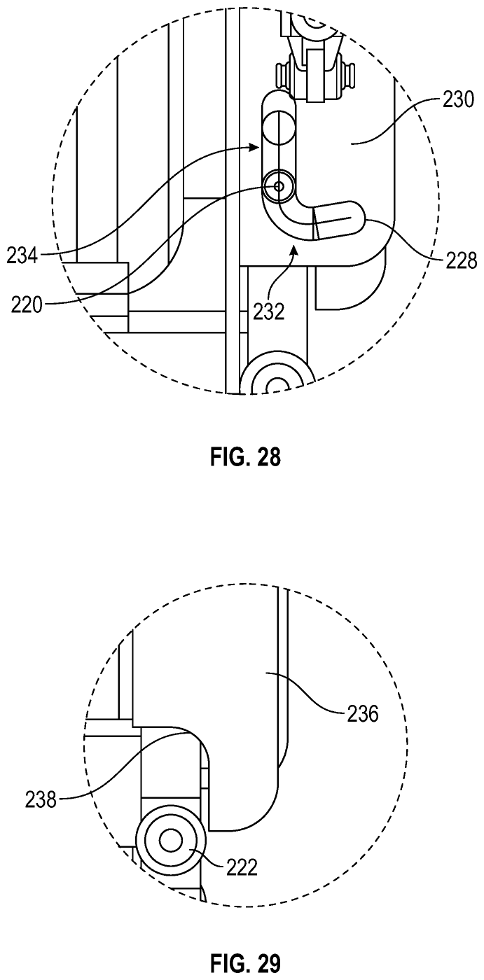

Once the nose landing gear 4 is received within the cradle 202, the front gate assemblies 210 are pivoted from the open position to the closed position, as shown in FIGS. 24-29. Specifically, the bottom pivot actuators 218 are actuated (e.g., retracted) so that the cam pins 220 move along the curved portions 232 of the cam slots 228 (see, e.g., FIG. 28), which results in the front gates 212 and the top retainers 214 pivoting inwardly toward the bottom plate 204, and toward the wheels 6 of the nose landing gear 4. In addition to the cam pins 220 moving along the cam slots 228, the follower pins 222 move around the distal end of the outer bottom walls 236 and engage an edge of the retention cutouts 238 (see, e.g., FIG. 29), which aids in maintaining or holding the front gate assemblies 210 in the closed position and prevents pivoting to the open position.

The amount that the bottom pivot actuators 218 actuate the cam pins 220 along the cam slot 228 may be dependent on a size of the wheels 6 being captured. For example, the further along the linear portion 234 (e.g., away from the curved portion 232) that the cam pins 220 move, the closer the front gates 212 and the top retainers 214 move toward the bottom plate 204. In some embodiments, the bottom pivot actuators 218 move the front gates 212 and the top retainers 214 until the ramped surfaces 224 of the front gates 212 engage the lower, rear portions of the wheels 6 of the nose landing gear 4 to form a point of contact therebetween. Once the front gates 212 engage the wheels 6 of the nose landing gear 4, the top retainer 214 may be pivoted by the top pivot actuators 216 to pivot the top retainers 214 in a direction toward the wheels 6 to form a contact point between the top, rear portions of the wheels 6 and the top retainers 214.

With the nose landing gear 4 captured by the bottom plate 204 and the front gate assemblies 210, an additional contact point may be formed between the nose landing gear 4 and the rear retention bar 240. For example, the retention bar actuators 242 may actuate (e.g., retract) to pivot the rear retention bar 240 in a direction toward the wheels 6 of the nose landing gear 4 so that the rear retention bar 240 engages the top, front portions of the wheels 6 and forms a contact point therewith. With each of the bottom plate 204, the front gates 212, the top retainers 214, and the rear retention bar 240 being in contact with both of the wheels 6 of the nose landing gear 4, the hands-free capture system 200 forms four points of contact with each of the wheels 6 of the nose landing gear 4, which securely captures and supports the nose landing gear 4 within the hands-free capture system 200 and provides stability during travel. With the nose landing gear 4 securely captured within the cradle 202, the nose landing gear 4 may then be lifted by the lift actuator 252 moving the cradle 202 to the lifted position (see, e.g., FIG. 17), and the tractor 10 may tow or pushback the airplane 2.

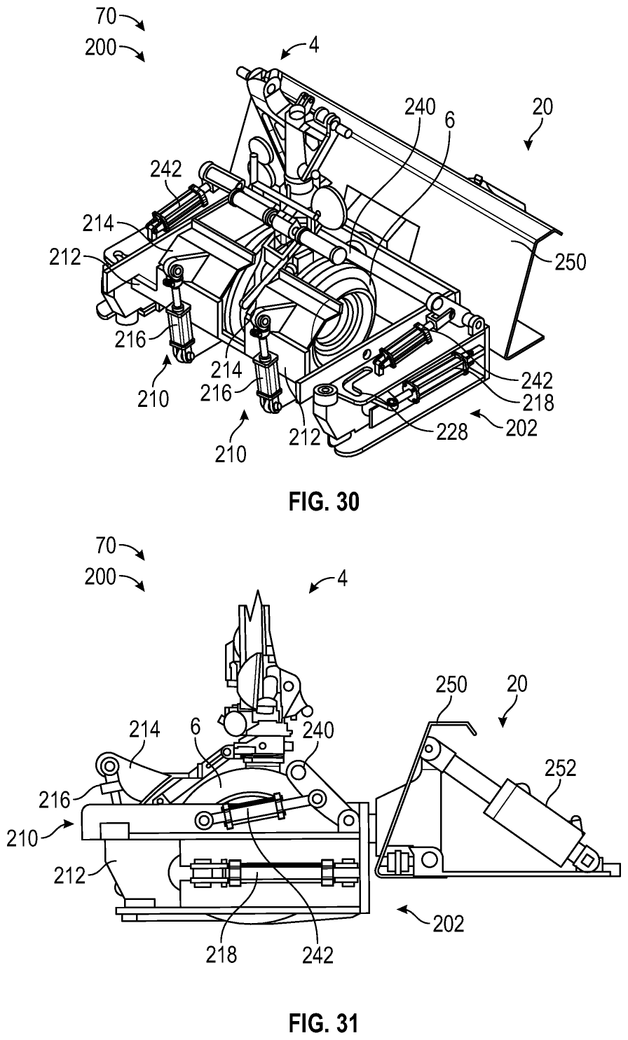

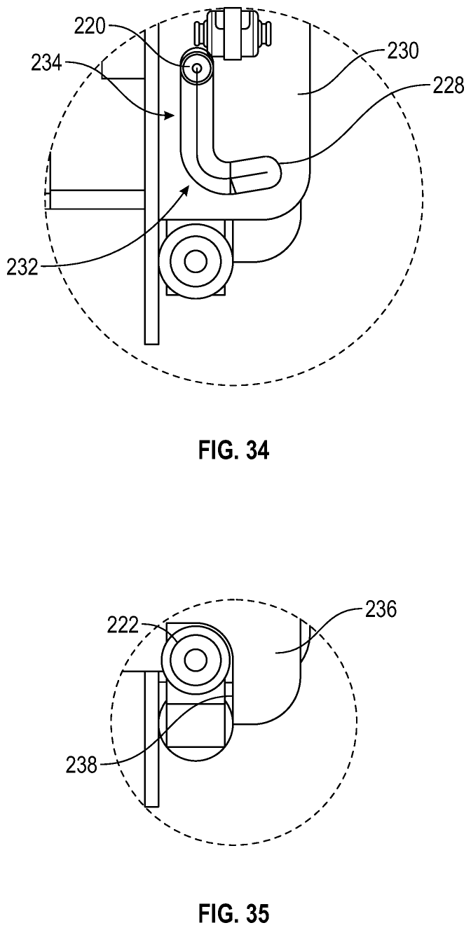

The design and properties of the hands-free capture system 200, for example, including the pivotal actuation of the front gate assemblies 210 and the pivotal movement of the rear retention bar 240, enable the hands-free capture system 200 to capture and lift varying sizes of the nose landing gear 4 with without swapping out any components or requiring differently sized tractors to engage with different airplanes. For example, FIGS. 30-35 show the hands-free capture system 200 with a nose landing gear 4 captured therein that defines a smaller wheel diameter than the nose landing gear 4 of FIGS. 24-29. To facilitate capturing the smaller diameter of the wheels 6 defined by the nose landing gear 4 of FIGS. 30-35, the bottom pivot actuators 218 actuate (e.g., retract) a greater distance so that the cam pins 220 move further along the linear portion 234 of the cam slots 228 (see, e.g., FIG. 34), which moves the front gates 212 and the top retainers 214 closer to the bottom plate 204 (e.g., when compared to FIGS. 24-29). This also moves the follower pins 222 further into the retention cutouts 238 (see, e.g., FIG. 35) to continue to aid in preventing the front gate assemblies 210 from moving to the open position and be maintained in the closed position. Additionally, the top pivot actuators 216 may pivot the top retainers 214 a greater amount (e.g., when compared to FIGS. 24-29) to engage the wheels 6, and the retention bar actuators 242 may pivot the rear retention bar 240 a greater distance toward the bottom plate 204 (e.g., when compared to FIGS. 24-29) to bring the rear retention bar 240 into engagement with the wheels 6. Accordingly, the amount of actuation provided by the top pivot actuator 216, the bottom pivot actuator 218, and the retention bar actuators 242 may be varied to capture different sizes defined by the nose landing gear 4 and the wheels 6 thereof.

### Control System

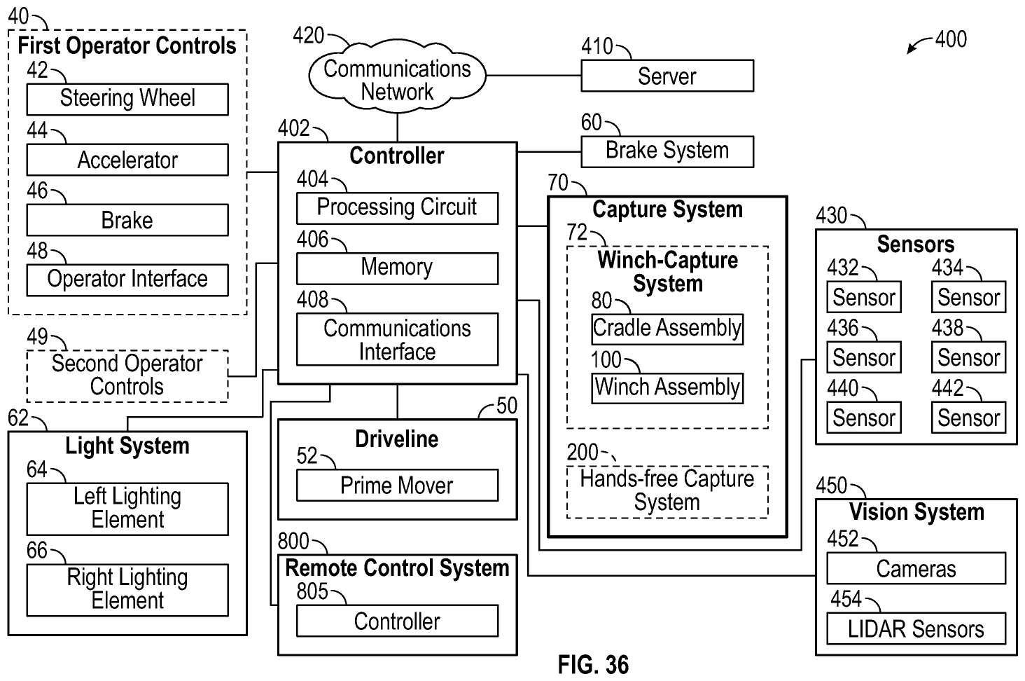

As shown in FIG. 36, the tractor control system 400 includes the first operator controls 40, the second operator controls 49, a controller 402, a remote system, shown as server 410, positioned remote or separate from the tractor 10, one or more first sensors, shown as sensors 430; and a monitoring system, shown as vision system 450. The controller 402 and the server 410 are configured to communicate via one or more communications protocols (e.g., Bluetooth, Wi-Fi, cellular, radio, through the Internet, etc.) through a network, shown as communications network 420.

As shown in FIG. 36, the controller 402 includes a processing circuit 404, a memory 406, and a communications interface 408. The controller 402 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. The processing circuit 404 may include an ASIC, one or more FPGAs, a DSP, circuits containing one or more processing components, circuitry for supporting a microprocessor, a group of processing components, or other suitable electronic processing components. In some embodiments, the processing circuit 404 is configured to execute computer code stored in the memory 406 to facilitate the activities described herein. The memory 406 may be any volatile or non-volatile or non-transitory computer-readable storage medium capable of storing data or computer code relating to the activities described herein. According to an exemplary embodiment, the memory 406 includes computer code modules (e.g., executable code, object code, source code, script code, machine code, etc.) configured for execution by the processing circuit 404. In some embodiments, the controller 402 may represent a collection of processing devices. In such cases, the processing circuit 404 represents the collective processors of the devices, and the memory 406 represents the collective storage devices of the devices.

In one embodiment, the controller 402 is configured to selectively engage, selectively disengage, control, or otherwise communicate with components of the tractor 10 (e.g., via the communications interface 408, a controller area network (“CAN”) bus, etc.). According to an exemplary embodiment, the controller 402 is coupled to (e.g., communicably coupled to) components of the first operator controls 40 (e.g., the steering wheel 42, the accelerator 44, the brake 46, the operator interface 48, etc.), components of the second operator controls 49, components of the driveline 50 (e.g., the prime mover 52), components of the braking system 60, components of the capture system 70 (e.g., the lift actuators 92 of the cradle assembly 80, the motor 102 of the winch assembly 100, the hands-free capture system 200, etc.), the sensors 430, and the vision system 450. By way of example, the controller 402 may send and receive signals (e.g., control signals, location signals, etc.) with the components of the first operator controls 40, the components of the second operator controls 49, the components of the driveline 50, the components of the braking system 60, the components of the capture system 70, the sensors 430, the vision system 450, and/or remote systems or devices (via the communications interface 408) including the server 410. By way of another example, the controller 402 may make determinations and control operation of the one or more components of the tractor 10 responsive to signals received by the sensors 430 and/or the vision system 450 indicative of the data captured thereby.

The sensors 430 may include various sensors positioned about the tractor 10 to acquire tractor information or tractor data regarding operation of the tractor 10 and/or the location thereof. By way of example, the sensors 430 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring tractor information or tractor data regarding operation of the tractor 10 and/or the location thereof. According to an exemplary embodiment, one or more of the sensors 430 are configured to facilitate detecting and obtaining data relating to the airplane 2 and one or more components thereof including a position of the airplane 2 relative to the tractor 10, a position of the wheels 6 relative to the cradle 82 (e.g., an angle of the wheels 6, a lateral/longitudinal position of the wheels 6 relative to the sidewalls 86 and/or the bottom plate 84, etc.), a type of aircraft (e.g., manufacturer, model, size, etc.), and/or other aircraft data. According to another exemplary embodiment, one or more of the sensors 430 are configured to facilitate detecting and obtaining data relating to the operation of the tractor 10 and one or more components thereof including a position of the cradle 82 (e.g., a distance the cradle 82 is from the ground surface, length of extension of the lift actuators 92, whether the cradle 82 is in the first, raised position or the second, lowered position, etc.), whether the winch hook 108 and/or the airplane coupler 110 are stored inside of the storage compartment 112, a speed of the tractor 10, a position of the tractor 10, and/or other tractor data.

As shown in FIGS. 2, 3, and 36, the sensors 430 include a first sensor (e.g., a limit switch, a position sensor, a mechanical switch, etc.), shown as sensor 432, configured to detect whether an operator is sitting on the seat 36. By way of example, the sensor 432 may be coupled with the seat 36 such that when the operator sits in the seat 36, the seat 36 comes into contact or otherwise engages the sensor 432. Responsive to engagement of the sensor 432, a determination may be made by the controller 402 or the server 410 that the operator is sitting in the seat 36. In some embodiments, the sensor 432 is another type of sensor (e.g., vision sensor, camera, etc.) configured to detect the presence or absence of the operator in the forward travel compartment 32 and/or the rearward travel compartment 34. While only shown as being coupled to one of the seats 36, it should be understood that the sensors 432 may be coupled to both seats 36.

As shown in FIGS. 2, 5, and 36, the sensors 430 include one or more second sensors (e.g., a wheel angle sensor, a potentiometer, a string potentiometer, an accelerometer, an inertial measurement unit, etc.), shown as sensors 434, configured to detect a steering angle of the tractive elements of the front tractive assembly 56 and/or the rear tractive assembly 58. As shown in FIGS. 2 and 5, the sensors 434 are positioned at or proximate the left tractive elements of the front tractive assembly 56 and the right tractive elements of the front tractive assembly 56. In some embodiments, the sensors 434 are additionally or alternatively positioned at or proximate the left tractive elements of the rear tractive assembly 58 and the right tractive elements of the rear tractive assembly 58.

As shown in FIGS. 2, 5, and 36, the sensors 430 include a third sensor (e.g., a nose gear sensor, a proximity sensor, a camera, etc.), shown as sensor 436, configured to detect the position of the nose landing gear 4 relative to the capture system 70. By way of example, the sensor 436 may be coupled to the cradle 82 at a position corresponding to a position where the nose landing gear 4 is fully loaded onto the cradle 82 if the sensor 436 detects the nose landing gear 4. In such an example, responsive to a detection of the nose landing gear 4 (e.g., the wheels 6) by the sensor 436, a determination may be made by the controller 402 that the nose landing gear 4 is fully loaded onto the cradle 82. By way of another example, the sensor 436 may be coupled to the hands-free capture system 200 to detect a position of the nose landing gear 4 relative to the cradle to determine whether the nose landing gear 4 is in a suitable position to be raised from the ground surface by the cradle. In some embodiments, the sensor 436 is otherwise configured and/or positioned to detect a position of the wheels 6 relative to the capture system 70 (e.g., an angle of the wheels 6, a lateral/longitudinal position of the wheels 6 relative to the sidewalls 86 and/or the bottom plate 84, a position of the plurality of arms and the cradle relative to the wheels 6, etc.).

As shown in FIGS. 2, 5, and 36, the sensors 430 include a fourth sensor (e.g., a switch plate sensor, a position sensor, a mechanical switch, etc.), shown as sensor 438, configured to detect a position of the switch plate 90. By way of example, when the nose landing gear 4 comes into contact with the switch plate 90, the switch plate 90 pivots and comes into contact or otherwise engages with the sensor 438. In such an example, responsive to engagement of the sensor 438, a determination may be made by the controller 402 that the nose landing gear 4 is fully loaded by the capture system 70 (e.g., onto the cradle 82 and winching operations may be stopped).

As shown in FIGS. 2, 5, and 36, the sensors 430 include a fifth sensor (e.g., a winch sensor, a load sensor, a position sensor, a speed sensor, etc.), shown as sensor 440, configured to monitor operation of the winch-capture system 72. By way of example, the sensor 440 may include a load sensor or strain gauge configured to monitor the tension or strain on the winch strap 106 during loading and unloading operations. By way of another example, the sensor 440 may include a rotary encoder configured to monitor the rotation of the winch drum 104 to determine a length of the winch strap 106 that has been wound or unwound therefrom and/or a rate at which the winch strap 106 is wound or unwound therefrom.

As shown in FIGS. 2, 5, and 36, the sensors 430 include a sixth sensor (e.g., a winch hook sensor, a position sensor, a proximity sensor, etc.), shown as sensor 442, configured to monitor the position of the winch hook 108 and/or the airplane coupler 110. By way of example, the sensor 442 may be configured to facilitate determining whether the winch hook 108 and/or the airplane coupler 110 is secured by the storage compartment 112. By way of another example, the sensor 442 may be configured to facilitate monitoring the position of the winch hook 108 and/or the airplane coupler 110 to determine whether the winch hook 108 and/or the airplane coupler 110 are sufficiently retracted. In some embodiments, a determination is made that (i) the winch hook 108 and the airplane coupler 110 are sufficiently retracted and/or (ii) the winch hook 108 and/or the airplane coupler 110 are secured using the storage compartment 112 when a mechanical, electromechanical, electrical, magnetic, etc. connection is established between the sensor 442 and the winch hook 108 and/or the airplane coupler 110. By way of example, the connection may be established via physical contact or sufficiently close proximity between the sensor 442 and the winch hook 108 and/or the airplane coupler 110. When the connection is made, a determination may be made by the controller 402 that (i) the winch hook 108 and the airplane coupler 110 are sufficiently retracted and/or (ii) the winch hook 108 and/or the airplane coupler 110 are secured using the storage compartment 112. Monitoring whether the winch hook 108 and the airplane coupler 110 are sufficiently retracted and whether the winch hook 108 and/or the airplane coupler 110 are secured using the storage compartment 112 helps prevent unintentional movement thereof during driving operations of the tractor 10 and may facilitate prevention of driving the tractor 10 without first retracting or winding up the winch hook 108 and/or the airplane coupler 110.

The vision system 450 includes one or more first sensors, shown as cameras 452, and one or more second sensors, shown as LIDAR sensors 454. The cameras 452 and the LIDAR sensors 454 may be variously positioned about the tractor 10 to acquire tractor information or tractor data regarding operation of the tractor 10, operation of the airplane 2, and/or a surrounding environment. The cameras 452 are configured to capture image data including videos and/or still images. The LIDAR sensors 454 are configured to capture distance measurements, three-dimensional maps, perform object detection and recognition, and/or capture other LIDAR data. The image data from the cameras 452 and the LIDAR data from the LIDAR sensors 454 may be transmitted to the operator interface 48 and/or the second operator controls 49 to be displayed on the one or more displays thereof. According to an exemplary embodiment, one or more of the cameras 452 and/or LIDAR sensors 454 are configured to facilitate obtaining data relating to the airplane 2 and one or more components thereof including a position of the airplane 2 relative to the tractor 10, a position of the wheels 6 relative to the capture system 70 (e.g., an angle of the wheels 6, a lateral/longitudinal position of the wheels 6 relative to the sidewalls 86 and/or the bottom plate 84, etc.), a height of a fuselage of the airplane 2, a height of the turbines on the airplane 2, a wing height of the airplane 2, and/or other aircraft image data. According to another exemplary embodiment, one or more of the cameras 452 and/or LIDAR sensors 454 are configured to facilitate obtaining data relating to the operation of the tractor 10 and one or more components thereof including a position of components of the capture system 70 and/or other tractor data. In some embodiments, the cameras 452 and/or LIDAR sensors 454 are configured to continuously capture data or periodically capture data (e.g., take a picture every 1 second, 5 seconds, 30 seconds, etc., record a 30 second, 1 minute, 5 minute, etc., long video every 30 seconds, 1 minute, 5 minutes, etc., capture data every 1 second, 5 seconds, 30 seconds, etc.). The cameras 452 and/or LIDAR sensors 454 may be configured to capture data responsive to an event (e.g., a detection that the tractor 10 crashed, a detection that the airplane 2 crashed, a detection of an improper alignment of the airplane 2 with the capture system 70, a detection that the airplane 2 is not present when it should be present, at the completion of capturing the nose landing gear 4, etc.) and communicate the data captured before the detection of the event (e.g., 30 seconds before, 1 minute before, 5 minutes before, etc.), after the detection of the event (e.g., 30 seconds after, 1 minute after, 5 minutes after, etc.), and/or during the detection of the event. In some embodiments, the data captured by the vision system 450 is used to autonomously drive the tractor 10 (e.g., with or without the airplane 2 coupled therewith), recognize one or more objects (e.g., recognize an operator, recognize a type of the airplane 2, etc.), detect one or more objects or hazards and control one or more components of the tractor 10 to avoid a collision with the hazard or object, assist the operator to perform one or more functions (e.g., assist in aligning the capture system 70 with the airplane 2), and/or for one or more other processes.

The server 410 may include one or more processors that execute one or more software programs to perform various processes. The server 410 may include processors and non-transitory, computer readable medium including instructions, which, when executed by the processors, cause the processors to perform methods disclosed herein. The processor may include any number of physical, hardware processors. Although FIG. 36 shows only a single server 410, the server 410 may include any number of computing devices. The server 410 may perform all or portions of the processes performed by the controller 402.

The server 410 may be configured to facilitate operator access to dashboards including the aircraft data, the tractor data, the image data, information available to the controller 402, etc. to manage and operate the tractor 10 such as to control operations of the winch-capture system 72, controlling operations of the hands-free capture system 200, remotely operating the tractor 10, etc. By way of example, the server 410 may be accessible via a user device (e.g., computer, laptop, smartphone, tablet, smart watch, a remote controller, etc.). The server 410 may also be configured to facilitate operator implementation of configurations and/or parameters for the tractor 10 (e.g., setting speed limits, setting wheel angle limits, etc.). Such configurations and/or parameters may be propagated to the controller 402 of the tractor 10 via the communications network 420 (e.g., as updates to settings) and/or used for real time control of the tractor 10 by the server 410.

### Vertical Lift Assembly

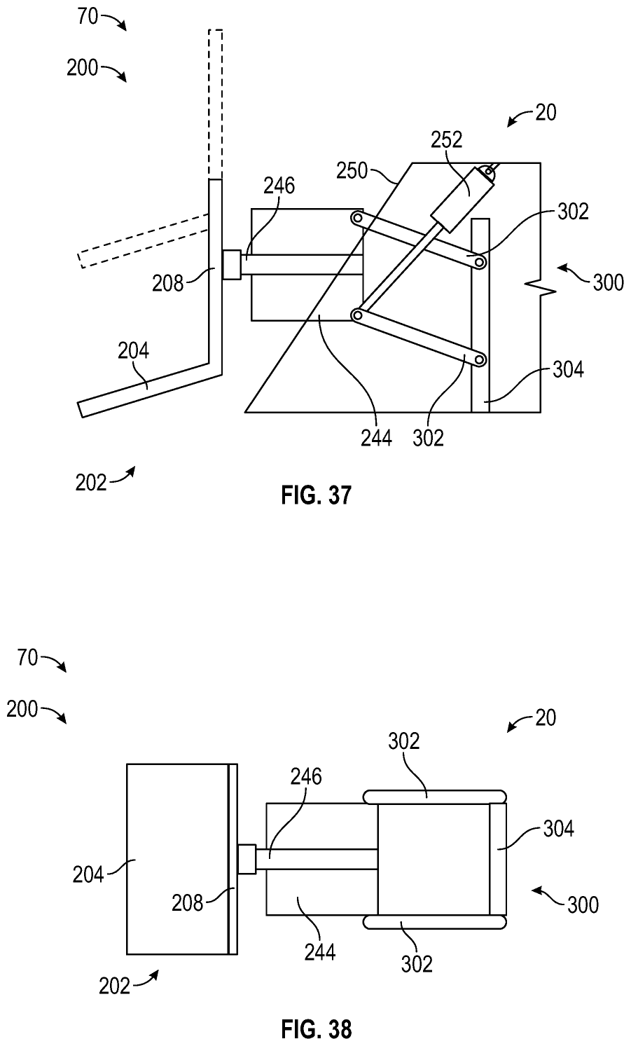

In some embodiments, the lift actuator 252 is configured to linearly raise and lower the cradle 202 (e.g., so that the cradle 202 is raised and lowered in a direction that is perpendicular or substantially perpendicular to the ground). As shown in FIGS. 37 and 38, the hands-free capture system 200 includes a linkage assembly, shown as linkage lift assembly 300, coupled between the body 20 (and/or the frame 12) and the lift body 244. The inclusion of the linkage lift assembly 300 and the orientation of the lift actuator 252 enable the cradle 202 to be raised/lowered linearly and vertically (e.g., not pivoted) so that the cradle 202 is maintained at an approximately constant distance from the body 20 (e.g., does not pivot toward or away from the body 20 as shown in the dashed lines in FIG. 37).

As shown in FIGS. 37 and 38, the linkage lift assembly 300 includes a plurality of linkages 302 that are pivotally coupled at one end to the lift body 244 (e.g., to the laterally outer sides of the lift body 244) and pivotally coupled to a support, shown as body wall 304, at an opposing end. In some embodiments, the linkage lift assembly 300 is a four-bar linkage with one pair of the linkages 302 being coupled to opposing lateral sides of the lift body 244 and vertically spaced from another pair of linkages 302 that are coupled opposing lateral sides of the lift body 244. The vertically-spaced pairs of the linkages 302 may be arranged parallel to one another. In some embodiments, the linkage lift assembly 300 includes more or less than four linkages 302 (e.g., two linkages 302 connected at the center of the lift body 244).

In some embodiments, the lift actuator 252 is pivotally coupled between the body 20 (and/or the frame 12) and the linkage lift assembly 300. For example, the lift actuator 252 may be pivotally coupled between the body 20 and one of the linkages 302, or pivotally coupled between the body 20 and two of the linkages 302. In some embodiments, the lift actuator 252 is pivotally coupled between the body 20 and the linkage lift assembly 300. Regardless of the particular coupling orientation of the lift actuator 252, movement of the lift actuator 252 is configured to raise and lower the cradle 202. By way of example, extension of the lift actuator 252 may pivot the linkage lift assembly 300 so that the lift body 244 and the cradle 202 coupled thereto are lowered vertically (e.g., in a direction perpendicular to the ground or in a direction perpendicular to a top surface of the body 20), and retraction of the lift actuator 252 may pivot the linkage lift assembly 300 so that the lift body 244 and the cradle 202 coupled thereto are raised vertically. In some embodiments, the lift actuator 252 may be arranged so that extension of the lift actuator 252 vertically raises the lift body 244 and the cradle 202, and retraction of the lift actuator 252 vertically lowers the lift body 244 and the cradle 202. In general, the vertical raising and lowering of the cradle 202 provided by the lift actuator 252 and the linkage lift assembly 300 may be implemented when the hands-free capture system 200 lifts the nose landing gear 4 and the wheels 6 thereof.

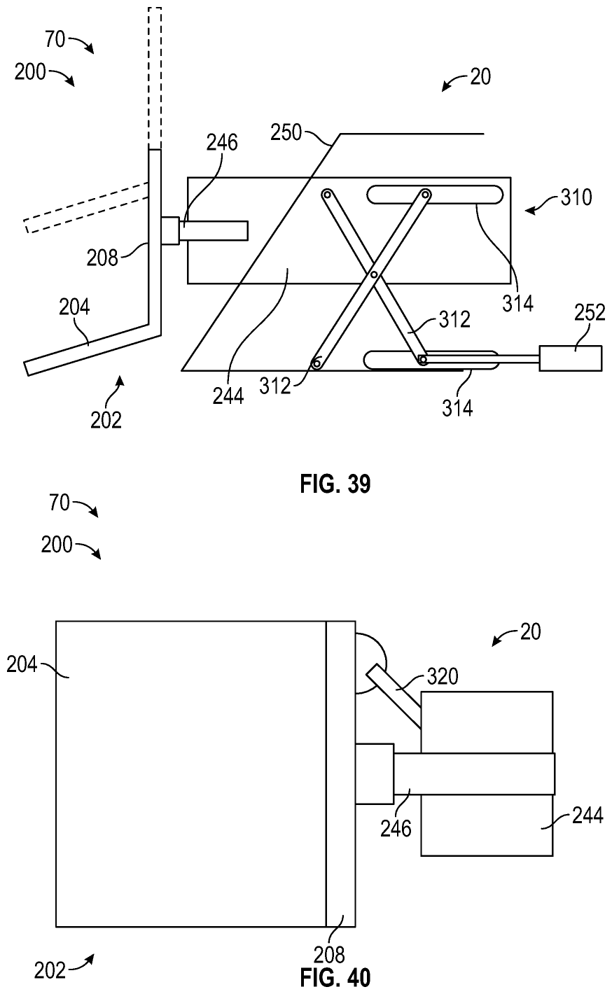

As shown in FIG. 39, the hands-free capture system 200 including a retractable lift mechanism, shown as scissor lift assembly 310, coupled between the body 20 (and/or frame 12) and the lift body 244. In general, the scissor lift assembly 310 is configured to vertically raise and lower the cradle 202 (e.g., not pivoted) so that the cradle 202 is maintained at an approximately constant distance from the body 20 (e.g., does not pivot toward or away from the body 20 as shown in the dashed lines in FIG. 39). A first end of the scissor lift assembly 310 is coupled to the lift body 244 and a second, opposing, end of the scissor lift assembly 310 is coupled to the body 20 (e.g., to a bottom wall of the body 20).

As shown in FIG. 39, the scissor lift assembly 310 includes a plurality of linked, foldable support members, shown as support linkages 312. In general, the lift actuator 252 is coupled to the scissor lift assembly 310 so that the scissor lift assembly 310 is selectively movable between a retracted or lowered position and an extended or raised position. The lift actuator 252 controls the orientation of the scissor lift assembly 310 by selectively applying force to the scissor lift assembly 310. When a sufficient force is applied to the scissor lift assembly 310 by the lift actuator 252, the scissor lift assembly 310 unfolds or otherwise deploys from the stowed, lowered position. Because the lift body 244 is coupled to the scissor lift assembly 310, the lift body 244 and the cradle 202 coupled thereto are also vertically raised away relative to the body 20 in response to the deployment of the scissor lift assembly 310.

As shown in FIG. 39, the lift actuator 252 is coupled to at least one of the support linkages 312 so that the lift actuator 252 moves the support linkage 312 along a track 314 formed within the body 20. An opposing end of the support linkage 312 arranged within the track 314 is pivotally coupled to the lift body 244 so that the end of the support linkage 312. Another of the support linkages 312 is arranged at one end within a body track 316 formed within the lift body 244, and pivotally coupled to the body 20 at an opposing end thereof. In general, as the lift actuator 252 displaces the support linkages 312 within the track 314, the support linkages 312 fold and unfold to vertically raise and lower the lift body 244 and the cradle 202 coupled thereto. The vertical raising and lowering of the cradle 202 provided by the lift actuator 252 and scissor lift assembly 310 may be implemented when the hands-free capture system 200 lifts the nose landing gear 4 and the wheels 6 thereof.

### Nose Landing Gear Torque Sensing

In some embodiments, the tractor 10 includes one or more torque sensors (e.g., a load sensor, a load cell, a pressure sensors, etc.) that are coupled to one or more components of the hands-free capture system 200 (or the winch-capture system 72) to facilitate measuring a torque applied to the nose landing gear 4 when the nose landing gear 4 is captured by the hands-free capture system 200. In general, the ability to sense and measure a torque applied to the nose landing gear 4 enables the tractor 10 to be controlled based on the torque (e.g., controlled steering, controlled speed, controlled brake force, etc.), which reduces the amount of torque placed on the nose landing gear 4 during travel.

FIG. 40 shows an exemplary embodiment of the hands-free capture system 200 including a torque sensor 320 coupled between the cradle 202 and body 20. In some embodiments, the torque sensor 320 is in the form of a strain gauge or a load cell. In some embodiments, the torque sensor 320 is coupled between the back wall 208 and the body 20. In some embodiments, the torque sensor 320 is coupled between the cradle 202 and the lift body 244. In some embodiments, the torque sensor 320 is coupled between the cradle 202 and the body front wall 250. In some embodiments, the hands-free capture system 200 includes more than one torque sensor 320. For example, the hands-free capture system 200 may include two torque sensors 320 coupled between the cradle 202 and the body 20, with one of the torque sensors 320 arranged on opposing lateral sides of the cradle pin 246. Regardless of the particular arrangement of the torque sensor 320, the torque sensor 320 is configured to measure the torque applied between the cradle 202 and the nose landing gear 4 (e.g., rotational force applied to the cradle 202 by the nose landing gear 4 about the tilt axis 258, or a rotational force applied to the nose landing gear 4 by the cradle 202).

As shown in FIG. 43, the torque sensor 320 is in communication with the controller 402, and the controller 402 is configured to control operation of the tractor 10 (e.g., the driveline 50, the braking system 60, the tilt actuator(s) 260, etc.) based on the torque measured by the torque sensor 320. In some embodiments, the controller 402 is configured to control the driveline 50 and the braking system 60 to limit a steering angle or turning radius, limit a speed of the tractor, and/or limit a braking force based on the torque measured by the torque sensor 320. In some embodiments, the controller 402 is configured to control the tilt actuator(s) 260 to reduce the torque on the nose landing gear 4 based on the torque measured by the torque sensor 320. For example, in response to the torque sensor 320 measuring a torque equal to or above a first torque threshold, the controller 402 may limit a speed of the tractor 10 to a first speed threshold, limit a turning radius or steering angle of the front tractive assembly 56 and/or the rear tractive assembly 58 to a first turning threshold, limit a braking force of the braking system 60 to a first brake threshold, and/or engage the tilt actuator(s) 260 to counteract the torque to reduce the torque (e.g., equal to or below the first torque threshold).

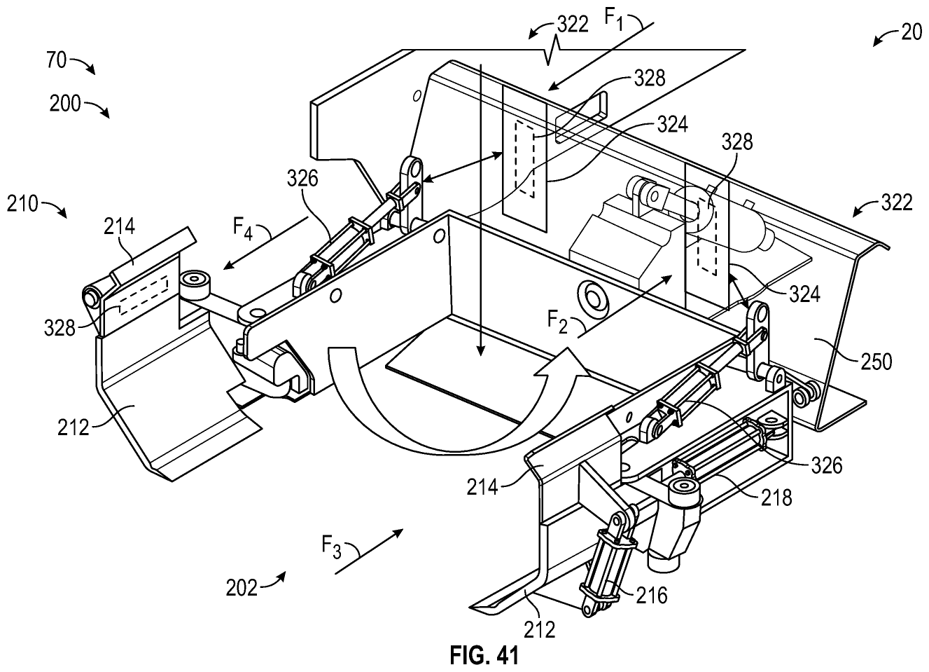

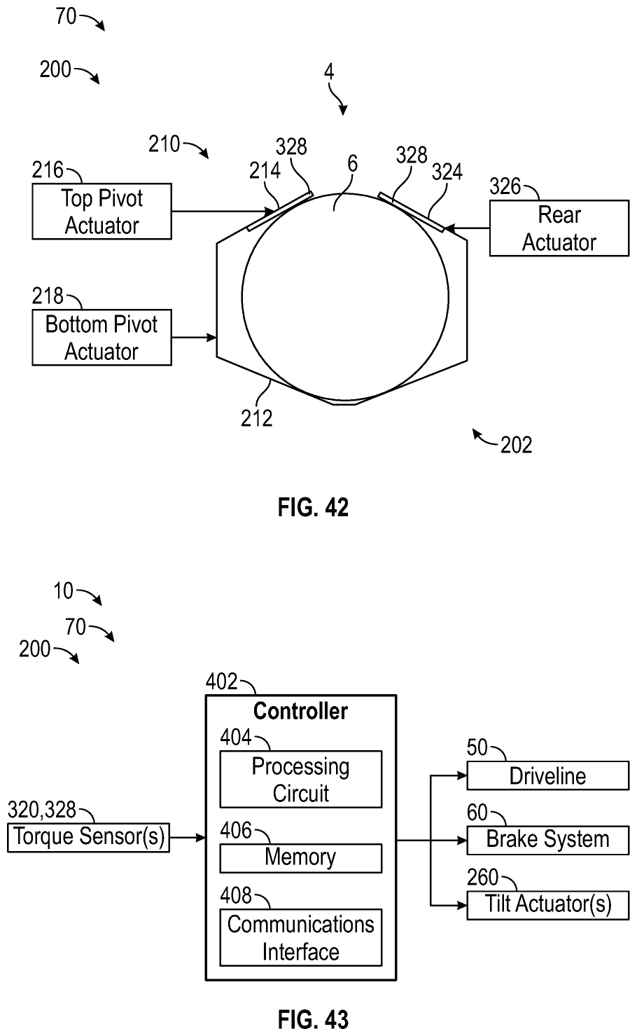

FIGS. 41 and 42 show an exemplary embodiment of the hands-free capture system 200 where the rear retention bar 240 is replaced with a pair of rear gate assemblies 322. In general, each of the rear gate assemblies 322 may be similar in design and operation to the top retainer 214 and the top pivot actuator 216 of the front gate assemblies 210. For example, each of the rear gate assemblies 322 includes a rear retainer 324 and a corresponding rear actuator 326. The rear actuators 326 are configured to pivotally move the rear retainers 324 (e.g., in a direction toward and away from the bottom plate 204) so that the rear retainers 324 engage and form a contact point with a top, front portion of the wheels 6 on the nose landing gear 4 (see, e.g., FIG. 39).

The hands-free capture system 200 may include a torque sensor 328 arranged on each of the top retainers 214 and the rear retainers 324 (e.g., first torque sensors arranged on the top retainers 214 and second torque sensors arranged on the rear retainers 324). In some embodiments, each of the torque sensors 328 is coupled to an inner surface of the top retainers 214 and the rear retainers 324, which is configured to face and engage the wheels 6 of the nose landing gear 4. In this way, for example, the torque sensors 328 are configured to measure the clamping force placed on the wheels 6 of the nose landing gear 4 on two different sides of each of the wheels 6 (e.g., a top, front portion and a top, rear portion of each of the wheels 6) and these clamping force measurements are correlated to a torque applied between the nose landing gear 4 and the cradle 202 (e.g., rotational force applied to the cradle 202 by the nose landing gear 4 about the tilt axis 258, or a rotational force applied to the nose landing gear 4 by the cradle 202). In some embodiments, each of the torque sensors 328 is in the form of a load cell, or a pancake load cell. In some embodiments, the torque sensors 328 arranged on the front gate assemblies 210 are additionally or alternatively coupled to the top retainers 214.

As shown in FIG. 43, the torque sensors 328 are in communication with the controller 402, and the controller 402 is configured to control operation of the tractor 10 (e.g., the driveline 50, the braking system 60, the tilt actuator(s) 260, etc.) based on the torque measured by the torque sensors 328. In some embodiments, the controller 402 is configured to control the driveline 50 and the braking system 60 to limit a steering angle or turning radius, limit a speed of the tractor, and/or limit a braking force based on the torque measured by the torque sensors 328. In some embodiments, the controller 402 is configured to control the tilt actuator(s) 260 to reduce the torque on the nose landing gear 4 based on the torque measured by the torque sensors 328. For example, in response to the torque sensors 328 measuring a torque equal to or above a first torque threshold, the controller 402 may limit a speed of the tractor 10 to a first speed threshold, limit a turning radius or steering angle of the front tractive assembly 56 and/or the rear tractive assembly 58 to a first turning threshold, limit a braking force of the braking system 60 to a first brake threshold, and/or engage the tilt actuator(s) 260 to counteract the torque to reduce the torque (e.g., equal to or below the first torque threshold).

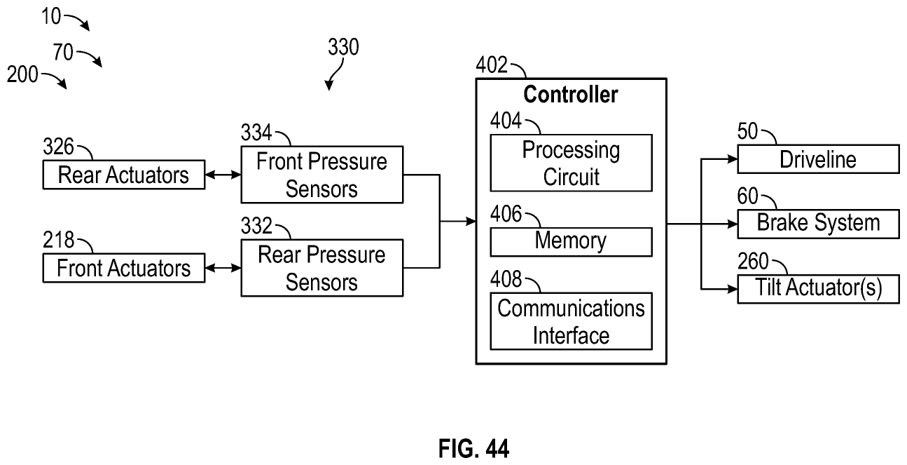

FIG. 44 shows an exemplary embodiment of the hands-free capture system 200 including a plurality of pressure sensors 330 that are configured to measure a pressure within the actuators of the hands-free capture system 200. Specifically, the pressure sensors 330 include a front pressure sensor 332 for each of the bottom pivot actuators 218 that are configured to measure a pressure within the bottom pivot actuators 218 (e.g., a pressure within a cylinder chamber or within a rod chamber) and a rear pressure sensor 334 for each of the rear actuators 326 (e.g., a pressure within a cylinder chamber or within a rod chamber) that are configured to measure a pressure within the rear actuators 326. In general, the pressure measured by the front pressure sensors 332 is correlated to a holding force provided by the front gate assemblies 210 on the wheels 6 of the nose landing gear 4, and the pressure measured by the rear pressure sensors 334 is correlated to a holding force provided by the rear gate assemblies 322 on the wheels 6 of the nose landing gear 4. And all the pressures and corresponding holding forces measured by the front pressure sensors 332 and the rear pressure sensors 334 are combined and correlated to a torque between the nose landing gear 4 and the cradle 202 (e.g., rotational force applied to the cradle 202 by the nose landing gear 4 about the tilt axis 258, or a rotational force applied to the nose landing gear 4 by the cradle 202).

As shown in FIG. 44, the pressure sensors 330, including the front pressure sensors 332 and the rear pressure sensors 334, are in communication with the controller 402, and the controller 402 is configured to control operation of the tractor 10 (e.g., the driveline 50, the braking system 60, the tilt actuator(s) 260, etc.) based on the torque measured by the pressure sensors 330. In some embodiments, the controller 402 is configured to control the driveline 50 and the braking system 60 to limit a steering angle or turning radius, limit a speed of the tractor, and/or limit a braking force based on the torque measured by the pressure sensors 330. In some embodiments, the controller 402 is configured to control the tilt actuator(s) 260 to reduce the torque on the nose landing gear 4 based on the torque measured by the pressure sensors 330. For example, in response to the pressure sensors 330 measuring a torque equal to or above a first torque threshold, the controller 402 may limit a speed of the tractor 10 to a first speed threshold, limit a turning radius or steering angle of the front tractive assembly 56 and/or the rear tractive assembly 58 to a first turning threshold, limit a braking force of the braking system 60 to a first brake threshold, and/or engage the tilt actuator(s) 260 to counteract the torque to reduce the torque (e.g., equal to or below the first torque threshold).

In some embodiments, the pressure sensors 330 are included on the hands-free capture system 200 as an alternative to the torque sensor 320 and/or the torque sensors 328. In some embodiments, the pressure sensors 330 are included on the hands-free capture system 200 in addition to the torque sensor 320 and/or the torque sensors 328 and the combined data from the torque sensor 320, the torque sensors 328, and/or the pressure sensors 330 is used to determine a torque on the nose landing gear 4 and control operation of the tractor 10.

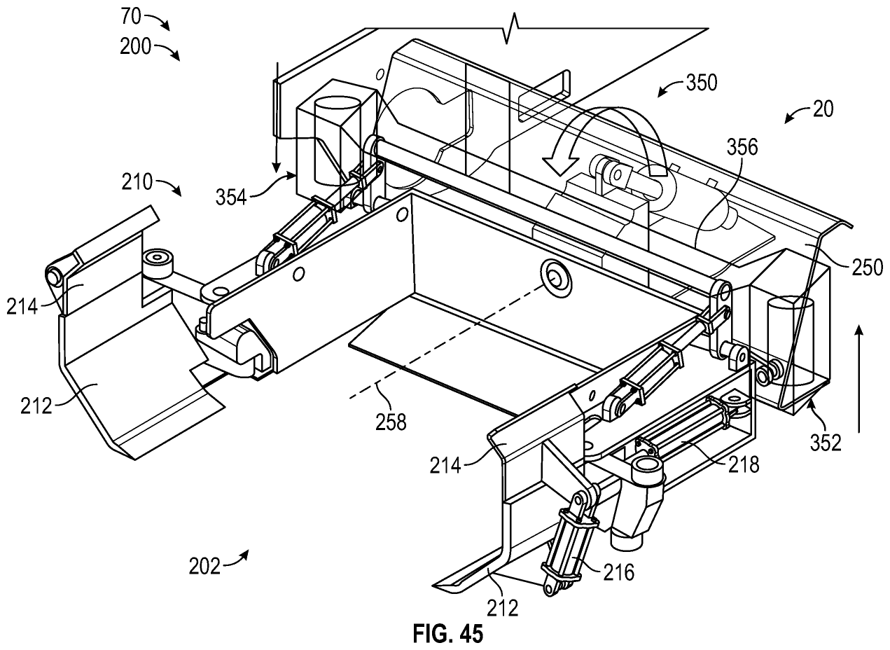

FIGS. 45-47 show an exemplary embodiment of the hands-free capture system 200 including a tilt actuator assembly 350 that is configured to provide tilting operations (e.g., rotation about the tilt axis 258) and enable the cradle 202 to float about the tilt axis 258 so that the tilt defined by the cradle 202 conforms to the torque of the nose landing gear 4, for example, during turning operations performed by the tractor 10. In some embodiments, the tilt actuator assembly 350 includes a first tilt actuator 352, a second tilt actuator 354, and a cross beam 356 coupled between the first tilt actuator 352 and the second tilt actuator 354. The first tilt actuator 352 and the second tilt actuator 354 are coupled to laterally opposing sides of the cradle 202 (e.g., coupled to a first lateral side and a second lateral side, respectively). In some embodiments, the first tilt actuator 352 and the second tilt actuator 354 are fixed to the body 20 (e.g., to the body front wall 250) and coupled to the cradle 202 (e.g., to a rear side of the back wall 208) so that rotation of the cradle 202 about the tilt axis 258 forces fluid between the first tilt actuator 352 and the second tilt actuator 354. In other words, the first tilt actuator 352 and the second tilt actuator 354 are coupled between the body 20 and the cradle 202 so that as the cradle 202 moves relative to the body 20 about the tilt axis 258, one of the first tilt actuator 352 and the second tilt actuator 354 extends and the other of the first tilt actuator 352 and the second tilt actuator 354 retracts.

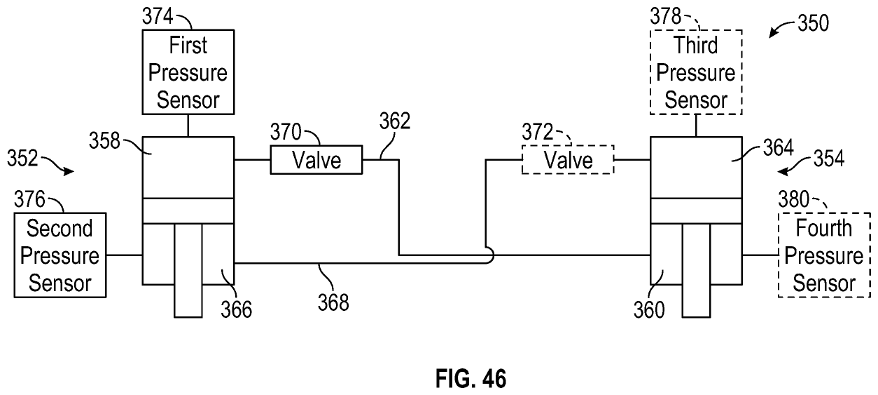

As shown in FIG. 46, the first tilt actuator 352 is cross-plumbed with the second tilt actuator 354, which provides the opposition movement between the two actuators as the cradle 202 tilts (i.e., one actuator extends while the other retracts). For example, a piston chamber 358 of the first tilt actuator 352 is in fluid communication with a rod chamber 360 of the second tilt actuator 354 by a first fluid line or conduit 362, and a piston chamber 364 of the second tilt actuator 354 is in fluid communication with a rod chamber 366 of the first tilt actuator 352 by a second fluid line or conduit 368. In some embodiments, a valve 370 is arranged on the first fluid line 362 and is configured to control or limit a fluid flow rate along the first fluid line 362. In some embodiments, the valve 370 is in the form of an orifice, a variable orifice, a spool valve, an electrohydraulic valve, an electrohydraulic spool valve, or an equivalent fluid control mechanism. In general, the valve 370 may be configured to control the rate at which the cradle 202 is allowed to tilt or rotate about the tilt axis 258 and thereby control the amount of torque that is transferred between the nose landing gear 4 and the cradle 202. Additionally, the cross-plumbing between the first tilt actuator 352 and the second tilt actuator 354 enables the cradle 202 to rotate with (e.g., in response to) the torque of the nose landing gear 4, which reduces the amount of torque on the nose landing gear 4 as the tractor 10 travels and turns. In some embodiments, a second valve 372 is provided along the second fluid line 368, either alternatively or in addition to the valve 370, to control or limit a fluid flow rate along the second fluid line 368. In some embodiments, the second valve 372 is in the form of an orifice, a variable orifice, a spool valve, an electrohydraulic valve, an electrohydraulic spool valve, or an equivalent fluid control mechanism.

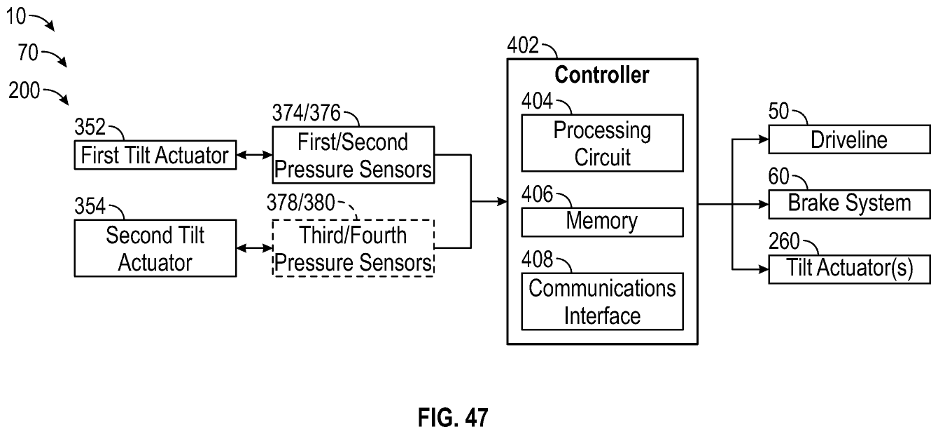

As shown in FIGS. 46 and 47, in some embodiments, the tilt actuator assembly 350 includes one or more pressure sensors that are configured to sense a pressure differential between the piston chamber and the rod chamber on at least one of the first tilt actuator 352 and the second tilt actuator 354 to determine a torque on the nose landing gear 4 received within the cradle 202. By way of example, the tilt actuator assembly 350 may include a first pressure sensor 374 configured to measure a pressure within the piston chamber 358 and a second pressure sensor 376 configured to measure a pressure within the rod chamber 360. By knowing the pressures within the piston chamber 358 and the rod chamber 360, and the corresponding areas that the pressure is acting on (e.g., the piston area and the piston area minus the rod area), the net force acting on the first tilt actuator 352 is known, which is correlated to the torque between the nose landing gear 4 and the cradle 202 (e.g., rotational force applied to the cradle 202 by the nose landing gear 4 about the tilt axis 258, or a rotational force applied to the nose landing gear 4 by the cradle 202).

In some embodiments, the tilt actuator assembly 350 includes a third pressure sensor 378 configured to measure a pressure within the piston chamber 364 and a fourth pressure sensor 380 configured to measure a pressure within the rod chamber 360. In some embodiments, the third pressure sensor 378 and the fourth pressure sensor 380 are included in the tilt actuator assembly 350 as an alternative to the first pressure sensor 374 and the second pressure sensor 376 (i.e., the tilt actuator assembly 350 includes two pressure sensors on one of the first tilt actuator 352 or the second tilt actuator 354). In some embodiments, the third pressure sensor 378 and the fourth pressure sensor 380 are included in the tilt actuator assembly 350 in addition to the first pressure sensor 374 and the second pressure sensor 376 (i.e., the tilt actuator assembly 350 includes two pressure sensors on both of the first tilt actuator 352 and the second tilt actuator 354).

As shown in FIG. 47, the first pressure sensor 374 and the second pressure sensor 376 and/or the third pressure sensor 378 and the fourth pressure sensor 380 are in communication with the controller 402, and the controller 402 is configured to control operation of the tractor 10 (e.g., the driveline 50, the braking system 60, the first tilt actuator 352, the second tilt actuator 354, the tilt actuator(s) 260, etc.) based on the torque measured by the first pressure sensor 374 and the second pressure sensor 376 and/or the third pressure sensor 378 and the fourth pressure sensor 380. In some embodiments, the controller 402 is configured to control the driveline 50 and the braking system 60 to limit a steering angle or turning radius, limit a speed of the tractor, and/or limit a braking force based on the torque measured by the first pressure sensor 374 and the second pressure sensor 376 and/or the third pressure sensor 378 and the fourth pressure sensor 380. In some embodiments, the controller 402 is configured to control the tilt actuator(s) 260, the first tilt actuator 352, and/or the second tilt actuator 354 to reduce the torque on the nose landing gear 4 based on the torque measured by the first pressure sensor 374 and the second pressure sensor 376 and/or the third pressure sensor 378 and the fourth pressure sensor 380. For example, in response to the first pressure sensor 374 and the second pressure sensor 376 and/or the third pressure sensor 378 and the fourth pressure sensor 380 measuring a torque equal to or above a first torque threshold, the controller 402 may limit a speed of the tractor 10 to a first speed threshold, limit a turning radius or steering angle of the front tractive assembly 56 and/or the rear tractive assembly 58 to a first turning threshold, limit a braking force of the braking system 60 to a first brake threshold, and/or engage the tilt actuator(s) 260, the first tilt actuator 352, and/or the second tilt actuator 354 to counteract the torque to reduce the torque (e.g., equal to or below the first torque threshold).

### Aircraft Recognition

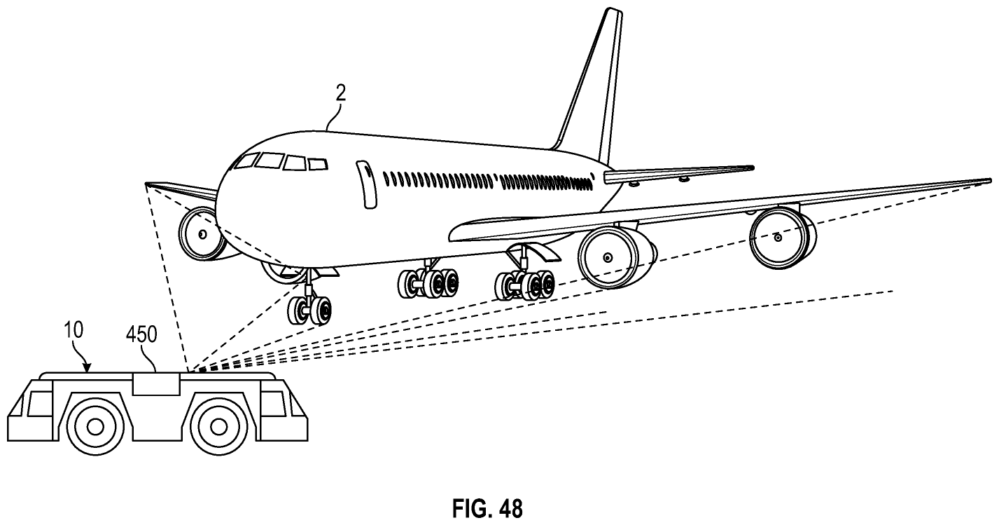

Referring now to FIG. 48, a system for aircraft recognition is shown, according to an exemplary embodiment. The tractor 10 may be used to recognize a specific aircraft, a type of aircraft, etc. The tractor 10 may recognize an aircraft (e.g., the airplane 2) using the vision system 450 on the tractor 10, one or more of the sensors 430 positioned on the tractor 10, and/or using automatic dependent surveillance-broadcast (“ADS-B”) data accessed from the server 410. While the tractor 10 is shown in FIG. 48, it should be understood that the aircraft recognition system may be implemented on any type of ground support equipment (“GSE”) utilized at an airport or a hanger. By way of example, the GSE may include an airplane tractor, a dolly tractor, a baggage tractor, a baggage loader, a cargo loader, a de-icer, a passenger boarding bridge, a fueling truck, a food truck, a stair truck, a dolly, and/or any other GSE utilized at an airport or a hanger.

In some embodiments, the controller 402 and/or the vision system 450 (e.g., the cameras 452 and/or the LIDAR sensors 454) located on the tractor 10 are used to detect one or more components of the airplane 2, one or more locations of the components on the airplane 2, one or more distances between components of the airplane 2, etc. Components of the airplane 2 detected by the controller and/or the vision system 450 may include, for example, an engine (e.g., a turbine, a jet engine, a propeller, etc.), one or more wings, a fuselage, a landing gear, etc. By way of example, the controller 402 and/or the vision system 450 may detect locations of one or more components relative to a ground level. For example, the controller 402 and/or the vision system 450 may detect a location of the turbine engine, a wing, the fuselage, etc. relative to a ground surface on which the airplane 2 is positioned. That is, in some embodiments, the controller 402 and/or the vision system 450 may determine a height of various components of the airplane 2 by detecting a location of a component and a location of the ground. In some embodiments, the vision system 450 is configured to perform local processing of the data captured thereby to detect the type of the component, locations thereof, height thereof, etc. In some embodiments, the vision system 450 is configured to transmit the data acquired thereby to a controller (e.g., the controller 402), which may be configured to use the data to determine the type of the component, locations thereof, height thereof, etc. For example, the vision system 450 may transmit data regarding the engine of the airplane 2 to the controller 402, and the controller 402 may identify the type of engine and/or the height of the engine. In various embodiments, the vision system 450 may be configured to determine or detect a location or position of one or more components of the airplane 2 relative to a location or position of the tractor 10 and/or one or more components of the tractor 10.

As described above, the vision system 450 includes the cameras 452 and/or the LIDAR sensors 454. The LIDAR sensors 454 of the vision system 450 may be configured to capture distance measurements, capture three-dimensional maps, perform or facilitate performing (e.g., by the controller 402) object detection and recognition, and/or capture other LIDAR data. For example, the LIDAR sensors 454 may determine or facilitate determining distances between components of the airplane 2, determine heights of components, determine shapes, dimensions, areas, etc. of components, and/or characteristics of components. The cameras 452 of the vision system 450 may be configured to capture image data including videos and/or still images. For example, the cameras 452 may capture images or videos of various components of the airplane 2. The cameras 452 may transmit camera data to the controller 402 to determine information such as component locations relative to other components, component locations relative to the ground, component identification, an aircraft identifier (e.g., serial number, etc.), and the like. In some embodiments, the tractor 10 is configured to utilize a combination of the cameras 452 and the LIDAR sensors 454. In various embodiments, the tractor 10 utilizes one or more of the sensors 430 to obtain data relating to one or more components of the airplane 2 to determine a type of the airplane 2.

The vision system 450 may be configured to identify or facilitate identifying (e.g., by the controller 402) characteristics of one or more components of the airplane 2. Different types of aircraft may have similar components that may look differently, be positioned differently, etc. For example, the vision system 450 may be positioned to capture or sense the nose landing gear 4 of the airplane 2. The vision system 450 may then be configured to identify or facilitate identifying (e.g., by the controller 402) specific characteristics of the nose landing gear 4. The specific characteristics may differentiate the airplane 2 from another airplane. For example, the nose landing gear 4 detected by the vision system 450 may include four wheels, while nose landing gears of different airplanes may include two wheels, six wheels, etc. Data corresponding to various aircrafts and types of aircraft may be stored in a lookup table or other database stored within the controller 402. Using the data acquired by the vision system 450, the controller 402 may compare the acquired data to data stored in the lookup table or database. A match between the acquired data and the stored data may indicate the type of the airplane 2.

The vision system 450 may be configured to detect or facilitate detecting (e.g., by the controller 402) locations of a plurality of components. For example, the vision system 450 may detect the location of the nose landing gear 4, the fuselage, and the engine. The vision system data may be used to calculate distances between the components via, for example, triangulation, which may be used to detect or determine the type of aircraft. For example, the triangulation calculation may correspond to a stored triangulation calculation associated with a particular aircraft or type of aircraft in a lookup table or database.

The vision system 450 may be configured to detect or facilitate detecting (e.g., by the controller 402) a shape of a component. For example, the vision system 450 may identify or facilitate identifying (e.g., by the controller 402) edges, vertices, etc. of a component. Further, the vision system 450 may determine or facilitate determining (e.g., by the controller 402) a length, width, height, etc. of each edge of the component and/or dimensions, area, volume, etc. of the entire shape of the component. For example, the measurements detected by the vision system 450 may correspond to stored measurements associated with a particular aircraft or type of aircraft in a lookup table or database.

The vision system 450 may be configured to identify or facilitate identifying (e.g., by the controller 402) a specific aircraft based on the vision system data collected. For example, the vision system 450 may be configured to determine or facilitate determining (e.g., by the controller 402) a specific make and model of the aircraft being sensed (e.g., Boeing, Airbus, 747, 777, 737, A320, A330, A380, etc.). For example, a first make and model of aircraft may have first characteristics (e.g., height of fuselage, engine, wing, etc.; wingspan; size of engine, fuselage, nose landing gear, tire, wing, etc.; shape of fuselage, engine, wing, nose landing gear; relative component positioning; etc.) and a second aircraft make and model may have second characteristics. The vision system 450 may be configured to detect or facilitate detecting (e.g., by the controller 402) such characteristics and, therefore, determine or facilitate determining that the aircraft being sensed is the first make and model or the second make and model.

In various examples, multiple makes and/or models of aircraft may have the same, similar, or substantially similar measurements of one or more components. Thus, vision system data relating to multiple components and/or measurements may be collected to determine the specific make and model of the aircraft. For example, two aircrafts may have the same engine height, but different wing heights. The controller 402 and/or the vision system 450 may then detect both an engine height and a wing height, and may determine which of the two types of aircraft the airplane 2 being sensed is.

In various embodiments, the controller 402 and/or the vision system 450 may be configured to determine a specific aircraft by detecting features specific to a single aircraft. For example, the vision system 450 may detect measurements or locations of components specific to only one aircraft. In various embodiments, the vision system data may be used in combination with information relating to a location of the aircraft. For example, the vision system data may be used in combination with the position of the aircraft at a certain gate of an airport to determine a make, model, and/or specific identifier of the aircraft. In some embodiments, the controller 402 and/or the vision system 450 are configured to determine a specific aircraft by identifying an identifier on the aircraft (e.g., a serial number, etc.) and comparing the identifier to a lookup table or other database to identify the aircraft.

In some embodiments, the vision system 450 and/or the controller 402 are configured to determine a type of aircraft using machine vision detection capabilities (e.g., object recognition, machine learning, by comparing real-time images to a database of images, etc.). In some embodiments, the vision system 450 and/or the controller 402 are additionally or alternatively configured to determine a type of aircraft using a lookup table. For example, the controller 402 and/or the vision system 450 may be configured to perform calculations to determine heights, distances, sizes, shapes, and/or other measurements of components captured by the vision system 450. The lookup table may then be accessed (e.g., stored on the controller 402 within the memory 406, stored at the server 410, etc.) by the controller 402 and/or the vision system 450. The lookup table may include information used to determine a type of aircraft based on measurements taken by the vision system 450. For example, the lookup table may correlate the type of aircraft with a size of one or more components of the airplane 2. For example, the lookup table may correlate the type of airplane 2 with a component height, relative component distances, a component size, a component shape, etc. of the aircraft. As such, the vision system 450 may capture such information for use as an input to the lookup table. The output of the lookup table may be the specific type of aircraft being sensed.

While it has been described herein that the controller 402 and/or the vision system 450 perform aircraft recognition based on the data acquired using the vision system 450, in some embodiments, the server 410 is configured to at least partially perform the aircraft recognition processes described herein. For example, the data acquired by the vision system 450 may be transmitted to the server 410 (e.g., by the controller 402), and the server 410 may be configured to perform the aircraft recognition procedures and then transmit the type of aircraft to the tractor 10.

In some embodiments, the tractor 10 is additionally or alternatively configured to acquire ADS-B data from the server 410 regarding the airplane 2 to perform aircraft recognition. For example, the server 410 may be an ADS-B system that monitors the positioning of aircrafts (e.g., based on satellite data or other sensors). The controller 402 of the tractor 10 may be configured to access the ADS-B data from the server 410. In some embodiments, the ADS-B data is continuously obtained by the controller 402. In some embodiments, the ADS-B data is acquired when the airplane 2 is detected and/or identified by the controller 402 and/or the vision system 450. The ADS-B data may be used to determine a type of aircraft or confirm the type of aircraft detected by the controller 402 and/or the vision system 450. For example, a location of the tractor 10 may be obtained or determined by the controller 402. The controller 402 may then acquire and/or use the ADS-B data to identify an aircraft at or near the location of the tractor 10. Thus, the controller 402 can determine the type of aircraft that the airplane 2 is by searching for or otherwise identifying, using the ADS-B data, an aircraft located near the location of the tractor 10. The ADS-B data may include information used to identify the type of aircraft in addition to a location of the aircraft, such as a make and model of the aircraft. In various embodiments, the ADS-B data may include a plurality of aircrafts located near the tractor 10. The controller 402 may select or identify the aircraft nearest the location of the tractor 10.

In some embodiments, the ADS-B data is used in conjunction with the data obtained by the vision system 450 to confirm an identification of a type of aircraft. For example, the controller 402 and/or the vision system 450 may determine information relating to one or more components of the airplane 2 to determine that the airplane 2 is a first type of aircraft. The controller 402 may then acquire and/or utilize ADS-B data to identify an aircraft at or near location of the tractor 10 to confirm the type of aircraft determined using the vision system 450. As such, ADS-B data may be used to confirm the recognition of the type of aircraft by the vision system 450. In other embodiments, the vision system 450 is used to confirm recognition of the aircraft using the ADS-B data. For example, the ADS-B data may be used to identify, using location data, a type of aircraft near a location of the tractor 10. The vision system 450 may identify one or more components of the aircraft to confirm the identification made using the ADS-B data.

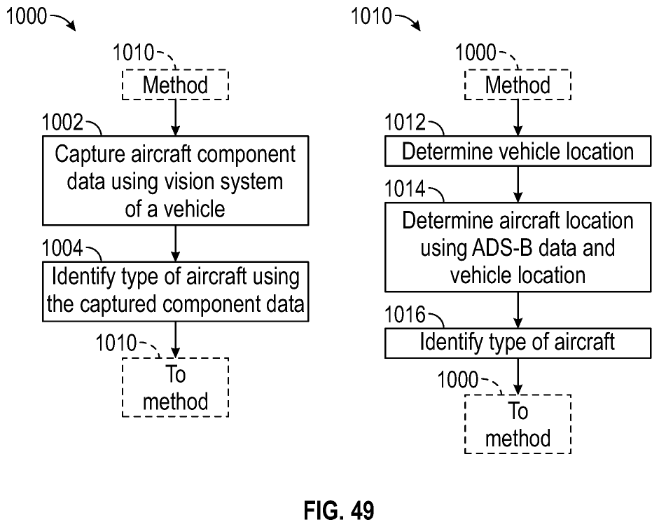

Referring now to FIG. 49, method 1000 and method 1010 for aircraft recognition are shown, according to example embodiments. The method 1000 illustrates a method of using a vision system (e.g., the vision system 450) to detect a type of aircraft. The method 1010 illustrates a method of using a database (e.g., ADS-B) to detect a type of aircraft. One or both of the method 1000 and the method 1010 may be performed by one or more processing circuits located on the tractor 10 and/or located remote from the tractor 10.

At process 1002 of the method 1000, aircraft component data is captured using a vision system of a vehicle (e.g., the tractor 10). For example, the aircraft component data may be captured by a sensor of the tractor 10 that is at least one of a LIDAR sensor or a camera. The aircraft component data may be regarding one or more external characteristics of an aircraft proximate a ground support equipment (e.g., the tractor 10). The aircraft component data may be or include a shape of a component of the aircraft (e.g., the airplane 2), a size of a component of the aircraft, a height of a component of the aircraft, a location of a component of the aircraft relative to a ground surface, a distance between two or more components of the aircraft, or an aircraft identification number positioned along an exterior of the respective aircraft.

In some embodiments, the aircraft component data is first data, and the vehicle includes a camera configured to acquire second data regarding the one or more external characteristics of aircrafts. The controller may be configured to acquire the first data from a sensor of the vehicle and acquire the second data from the camera regarding the one or more external characteristics of the respective aircraft.

At process 1004 of the method 1000, a type of aircraft is identified using the component data captured at process 1002. The type of the aircraft may include at least one of: a make of the aircraft, a model of the aircraft, or an identifier of the aircraft. In some embodiments, the component data is transmitted to a controller of the vehicle (e.g., the controller 402 of the tractor 10). The controller and/or the vision system may be configured to identify the type of aircraft based on the transmitted data. For example, the controller may use a lookup table to determine the type of aircraft by using the component data as inputs to obtain the type of aircraft as an output. As another example, the controller and/or the vision system may use object recognition, machine vision, machine learning, etc. to detect and determine the type of aircraft.

As such, in some embodiments, the controller may be configured to determine the type of the respective aircraft based on the data by at least one of: (a) using at least one of machine vision, machine learning, or object recognition and/or (b) comparing the data to pre-stored data stored in a lookup table or database to identify a match between the data and the data stored in the lookup table.

Referring now to the method 1010, at process 1012, a location of the vehicle is determined. For example, the controller of the vehicle may determine or obtain a current location of the vehicle (e.g., using a GPS sensor, using the sensors 430, etc.).

At process 1014, an aircraft location is determined using ADS-B data and the location of the vehicle. In various embodiments, a database other than the ADS-B database may be used to determine an aircraft location. The controller may use the location of the vehicle to search or query the ADS-B database to determine locations of aircraft at or near the location of the tractor 10.

At process 1016, a type of aircraft is identified. For example, at process 1014, an aircraft located at or near the vehicle may be identified. At process 1016, the specific type of the aircraft may be identified based on the location of the vehicle and the location of the aircraft.

In some embodiments, the controller is configured to determine the type of the aircraft based on the location of the ground support equipment by: acquiring ADS-B data including locations of a plurality of aircraft, searching or querying, using the location of the ground support equipment, the ADS-B data to identify an aircraft of the plurality of aircraft located within a predefined distance of the ground support equipment, and identifying the aircraft of the plurality of aircraft as the aircraft of interest.

In various embodiments, one or both of the method 1000 and the method 1010 may be used for aircraft recognition. Either of the method 1000 or the method 1010 may be performed first or second. The second method used may be performed to verify or confirm the identification of the aircraft performed by the first method. For example, the method 1000 may be performed first to identify a type of aircraft. The method 1010 may be subsequently performed to verify that the type of aircraft identified by the method 1000 is correct. Conversely, the method 1010 may be performed first to identify a type of aircraft, and the method 1000 may be performed subsequently to confirm that the type of aircraft identified by the method 1010 is correct. In various examples, either of the method 1000 or the method 1010 may be performed without performing the other of the method 1000 or the method 1010 to confirm the identification of the type of aircraft.

### Operator Assist

In general, the type of aircraft identified using the method 1000 and/or the method 1010 may be used to assist an operator when operating the tractor 10, for example, to approach an aircraft, to capture the nose landing gear of the aircraft, and/or when driving or towing the aircraft. In some embodiments, the assistance provided to the operator may be the controller 402 and/or the server 410 taking full or partial control of the tractor 10 (e.g., controlling the driveline 50, the braking system 60, controlling the controls of the tractor 10 (e.g., the first operator controls 40, the second operator controls 49, and/or the remote control system 800 (see, e.g., FIG. 36)), and/or controlling the capture system 70. Alternatively or additionally, the controller 402 and/or the server 410 may provide a notification to the operator (e.g., via the operator interface 48 and/or a display of the remote control system 800) indicating that the tractor 10 is going to be assisted in its operation or to provide instructions for the operator to follow. For example, the notification may instruct the operator to reduce the speed of the tractor 10, to turn a specific direction, to follow a given travel path, etc., or that the tractor 10 is going to be fully or partially controlled to reduce the speed, turn a specific direction, and/or follow a given travel path. In some embodiments, the controller 402 and/or the server 410 may additionally or alternatively provide haptic feedback to the operator (e.g., vibrating the steering wheel 42), audible feedback (e.g., an audible alarm, audible instructions), and/or visual feedback (e.g., a warning light, a displayed path on the operator interface 48 and/or a display of the remote control system 800, etc.) to assist the operator.

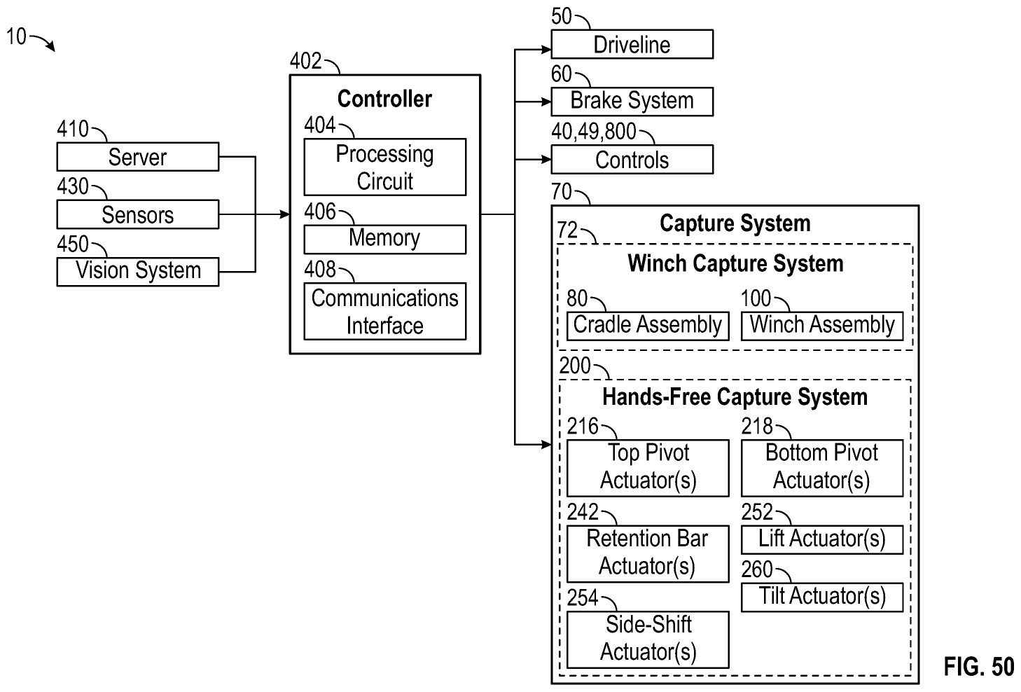

As shown in FIG. 50, and described herein, the controller 402 is configured to acquire the type of aircraft from the server 410 and/or determine the type of aircraft based on data measured by the sensors 430 and/or the vision system 450. In general, the controller 402 may be configured to assist an operator of the tractor 10 based the type of aircraft. It should be appreciated that the assistance and control of the tractor 10 described herein as being performed by the controller 402 may also be performed by the server 410, which provides the control signals to assist an operator to the controller 402. As described herein, the type of aircraft may include identification information relating to the size, shape, location, and components of the aircraft, and the size, shape, location, orientation, height above the ground, and quantity of components on the aircraft (e.g., engine(s), wings, fuselage, nose landing gear, main landing gear, etc.).

In some embodiments, the controller 402 may utilize the identification information provided by the type of aircraft to assist the operator when approaching an aircraft to align the tractor 10 (e.g., the cradle assembly 80 or the cradle 202) with the nose landing gear (e.g., the nose landing gear 4). For example, the controller 402 may generate or modify a steering command (e.g., change a steering angle or travel direction of the tractor 10) provided to the driveline 50 by the first operator controls 40, the second operator controls 49, and/or the remote control system 800. In some embodiments, the controller 402 may generate or modify a steering command to guide the tractor 10 so that the capture system 70 aligns with the nose landing gear of the aircraft (e.g., the nose landing gear 4), based on the known location of the nose landing gear provided in the identification information. In some embodiments, alternatively or additionally, the controller 402 may be configured to generate or modify a steering command to avoid components of the aircraft, other than the nose landing gear, based on the size, shape, location, orientation, and/or height above the ground of the components provided in the identification information. For example, if the tractor 10 is on a path that would bring the tractor 10 too close to the engine of an aircraft, the controller 402 may generate or modify a steering command that steers the tractor 10 away from the engine and back toward a path where the tractor 10 aligns with the nose landing gear.

In some embodiments, the controller 402 may be configured to supply the steering command to the driveline 50 and automatically implement the steering change as the tractor 10 approaches the aircraft regardless of the operator input to the first operator controls 40, the second operator controls 49, and/or the remote control system 800. In some embodiments, the controller 402 may provide an indication to the operator that instructs the operator to follow a generated or modified steering command. For example, the controller 402 may provide a visual or audible indication on the operator interface 48 and/or a display of the remote control system 800 to indicate to the operator that the steering angle requires changing to either avoid a component of the aircraft or to align the tractor 10 with the nose landing gear.

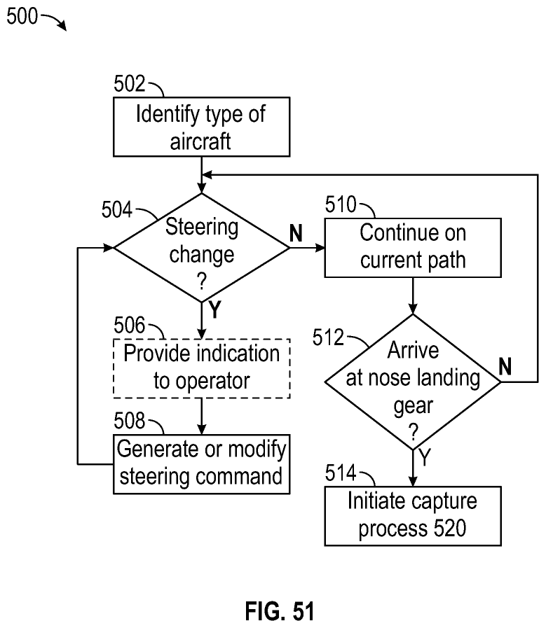

FIG. 51 shows an exemplary embodiment of a process or method 500 for operating the tractor 10 as the tractor 10 approaches an aircraft (e.g., the airplane 2). As described herein, the controller 402 may provide steering assistance, based on the type of aircraft, to an operator as the operator approaches the aircraft. In some embodiments, the method 500 may initiate at step 502 where the type of aircraft is identified, for example, as described herein using the method 1000 (e.g., based on data from the sensors 430 and/or the vision system 450) and/or the method 1010 (e.g., based on ADS-B data and the server 410). Once the type of aircraft is identified at step 502, the operator may approach the aircraft by driving the tractor 10 in a direction toward the aircraft. In some embodiments, the type of aircraft is identified prior to the operator initiating movement toward the aircraft. In some embodiments, the type of aircraft is identified while the operator is driving toward the aircraft.

As the operator travels toward the aircraft, the controller 402 utilizes the identification information to determine if a steering change is required at step 504. In some embodiments, the controller 402 determines, at step 504, that a steering change is needed if the tractor 10 is traveling along a path where the capture system 70 is misaligned with the nose landing gear. In some embodiments, the controller 402 determines, at step 504, that a steering change is needed if the tractor 10 is traveling along a path that intersects with a component of the aircraft, other than the nose landing gear, based on the size, shape, location, orientation, and/or height above the ground of the components provided in the identification information. Regardless of the reason for determining that a steering change is needed, if the controller 402 determines that a steering change is required to assist the operator, the controller 402 may provide an indication to the operator at step 506, via the operator interface 48 and/or a display of the remote control system 800, to indicate to the operator that a change in the steering angle is required (e.g., either to avoid a component of the aircraft or to align the tractor 10 with the nose landing gear). In some embodiments, the indication provided at step 506 includes a directional indication (e.g., turn right/left). In some embodiments, the indication provided at step 506 includes a directional indication and a magnitude indication (e.g., turn right/left a particular amount of degrees). In some embodiments, alternatively or additionally, the indication provided at step 506 may include a visual indication (e.g., an arrow pointing to the required steering change).

Once the controller 402 determines, at step 504, that a steering change is needed, the controller 402 generates or modifies a steering command provided to the driveline 50 at step 508. The generation or modification of the steering command assists the operator as the tractor 10 approaches the aircraft to aid the operator in avoiding components of the aircraft, other than the nose landing gear, and align the tractor 10 with the nose landing gear. In some embodiments, the steering command is generated or modified a predetermined amount of time after the indication is provided to the operator at step 506. For example, if the path of the tractor 10 is not changed within the predetermined amount of time, the controller 402 generates or modifies the steering command and sends the steering command to the driveline 50 to automatically change the travel path of the tractor 10. In some embodiments, the controller 402 generates or modifies the steering command and sends the steering command to the driveline 50 to automatically change the travel path of the tractor 10 substantially simultaneously after determining that the steering change is needed at step 504. Once the steering change is implemented at step 508, the controller 402 continues to determine if a steering change is needed at step 502 as the tractor 10 approaches the aircraft.

If the controller 402 determines that a steering change is not needed at step 502, the tractor 10 is allowed to continue on its current travel path, as controlled by the operator, at step 510. As the tractor 10 is continuing along its travel path, the controller 402 determines, at step 512, if the tractor 10 has arrived at the nose landing gear (e.g., the nose landing gear 4), for example, based on a location of the nose landing gear provided in the identification information of the aircraft or otherwise detected using the vision system 450. In some embodiments, the controller 402 determines if the tractor 10 has arrived at the nose landing gear based on the capture system 70 being within a predefined distance of the nose landing gear (e.g., a distance where the capture system 70 can effectively capture the nose landing gear). If the tractor 10 has not arrived at the nose landing gear, the tractor 10 continues on its current path and the controller 402 continues to determine if a steering change is needed at step 502. If the tractor 10 has arrived at the nose landing gear, the operator may initiate a capture process at step 514 (e.g., the method 520), where the operator is further assisted by the controller 402 based on the identification information, as described herein.

In some embodiments, the controller 402 may utilize the identification information provided by the type of aircraft to assist the operator when capturing the nose landing gear (e.g., the nose landing gear 4) with the capture system 70. As shown in FIG. 50, the controller 402 is in communication with the capture system 70 and the controller 402 may be configured to generate or modify commands sent to the capture system 70 to assist an operator during the capture process. For example, the diameter of the wheels (e.g., the wheels 6) on the nose landing gear (e.g., the nose landing gear 4) may be provided in the identification information and the capture system 70 may be controlled based on the diameter of the wheels. In some embodiments, the controller 402 generates or modifies a winch command provided to the winch assembly 100 based on the type of aircraft. For example, the controller 402 may generate or modify a winch speed command provided to the winch assembly 100 (e.g., to the motor 102) based on the diameter of the wheels provided in the identification information. Alternatively or additionally, the controller 402 may generate or modify a winch stop command provided to the winch assembly 100 (e.g., to the motor 102) based on the diameter of the wheels provided in the identification information. In this way, for example, the controller 402 may assist the operator with how fast to winch the nose landing gear onto the cradle assembly 80 and with when to stop the winch assembly 100 (e.g., larger diameter wheels need to stop winching before smaller diameter wheels).

In some embodiments, the controller 402 generates or modifies a side-shift command that is provided to the side-shift actuator 254 based on the location of the nose landing gear provided in the identification information and/or based on a size of the nose landing gear provided in the identification information or otherwise detected using the vision system 450. In this way, for example, the controller 402 may assist the operator with aligning the capture system 70 (e.g., the cradle assembly 80 of the winch-capture system 72 or the cradle 202 of the hands-free capture system 200) with the nose landing gear prior to capturing the nose landing gear. In some embodiments, alternatively or additionally, the controller 402 generates or modifies gate capture commands that are provided to the top pivot actuators 216, the bottom pivot actuators 218, and/or the retention bar actuators 242 based on the diameter of the wheels of the nose landing gear provided in the identification information or otherwise detected using the vision system 450. In this way, for example, the operator may be assisted when operating the front gate assemblies 210 and the rear retention bar 240 when capturing and engaging the wheels of the nose landing gear. That is, the front gate assemblies 210 and the rear retention bar 240 may be operated according to the diameter of the wheels.

In some embodiments, the controller 402 is configured to supply the capture commands described herein (e.g., the winch speed command, the winch stop command, the side-shift command, and/or the gate capture commands) to automatically implement changes to the capture process as the capture system 70 captures the nose landing gear, regardless of the operator input to the first operator controls 40, the second operator controls 49, and/or the remote control system 800. In some embodiments, the controller 402 provides an indication to the operator that instructs the operator to follow the generated or modified capture commands. For example, the controller 402 may provide a visual or audible indication on the operator interface 48 and/or a display of the remote control system 800 to indicate to the operator that one or more of the capture commands require changing to either avoid a component of the aircraft or to align the tractor 10 with the nose landing gear. In some embodiments, alternatively or additionally, the controller 402 is configured to provide an indication to the operator, via the operator interface 48 and/or a display of the remote control system 800, to notify the operator of the desired value for the capture commands described herein (e.g., the winch speed command, the winch stop command, the side-shift command, and/or the gate capture commands) based on the wheel diameter in the identification information or otherwise detected using the vision system 450.

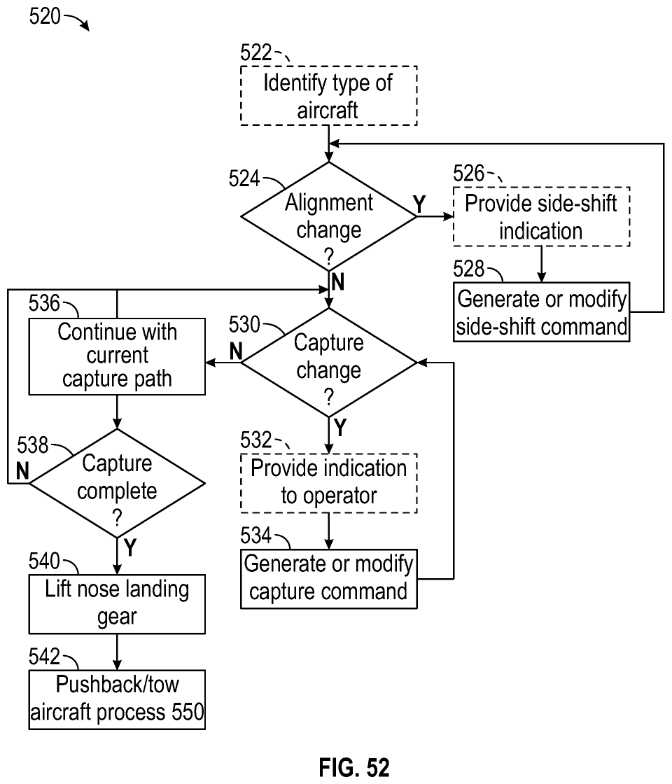

FIG. 52 shows an exemplary embodiment of a process or method 520 for operating the tractor 10 as the tractor 10 captures a nose landing gear (e.g., the nose landing gear 4) of an aircraft (e.g., the airplane 2). As described herein, the controller 402 may provide capture assistance, based on the type of aircraft, to an operator as the operator captures the nose landing gear. In some embodiments, the method 520 may initiate at step 522 where the type of aircraft is identified, for example, as described herein using the method 1000 (e.g., based on data from the sensors 430 and/or the vision system 450) and/or the method 1010 (e.g., based on ADS-B data and the server 410). In some embodiments, the type of aircraft may already be identified by the time the tractor 10 is ready to capture the nose landing gear and, in these embodiments, the type of aircraft may not need to be identified at step 522 and the method 520 may begin at step 524. Once the type of aircraft is identified at step 522, the controller 402 determines at step 524 if an alignment change is required to align the capture system 70 with the nose landing gear, for example, based on the location of the nose landing gear and the diameter of the wheels provided in the identification information or otherwise detected using the vision system 450.

In some embodiments, if the controller 402 determines at step 524 that an alignment change is needed, the controller 402 may provide an indication to the operator at step 526, via the operator interface 48 and/or a display of the remote control system 800, to indicate to the operator that a change in the alignment of the capture system 70 is required. In some embodiments, the indication provided at step 526 includes a directional indication (e.g., move right/left). In some embodiments, the indication provided at step 526 includes a directional indication and a magnitude indication (e.g., move right/left a particular distance). In some embodiments, alternatively or additionally, the indication provided at step 526 may include a visual indication (e.g., an arrow pointing to the required alignment change).

Once the controller 402 determines, at step 524, that an alignment change is needed, the controller 402 generates or modifies a side-shift command provided to the side-shift actuator at step 528. The generation or modification of the side-shift command assists the operator with aligning the capture system 70 with the nose landing gear. In some embodiments, the side-shift command is generated or modified a predetermined amount of time after the indication is provided to the operator at step 526. For example, if the alignment of the capture system 70 is not changed within the predetermined amount of time, the controller 402 generates or modifies the side-shift command and sends the side-shift command to the side-shift actuator 254 to automatically change the lateral position of the capture system 70 relative to the nose landing gear and to align the capture system 70 with the nose landing gear. In some embodiments, the controller 402 generates or modifies the side-shift command and sends the side-shift command to the side-shift actuator 254 to automatically change the lateral position of the capture system 70 substantially simultaneously after determining that the alignment change is needed at step 524. Once the alignment change is implemented at step 528, the controller 402 continues to determine if an alignment change is needed at step 524 prior to the capture system 70 capturing the nose landing gear.

If the controller 402 determines that an alignment change is not needed at step 524, the controller 402 then determines at step 530 if a change in one or more of the capture commands (e.g., the winch speed command, the winch stop command, and/or the gate capture commands) is required. In some embodiments, if the controller 402 determines at step 530 that a change in one or more of the capture command change is needed, the controller 402 provides an indication to the operator at step 532, via the operator interface 48 and/or a display of the remote control system 800, to indicate to the operator that a change one or more of the capture commands is required. In some embodiments, the indication provided at step 532 includes a directional indication (e.g., move a capture component in a particular direction). In some embodiments, the indication provided at step 532 includes a directional indication and a magnitude indication (e.g., move a capture component in a particular direction a particular distance). In some embodiments, alternatively or additionally, the indication provided at step 526 may include a visual indication (e.g., an arrow pointing to the required capture change).

Once the controller 402 determines, at step 530, that a capture command change is needed, the controller 402 generates or modifies one or more of the capture commands provided to the capture components (e.g., the motor 102, the top pivot actuator 216, the bottom pivot actuator 218, the retention bar actuator 242, etc.) at step 534. The generation or modification of the capture command(s) assists the operator as the capture system 70 captures the nose landing gear. In some embodiments, the capture command(s) is/are generated or modified a predetermined amount of time after the indication is provided to the operator at step 532. For example, if the path and/or operation of the capture components are not changed within the predetermined amount of time, the controller 402 generates or modifies the capture command(s) and sends the capture command(s) to the capture system 70 to automatically control operation of the capture components. In some embodiments, the controller 402 generates or modifies the capture command(s) and sends the capture components of the capture system 70 to automatically change control operation thereof substantially simultaneously after determining that the capture command change is needed at step 530. Once the capture command change is implemented at step 534, the controller 402 continues to determine if a capture command change is needed at step 530 as the capture system 70 captures the nose landing gear.

If the controller 402 determines that a capture command change is not needed at step 530, the capture system 70 is allowed to continue on its current capture path, as controlled by the operator, at step 536. As the capture system 70 is continuing along its capture path, the controller 402 determines, at step 538, if the capture system 70 has captured the nose landing gear, for example, based on a location of the capture components and the diameter of the wheels provided in the identification information of the aircraft or otherwise detected using the vision system 450. If the capture system 70 has not captured the nose landing gear, the capture system 70 continues on its current capture path and the controller 402 continues to determine if a capture command change is needed at step 530. If the capture system 70 has captured the nose landing gear, the operator may lift the nose landing gear at step 540, via the lift actuator 252. The controller 402 may then initiate a pushback or tow process (e.g., the method 550) at step 542, where the operator is further assisted by the controller 402 based on the identification information, when operating the tractor 10 to pushback or tow the aircraft to a desired location.

In some embodiments, the controller 402 may utilize the identification information provided by the type of aircraft to assist the operator when moving the aircraft (e.g., the airplane 2), for example, during a pushback or tow procedure. As shown in FIG. 50, the controller 402 is in communication with the driveline 50, the braking system 60, the sensors 430, and the vision system 450 and the controller 402 may be configured to update sensor parameters (e.g., object avoidance parameters) and/or generate or modify drive commands sent to the driveline 50 and/or the braking system 60 to assist an operator while moving the aircraft based on the type of aircraft. In some embodiments, one or more of the sensors 430 and/or the vision system 450 are utilized to provide object detection for the tractor 10 by identifying objects within a predetermined boundary of the tractor 10. In some embodiments, the vision system 450 includes a camera and/or a LIDAR sensor that is positioned to monitor a field of view in front of the tractor 10 (e.g., in a travel direction of the vehicle), and the vision system 450 may include a sensor parameter that defines a lookahead distance for the field of view. The lookahead distance is a distance that the vision system 450 monitors in the travel direction of the tractor 10 to identify objects along the travel direction. In some embodiments, the controller 402 is configured to generate or modify a lookahead distance based on the identification information. For example, the tractor 10 may take a longer time to stop or slow down a larger aircraft, when compared to a smaller aircraft, so the identification information may include a specific lookahead distance for each type of aircraft.

In some embodiments, the controller 402 may be configured to generate or modify a speed command provided to the front tractive assembly 56 and/or the rear tractive assembly 58 by the prime mover 52 based on the identification information. For example, a larger aircraft may be limited to lower travel speeds than a smaller aircraft, and the identification information may include a travel speed threshold for the tractor 10 that is based on the type of aircraft (e.g., a size and/or weight of the aircraft). In some embodiments, the controller 402 may be configured to generate or modify a brake command provided to the braking system 60 based on the identification information. For example, the tractor 10 may take a longer time to stop or slow down a larger aircraft, when compared to a smaller aircraft, so the identification information may include a brake force threshold that is based on the type of aircraft (e.g., a size and/or weight of the aircraft). In some embodiments, the controller 402 may be configured to generate or modify a steering command provided to the driveline 50 based on the identification information. For example, the identification information may include a steering angle threshold that is based on the type of aircraft. Alternatively or additionally, the size and shape of the aircraft and the size, shape, location, orientation, height above the ground, and quantity of components on the aircraft (e.g., engine(s), wings, fuselage, nose landing gear, main landing gear, etc.) provided in the identification information may be utilized by the controller 402 to generate or modify the steering command to avoid obstacles from contacting the components on the aircraft. For example, an aircraft with a larger wingspan requires different steering performance than an aircraft with a smaller wingspan, and the identification information may generate or modify the steering command based on the type of aircraft.

In some embodiments, the controller 402 is be configured to update the sensor parameters (e.g., the lookahead distance) and/or provide the drive command(s) (e.g., the speed command, the brake command, and/or the steering command) to the driveline 50 and/or the braking system 60 to automatically implement the sensor parameter and/or the drive command changes as the tractor 10 moves the aircraft, regardless of the operator input to the first operator controls 40, the second operator controls 49, and/or the remote control system 800. In some embodiments, the controller 402 provides an indication to the operator that instructs the operator to follow to generated or modified drive command, or that notifies that operator that the sensor parameters have been updated. For example, the controller 402 may provide a visual or audible indication on the operator interface 48 and/or a display of the remote control system 800 to indicate to the operator that the drive command(s) require changing based on the identification information.

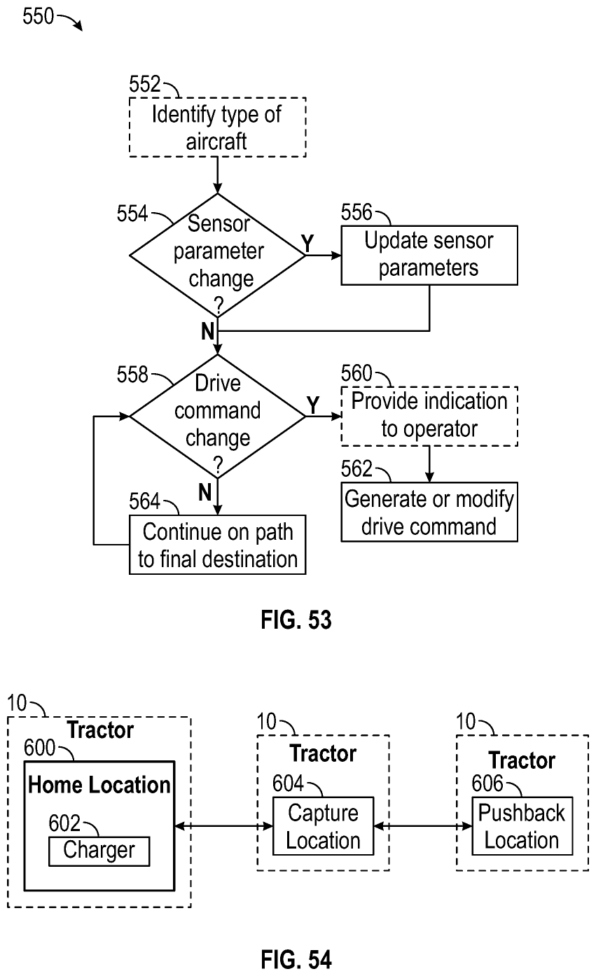

FIG. 53 shows an exemplary embodiment of a process or method 550 for operating the tractor 10 as the tractor 10 moves an aircraft (e.g., the airplane 2). As described herein, the controller 402 may provide driving assistance, based on the type of aircraft, to an operator as the operator moves the aircraft with the tractor 10. In some embodiments, the method 550 may initiate at step 552 where the type of aircraft is identified, for example, as described herein using the method 1000 (e.g., based on data from the sensors 430 and/or the vision system 450) and/or the method 1010 (e.g., based on ADS-B data and the server 410). In some embodiments, the type of aircraft may already be identified by the time the tractor 10 is ready to move the aircraft (e.g., after the method 520) and, in these embodiments, the type of aircraft may not need to be identified at step 552 and the method 520 may begin at step 524.

Once the type of aircraft is identified at step 522, the controller 402 determines at step 554 if a sensor parameter needs to be updated based on the identification information. For example, the controller 402 may determine that the type of aircraft being moved by the tractor 10 is different than a previous type of aircraft being moved by the tractor 10 and initiate an update to the sensor parameters. Alternatively or additionally, the controller 402 may automatically update the sensor parameters, according to the identification information, each time the type of aircraft is identified. If the controller 402 determines that the sensors parameters require an update at step 554, the sensor parameters are updated at step 556. For example, the lookahead distance for the vision system 450 may be updated according to the identification information.

Once the sensor parameters are updated at step 556, or if the controller 402 determines at step 554 that the sensor parameters do not need to be updated, the controller 402 then determines at step 558 is a drive command change is required. For example, the controller 402 utilizes the identification information to determine if a change in the drive command(s) (e.g., the speed command, the brake command, and/or the steering command) is required at step 558. If the controller 402 determines that a drive command change is required to assist the operator, the controller 402 may provide an indication to the operator at step 560, via the operator interface 48 and/or a display of the remote control system 800, to indicate to the operator that a change in the drive command(s) is required. In some embodiments, the indication provided at step 560 includes a directional indication (e.g., turn right/left, slow down, remove brake force, etc.). In some embodiments, the indication provided at step 506 includes a directional indication and a magnitude indication (e.g., turn right/left a particular amount of degrees, slow down a specific speed, decrease braking by a specific amount). In some embodiments, alternatively or additionally, the indication provided at step 506 includes a visual indication (e.g., an arrow pointing to the required steering change, a message instructing a steering, speed, and/or braking change, etc.).

Once the controller 402 determines, at step 558, that a drive command change is needed, the controller 402 generates or modifies one or more drive commands that are provided to the driveline 50 and/or the braking system 60 at step 562. The generation or modification of the drive command(s) assists the operator as the tractor 10 moves the aircraft. In some embodiments, the driving command(s) is/are generated or modified a predetermined amount of time after the indication is provided to the operator at step 560. For example, if the driving characteristics of the tractor 10 are not changed within the predetermined amount of time, the controller 402 generates or modifies the drive command(s) and sends the drive commands to the driveline 50 and/or the braking system 60 to automatically change the driving characteristics of the tractor 10. In some embodiments, the controller 402 generates or modifies the drive command(s) and sends the drive command(s) to the driveline 50 to automatically change the driving characteristics of the tractor 10 substantially simultaneously after determining that the drive command change is needed at step 558. Once the drive command is implemented at step 562, the controller 402 continues to determine if a drive command change is needed at step 558 as the tractor 10 approaches the aircraft.

If the controller 402 determines that a drive command change is not needed at step 558, the tractor 10 is allowed to continue on its current travel path toward a final destination, as controlled by the operator, at step 564. As the tractor 10 is continuing along its travel path, the controller 402 continuously determines if a drive command change is needed at step 558, until the tractor 10 reaches the final destination. Accordingly, the operator is continually assisted while approaching, capturing, and driving an aircraft. It should be appreciated that the method 500, the method 520, and the method 550 may be combined to control operation of the tractor 10 and continually assist an operator while approaching, capturing, and driving an aircraft.

Accordingly, the tractor 10 can be used to efficiently approach, capture, pushback, and tow the aircraft based on detecting or determining the type of a respective aircraft that is being engaged. Once engaged, the tractor 10 can then be modified or controlled based on the specific towing/pushback requirements for the respective aircraft (e.g., speed limits, braking requirements, turning requirements, nose landing gear angle requirements, etc.) such that the respective aircraft can be properly maneuvered. Further, by understanding the type of aircraft being maneuvered, object detection and avoidance can be enhanced by adjusting lookahead distances accordingly and understanding where all portions and components of the aircraft are relative to the tractor 10 at all times, facilitating enhanced collision avoidance.

### Autonomous Pushback

According to an exemplary embodiment, the tractor 10 is operable autonomously (i.e., hands-free operation without an operator on or remotely controlling operation of the tractor 10). As shown in FIG. 50, the controller 402 is in communication with the server 410, the sensors 430, the vision system 450, the driveline 50, the braking system 60, and the capture system 70. In general, the data being received, processed, and output by the controller 402 is configured to enable the autonomous operation of the tractor 10. For example, the data received from the sensors 430 and/or the vision system 450 may be used for object detection and object avoidance during autonomous operation. And the data relating to the type of aircraft described herein for assisting an operation may equally be applied to autonomous operation where, rather than generating or modifying commands to assist an operator, the commands are automatically generated and supplied to the respective components of the tractor 10 to perform autonomous operation (e.g., the method 500, the method 520, and the method 550 may describe autonomous operation of the tractor 10, rather than operator assistive operation). For example, the communication between the controller 402 and each of the driveline 50, the braking system 60, and the capture system 70 enables the controller 402 to control a speed, steering, and braking for the front tractive assembly 56 and/or the rear tractive assembly 58, and the capture, lift, and release operations performed by the capture system 70.

In some embodiments, the controller 402 is configured to control the tractor 10 and perform an autonomous pushback operation illustrated in FIG. 54. In some embodiments, a parking spot or home location 600 is defined for the tractor 10 where the tractor 10 is located when it is not traveling to perform a pushback operation. By way of example, the home location 600 may be proximate to an airport gate, proximate to a hanger, or within a hanger. The home location 600 may include a charger 602 for the tractor 10. For example, the prime mover 52 may include the energy storage 54 and the charger 602 may be in the form of an induction charger that is configured to charge the energy storage 54 when the tractor 10 is parked or otherwise arranged at the home location 600. In this way, for example, when the tractor 10 is positioned or parked at the home location 600, the energy storage 54 may be charged or maintained at a predetermined charged state (e.g., maintained at maximum state of charge).

In general, when an aircraft is parked in a boarding or cargo loading location where the aircraft is boarded by passengers (e.g., when connected to a boarding bridge) or loaded with cargo, the aircraft is arranged in a capture location that may vary slightly depending on where the aircraft is parked by the pilot, the type of aircraft, etc. In some embodiments, the tractor 10 may be configured to autonomously navigate to a capture location 604 where the tractor 10 approaches and captures the nose landing gear (e.g., the nose landing gear 4) of an aircraft (e.g., the airplane 2). In some embodiments, when the tractor 10 performs an initial trip to the capture location 604, the controller 402 may utilize the sensors 430 (e.g., the GPS sensor), the vision system 450, and/or the type of aircraft identified (e.g., including a location of the nose landing gear and/or a diameter of the wheels of the nose landing gear) to autonomously control the driveline 50, the braking system 60, and/or the capture system 70 to autonomously navigate to the capture location 604. In some embodiments, after the initial navigation to the capture location 604, the controller 402 learns and stores (e.g., within the memory 406) a path between the home location 600 and the capture location 604, and the controller 402 performs the same or similar driving characteristics to travel between the home location 600 and the capture location 604 in subsequent trips therebetween.

In some embodiments, once the controller 402 learns the path between the home location 600 and the capture location 604, the controller 402 continues to adjust the autonomous control of the tractor 10 based on, for example, the type of aircraft that is identified at the capture location and/or data from the sensors 430 and/or the vision system 450. For example, the controller 402 may automatically adjust control of the driveline 50, the braking system 60, and/or the capture system 70 based on the type of aircraft and/or the location of the nose landing gear detected by the sensors 430 and/or the vision system 450. In some embodiments, the controller 402 utilizes the identification information provided by the type of aircraft and/or data from the sensors 430 and/or the vision system 450 to generate or modify a steering command (e.g., change a steering angle or travel direction of the tractor 10) provided to the driveline 50 as the tractor 10 autonomously navigates from the home location 600 to the capture location 604. In some embodiments, the controller 402 generates or modifies a steering command to guide the tractor 10 so that the capture system 70 aligns with the nose landing gear of the aircraft (e.g., the nose landing gear 4), based on the known location of the nose landing gear provided in the identification information and/or data provided by the sensor 430 and/or the vision system 450. In some embodiments, alternatively or additionally, the controller 402 is configured to generate or modify a steering command to avoid components of the aircraft, other than the nose landing gear, based on the size, shape, location, orientation, and/or height above the ground of the components provided in the identification information. For example, if the tractor 10 is on a path that would bring the tractor 10 too close to the engine of an aircraft, the controller 402 may generate or modify a steering command that autonomously steers the tractor 10 away from the engine and back toward a path where the tractor 10 aligns with the nose landing gear.

Once the tractor 10 reaches the capture location 604, the controller 402 is configured to autonomously control operation of the capture system 70 to capture the nose landing gear (e.g., the nose landing gear 4). In some embodiments, the controller 402 generates or modifies a side-shift command that is provided to the side-shift actuator 254 based on the location of the nose landing gear provided in the identification information, based on a size of the nose landing gear provided in the identification information, and/or based on data provided by the sensors 430 and/or the vision system 450. In some embodiments, alternatively or additionally, the controller generates or modifies gate capture commands that are provided to the top pivot actuators 216, the bottom pivot actuators 218, and/or the retention bar actuators 242 based on the diameter of the wheels of the nose landing gear provided in the identification information and/or based on data provided by the sensors 430 and/or the vision system 450. In this way, for example, the controller 402 may autonomously operate the front gate assemblies 210 and the rear retention bar 240 to capture and engage the wheels of the nose landing gear.

After the nose landing gear is autonomously captured by the capture system 70, the nose landing gear may be autonomously lifted by the controller 402 instructing the lift actuator 252 to lift the nose landing gear, which enables the tractor 10 to pushback the aircraft. With the nose landing gear lifted, the controller 402 may be configured to instruct the driveline 50 and/or the braking system 60 to autonomously navigate the tractor 10 to a pushback location 606 where the aircraft is pushed back from the capture location 604 and released by the capture system 70 (e.g., lowered and disengaged by the capture system 70). In some embodiments, when the tractor 10 performs an initial trip from the capture location 604 to the pushback location 606, the controller 402 utilizes the sensors 430 (e.g., the GPS sensor), the vision system 450, and/or the type of aircraft identified (e.g., including a location of the nose landing gear and/or a diameter of the wheels of the nose landing gear) to autonomously control the driveline 50, the braking system 60, and/or the capture system 70 to autonomously navigate to the pushback location 606. In some embodiments, after the initial navigation to from the capture location 604 to the pushback location 606, the controller 402 learns and stores (e.g., within the memory 406) a path between the capture location 604 and the pushback location 606, and the controller 402 performs the same or similar driving characteristics to travel between the capture location 604 and the pushback location 606 in subsequent trips therebetween.

In some embodiments, once the controller 402 learns the path between the capture location 604 and the pushback location 606, the controller 402 continues to adjust the autonomous control of the tractor 10 based on, for example, the type of aircraft that is identified at the capture location 604 and/or data from the sensors 430 and/or the vision system 450. For example, the controller 402 may automatically adjust control of the driveline 50 and/or the braking system 60 based on the type of aircraft and/or the location of the nose landing gear detected by the sensors 430 and/or the vision system 450. In some embodiments, the controller 402 is configured to generate or modify a speed command provided to the front tractive assembly 56 and/or the rear tractive assembly 58 by the prime mover 52 as the tractor 10 autonomously moves the aircraft between the capture location 604 and the pushback location 606 based on the type of aircraft. For example, a larger aircraft may be limited to lower travel speeds than a smaller aircraft, and the controller 402 may autonomously limit a travel speed threshold for the tractor 10 that is based on the type of aircraft (e.g., a size and/or weight of the aircraft). In some embodiments, the controller 402 is configured to generate or modify a brake command provided to the braking system 60 as the tractor 10 autonomously moves the aircraft between the capture location 604 and the pushback location 606. For example, the tractor 10 may take a longer time to stop or slow down a larger aircraft, when compared to a smaller aircraft, so the controller 402 may autonomously control a brake force threshold that is based on the type of aircraft (e.g., a size and/or weight of the aircraft). In some embodiments, the controller 402 is configured to generate or modify a steering command provided to the driveline 50 as the tractor 10 autonomously moves the aircraft between the capture location 604 and the pushback location 606. For example, the controller 402 may autonomously apply a steering angle threshold that is based on the type of aircraft (e.g., a size and/or weight of the aircraft) as the tractor 10 autonomously moves the aircraft between the capture location 604 and the pushback location 606. Alternatively or additionally, the size and shape of the aircraft and the size, shape, location, orientation, height above the ground, and quantity of components on the aircraft (e.g., engine(s), wings, fuselage, nose landing gear, main landing gear, etc.) provided in the identification information may be utilized by the controller 402 to generate or modify the steering command to avoid obstacles from contacting the components on the aircraft. For example, an aircraft with a larger wingspan requires different steering performance than an aircraft with a smaller wingspan, and the identification information may generate or modify the steering command based on the type of aircraft. As another example, aircrafts may have different nose landing gear angle requirements such that the tractor 10 may be limited to certain turning radii to prevent over-rotating the nose landing gear beyond a threshold angle of rotation.

Once the tractor 10 reaches the pushback location 606, the tractor 10 may release the nose landing gear from the capture system 70, for example, by performing the capture commands that captured the nose landing gear in reverse order, which allows the aircraft to depart from the pushback location 606. In some embodiments, the tractor 10 includes a light system 62 arranged on both lateral sides of the body 20 (see, e.g., FIGS. 7-9) that is configured to blink, flash, light up a certain color, etc. during autonomous operation to indicate un-assisted operation of the tractor 10.

### Autonomous Return

In some embodiments, after the tractor 10 autonomously navigates from the home location 600 to the pushback location 606 and releases the aircraft at the pushback location 606, the controller 402 is configured to autonomously navigate the tractor 10 along a return path from the pushback location 606 to the home location 600. In some embodiments, the controller 402 is configured to cause the tractor 10 to follow the same path (e.g., within a predefined tolerance) the was taken between the home location 600 and the pushback location 606, in reverse order, to autonomously navigate from the pushback location 606 to the home location 600. For example, the controller 402 may apply the same or similar autonomous commands, in reverse order, to the driveline 50 that were commanded during the path from the home location 600 to the pushback location 606 (excluding the capture process performed at the capture location 604).

In some embodiments, the controller 402 is configured to monitor data from the sensors 430 and/or the vision system 450 to determine if an object or vehicle is present on or intersects the return path. If the controller 402 detects an object or vehicle along the return path, the controller 402 may autonomously instruct the braking system 60 and/or the driveline 50 to stop movement of the tractor 10. The controller 402 may maintain the tractor 10 in a stopped state until the object or vehicle moves or is manually moved from the return path. Once the object is removed from the return path, the controller 402 may instruct the driveline 50 to resume travel along the return path to the home location 600.

Once the tractor 10 reaches the home location 600, the energy storage 54 may be charged by the charger 602 and the tractor 10 may wait at the home location 600 until another pushback procedure is initiated. Accordingly, the tractor 10 should always be at the ready for pushback operations (i.e., sufficiently charged) and not require manual recharging.

### Remote Control of Tractor

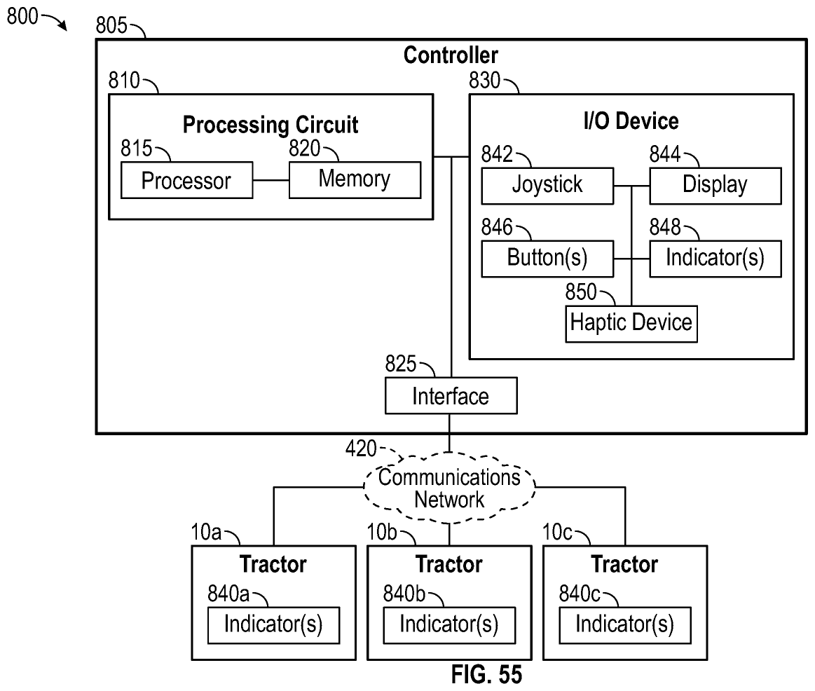

As shown in FIG. 55, a remote tractor control system, shown as remote control system 800, includes a remote control device, shown as controller 805, configured to facilitate remotely controlling one or more operations of the tractor 10. For example, the controller 805 may transmit one or more signals to controller 402 to facilitate control of the prime mover 52, the braking system 60, and/or a steering system to facilitate remotely driving or operating the tractor 10. As another example, the controller 805 may transmit one or more signals to the controller 402 to cause one or more light elements (e.g., LEDs, the light system 62, etc.) of the tractor 10 to illuminate and/or produce light. In some embodiments, the remote control system 800 may facilitate control of a plurality of the tractors 10 and/or various vehicles and/or machines described herein. For example, as shown in FIG. 55, the controller 805 is configured to communicate, via the communications network 420, with a plurality of the tractors 10 including a first tractor 10a, a second tractor 10b, and a third tractor 10c. In some embodiments, the controller 805 is configured to directly couple (e.g., wirelessly and/or wired) to the tractors 10 such that that the controller 805 can communicate with the tractors 10 without the communications network 420.

In some embodiments, the tractors 10a, 10b, and 10c may refer to similar types of vehicles. For example, the tractors 10a, 10b, and 10c may be towbarless tractors like in FIG. 2 and/or FIGS. 7-9. In some embodiments, the tractors 10a, 10b, and 10c may refer to different types of vehicles. For example, the tractor 10a may include access equipment vehicles (e.g., boom lifts, aerial lifts, scissor lifts, articulating lifts, etc.). As another example, the tractor 10b may include fuel trucks, supply vehicles, and/or refueling equipment. As another example, the tractor 10c may include ground support equipment (“GSE”) such as an airplane tractor, a dolly tractor, a baggage tractor, a baggage loader, a cargo loader, a de-icer, a passenger boarding bridge, an airplane fueling truck, an airplane food truck, a dolly, a stair truck, and/or any other GSE utilized at an airport or a hanger.

As shown in FIG. 55, the tractor 10 includes at least one output device (e.g., lighting element, display, spotlight, lightbar, light beacon, etc.), shown as indicator 840. For example, the tractor 10 may include a first indicator 840 coupled with or positioned proximate the rear end 24. As another example, the tractor 10 may include a second indicator 840 coupled with or proximate the front end 22. In some embodiments, the indicators 840 are communicably coupled with the controller 402. For example, the controller 402 may transmit one or more signals to cause operation of the indicators 840. In some embodiments, the indicators 840 include at least one of light sources, light fixtures, lighting equipment, and/or lightbars. For example, the indicators 840 may include light emitting diodes (LEDs) that produce or otherwise generate light. In some embodiments, the indicators 840 produce light to indicate one or more statuses of the tractor 10. For example, the indicators 840 may produce light to indicate that the controller 402 established communication with the controller 805. As another example, the indicators 840 may produce light at a given end and/or portion of the tractor 10 to indicate a direction of travel of the tractor 10. In some embodiments, the controller 805 causes the indicators 840 to produce light to illuminate a path or area proximate to the tractor 10. For example, the controller 805 may cause the indicators 840 to illuminate the rear end 24 of the tractor 10. As another example, the controller 805 may cause the indicators 840 to illuminate an area around the tractor 10 to assist with a visibility of one or more portions of the tractor 10.

In some embodiments, the controller 805 refers to and/or includes at least one of ground control stations, handheld devices, receivers and transmitters, control units, radio devices, and/or circuitry separate from that of the tractor 10. For example, the controller 805 may be or include a handheld remote-control device. As shown in FIG. 55, the controller 805 includes a processing circuit 810, an interface 825, and an input/output device (shown as I/O device 830). The devices and/or components of the controller 805 may be provided as one or more discrete and/or separate components. For example, the interface 825 may be separate from the I/O device 830. In some embodiments, the devices and/or components of the controller 805 are provided via at least one of system on chips, printed circuit boards, pluggable components that couple with one or more ports or terminals of a processing system (e.g., the processing circuit 810). In some embodiments, the interface 825 includes at least one of human-machine interfaces or network devices (e.g., network jacks, ethernet ports, network interface cards, transmitters, receivers, transceivers, radio devices, antenna, etc.).

As shown in FIG. 55, the processing circuit 810 includes at least one processor 815 and a memory 820. The processing circuit 810 and/or one or more components thereof (e.g., the processor 815 and the memory 820) may include various computing devices, hardware, and/or circuitry described herein. In some embodiments, the memory 820 stores instructions that, when executed by the processor 815, cause the processor 815 to perform at least one of the various actions and/or processes described herein. As shown in FIG. 55, the I/O device 830 includes at least one first input device, shown as joystick 842, at least one display, shown as display 844, at least one second input device, shown as button 846, at least one output device (e.g., lighting element, display, etc.), shown as indicator 848, and at least one haptic output device (e.g., a vibration motor, an actuator, etc.), shown as haptic device 850. In some embodiments, the I/O device 830 and/or one or more components thereof communicate with the processing circuit 810 to exchange information. For example, the joystick 842 may provide one or more inputs to the processing circuit 810 to indicate interactions with the remote-control device. Stated otherwise, the joystick 842 may receive inputs (e.g., from an operator of the remote-control device) and provide the inputs to the processing circuit 810.

In some embodiments, the joystick 842 includes at least one of an input device, a repositionable device, and/or a moveable device that receives inputs to control subsequent movement of an object (e.g., the tractor 10). In some embodiments, the display 844 includes at least one of the various displays and/or interface devices described herein. In some embodiments, the buttons 846 include at least one of a keypad, a keyboard, and/or a device including one or more digits or selectable elements. In some embodiments, the indicators 848 include at least one of the various light sources and/or light fixtures described herein. In some embodiments, the haptic devices 850 include at least one of audio devices, a tactile device, a device that produces vibration, and/or a device that produces force.

In some embodiments, the joystick 842 receives one or more inputs or control actions to control movement of the tractor 10. For example, the joystick 842 may receive a first input to indicate a direction of travel of the tractor 10. The interface 825 may provide, to the controller 402, the first input to cause the tractor 10 to move in accordance with the first input (e.g., move in the direction of travel). As another example, the joystick 842 may receive a second input to activate the capture system 70. The interface 825 may provide the second input, to the controller 402, to cause activation of the capture system 70.

In some embodiments, the controller 805 communicates with and/or syncs with one or more machines. For example, as shown in FIG. 55, the controller 805 may be synchronized or connected with the tractors 10a, 10b, and 10c. In some embodiments, the controller 805 stores information associated with synchronization with the tractors 10a, 10b, and 10c in the memory 820. For example, the controller 805 may store a network address or credentials associated with each of the tractors 10a, 10b, and 10c. As another example, the controller 805 may store information associated with previous handshakes and/or exchanges to create and/or reestablish communication with the tractors 10a, 10b, and 10c.

In some embodiments, the controller 805 is configured to synchronize with and/or otherwise connect to multiple devices such that a single controller (e.g., the controller 805) can be used to control the plurality of tractors 10a, 10b, and 10c. For example, the controller 805 may synchronize with the tractor 10a by directing transmissions of the interface 825 to the tractor 10a. As another example, the controller 805 may sync to multiple devices and the controller 805 may select which device to transmit signals to. In some embodiments, the controller 805 synchronizes with a given device based on one or more inputs provided to the I/O device 830. For example, a first interaction with the I/O device 830 (e.g., the joystick 842, the display 844, the button 846, etc.) may indicate an input to synchronize with the tractor 10a. As another example, a second interaction with the I/O device 830 may indicate an input to synchronize with the tractor 10b. In some embodiments, the controller 805 causes performance of one or more actions to indicate successful synchronization between the controller 805 and the tractor 10. For example, the controller 805 may cause the indicators 848 to produce light having a respective pattern (e.g., brightness, color, flash, pulse, blink, etc.) to indicate when the controller 805 has synchronized with the tractor 10. In some embodiments, the controller 805 provides one or more signals to the tractor 10 to cause the tractor 10 to indicate synchronization with the controller 805. For example, the controller 805 may provide one or more signals to cause the indicators 840 to produce light having the same or similar patten to that of the indicators 848. As another example, the controller 805 may provide one or more signals to cause the tractor 10 to produce an audio noise or sound to indicate synchronization with the controller 805.

In some embodiments, controller 805 establishes and/or reestablishes communication with the tractor 10 based on one or more addresses provided to the controller 805. For example, the buttons 846 may be selected in a respective order or pattern to identify a respective address and/or identifier for the tractor 10. Stated otherwise, the buttons 846 may receive an input that identifies a respective tractor 10 to synchronize with.

In some embodiments, the display 844 presents and/or otherwise displays information associated with the tractor 10. For example, the display 844 may provide a user interface that includes information associated with the tractor 10. In some embodiments, the information associated with the tractor 10 may include at least one of a state of charge (SoC) of one or more batteries and/or energy storage devices of the tractor 10, a camera feed associated with the sensors 430 and/or the vision system 450, and/or information associated with one or more operations performable by the tractor 10.

In some embodiments, the controller 805 includes a housing or an assembly that stores or includes the various components of the controller 805. The housing may include one or more coupling devices (e.g., a mount, a strap, magnets, clips, etc.) to couple the controller 805 with one or more objects. For example, the one or more coupling devices may couple the controller 805 with a collision avoidance system and/or collision avoidance device. In some embodiments, the controller 805 overrides and/or adjusts one or more inputs provided to the controller 805. For example, the controller 805 may override a first input, provided to the joystick 842, to prevent oversteering of the tractor 10 (e.g., the first input exceeding a threshold). As another example, the controller 805 may override a second input, provided to the joystick 842, to adjust a speed of the tractor 10 associated with second input.

In some embodiments, the controller 805 includes one or more sensors to detect that the controller 805 is being held and/or operated by a person. For example, the controller 805 may include sensors in a respective area of the housing to detect a palm or a hand of a person that is holding the controller 805. In some embodiments, the controller 805 is inoperable and/or non-responsive prior to the sensors detecting that the controller 805 is being held. Stated otherwise, the controller 805 may enter a standby or rest mode while the controller 805 is not being held.

In some embodiments, the tractor 10 includes one or more stations, ports, or cradles to receive the controller 805. For example, the tractor 10 may include a docking station to receive the controller 805. In some embodiments, the controller 805 is configured to couple with the tractor 10, via the stations, to receive power and/or energy from the tractor 10. For example, the docking station may electrically couple the controller 805 with one or more batteries of the tractor 10 such that the controller 805 may receive power from the batteries to charge one or more energy storage devices of the controller 805.

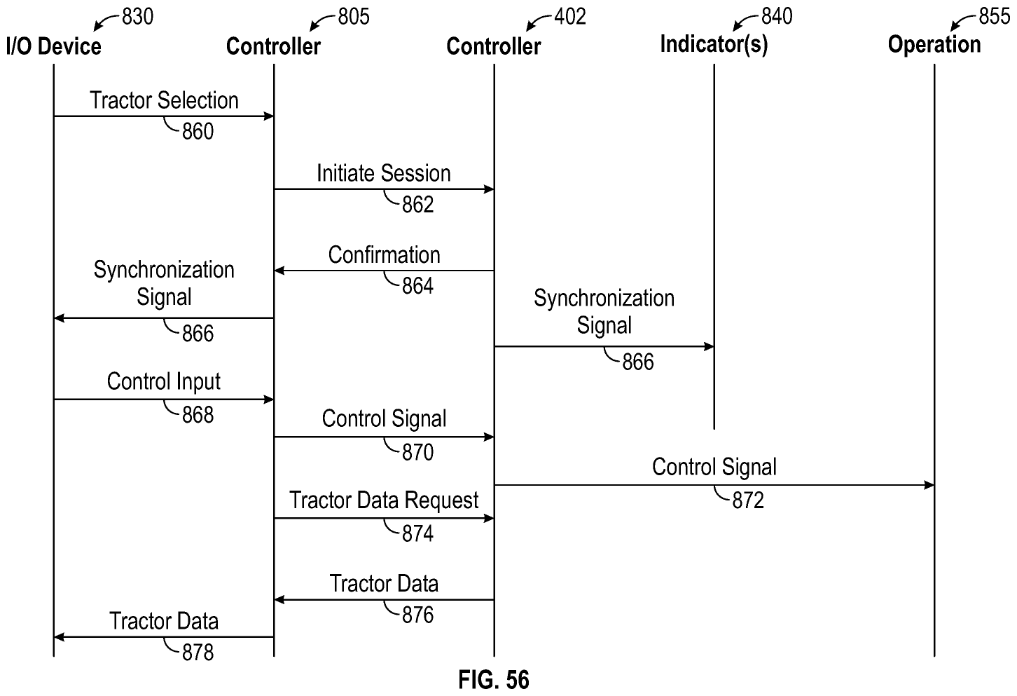

As shown in FIG. 56, a sequence diagram of communication between components of the remote control system 800 is shown, according to an exemplary embodiment. In some embodiments, at least one step, illustrated in FIG. 56, may be omitted, skipped, altered, adjusted, modified, repeated, changed, and/or replicated. While the sequence diagram, as illustrated in FIG. 56, may show one or more components performing steps of the sequence diagram, this is for illustrative purposes only and is in no way limiting.

At step 860, a selection of a respective tractor 10 is received as an input. For example, the controller 805 may receive an indication of a selection of the respective tractor 10 from the I/O device 830. In some embodiments, the controller 805 receives the indication responsive to one or more interactions with the I/O device 830. For example, the controller 805 may receive the indication responsive to a selection of a first button 846 that is associated with the respective tractor 10. As another example, the controller 805 may receive the indication responsive to interaction with a user interface display by the display 844.

At step 862, a request to initiate a session is transmitted from the controller 805 to the controller 402. For example, the controller 805 may transmit one or more signals to the controller 402 to initiate and/or establish communication with the respective tractor 10. As another example, the controller 805 may control operation of the interface 825 to cause the interface 825 to transmit one or more signals to an address associated with the respective tractor 10. In some embodiments, initiation of a session may refer to or include the transmission of one or more pings or prompts for a response from the tractor 10. For example, initiation of the session may include the transmission of a first (e.g., initial) handshake message. Stated otherwise, the controller 805 may initiate a session via transmission one or more signals in accordance with a communication protocol.

At step 864, a confirmation signal from the controller 402 is received by the controller 805. For example, the controller 805 may receive a signal, from the controller 402, that confirms an establishment of communication between the respective tractor 10 and the controller 805. As another example, the controller 805 may receive an indication, from the interface 825, of receipt of a confirmation signal from the controller 402. Stated otherwise, the controller 805 may receive a response, an acknowledgment, or a subsequent handshake to finalize establishment of a communication session between the controller 805 and the controller 402. For example, the controller 805 may receive a data packet, from the controller 402, which includes information to indicate a successful establishment of communication. Additionally, or alternatively, the controller 402 may transmit a practice control request (e.g., a prompt for the controller 805 to provide a given command) to confirm that the controller 402 is receiving signals (e.g., commands) from the controller 805.

At step 866, a signal to indicate synchronization is transmitted from the controller 805 to the I/O device 830. For example, the controller 805 may transmit one or more signals to the I/O device 830 to cause the indicators 848 to produce light to indicate synchronization between the controller 805 and the respective tractor 10. Stated otherwise, the controller 805 may cause the indicators 848 to produce light that indicates an establishment of communication between the controller 805 and the respective tractor 10. In some embodiments, the controller 402 transmits one or more signals to the indicators 840 to cause the indicators 840 to produce light to indicate synchronization. The controller 805 and the controller 402 may transmit similar signals such that the indicators 848 and the indicators 840 produce light having a similar pattern. For example, the indicators 848 and the indicators 840 may receive signals such the indicators 848 and indicators 840 produce light that blink at the same time, color, and/or at the same frequency (which may help an operator identify which tractor 10 the controller 805 has connected or synced to).

At step 868, an input to control operation of the respective tractor 10 is received by the I/O device 830 of the controller 805. For example, the controller 805 may receive an input from the joystick 842. The input form the joystick 842 may indicate a given operation for the respective tractor 10. For example, the input may indicate a given direction for the respective tractor 10 to travel. As another example, the input may indicate a given operation for the respective tractor 10 to perform (e.g., capture the nose landing gear 4, release the nose landing gear 4, etc.).

At step 870, a control signal is transmitted from the controller 805 to the controller 402. For example, the controller 805 may transmit a control signal to the controller 402 based on the input received in step 868. As another example, the controller 805 may forward and/or transmit one or more inputs, received from the I/O device 830, to the controller 402.

At step 872, a control signal is transmitted from the controller 402 to one or more components of the respective tractor 10. For example, the controller 402 may transmit the control signal received in step 870 to one or more components of the respective tractor 10 to cause the respective tractor 10 to perform a respective action or operation associated with the control signal. The controller 402 may transmit the control signal to the prime mover 52 to cause the respective tractor 10 to move in a respective direction. The controller 402 may transmit the control signal to the capture system 70 to cause the capture system 70 to perform a respective action (e.g., capture the nose landing gear 4, release the nose landing gear 4, etc.).

At step 874, a request for data is transmitted from the controller 805 to the controller 402. For example, the controller 805 may transmit a signal to the controller 402 that indicates a request for information/data associated with the respective tractor 10. The information/data associated with the respective tractor 10 may include at least one of a state of charge (SoC) of the respective tractor 10, a video feed captured and/or produced by the sensors 430 and/or the vision system 450, and/or telemetric data associated with operation of the respective tractor 10 and/or one or more components thereof.

At step 876, the data is received by the controller 805 from the controller 402. For example, the controller 805 may receive the information associated with the respective tractor 10 from the controller 402. As another example, the controller 402 may establish a connection between the controller 805 and data sources that include the information/data associated with the respective tractor 10.

At step 878, the data is presented by the display 844. For example, the display 844 may generate and/or present a user interface that includes the information associated with the respective tractor 10. As another example, the controller 805 may forward the information associated with the respective tractor 10 to one or more display devices (e.g., monitors, smart phones, tablets, computers, etc.) to cause the display devices to present the information associated with the respective tractor 10.

### Light System

As shown in FIGS. 7-9, 36, and 57-61, the tractor 10 includes a light indicator system (e.g., a turn indicator system, a direction of travel indicator system, etc.), shown as light system 62. The light system 62 includes a first lighting element, shown as left lighting element 64, and a second lighting element, shown as right lighting element 66. In some embodiments, the light system 62 functions as the indicators 840. In some embodiments, the light system 62 includes one or more additional lighting elements (e.g., warning lights, spotlights, headlights, brake lights, tail lights, running lights, etc.). The light system 62 (e.g., the right lighting element 66, the left lighting element 64, etc.) is configured to emit lights in various patterns, with various colors, at various frequencies, and/or with varying intensities or brightness. By way of example, the light system 62 may emit pulsing lights, strobing lights, constant lights (e.g., spotlight), colored lights, etc. The light system 62 may provide flashing lights or controlled to flash such that, when flashing, are indicative of an operation of the tractor 10 (e.g., the tractor 10 is towing, pushing-back, or otherwise manipulating the airplane 2, the tractor 10 is traveling forwards or backwards, the tractor 10 is turning left of right, the tractor 10 is in a remote control mode, the tractor 10 is in an autonomous operation mode, etc.). In some embodiments, one or more components of the light system 62 emit a constant, bright light to illuminate an area surrounding the tractor 10 so operators may be able to see an otherwise dark environment, for example.

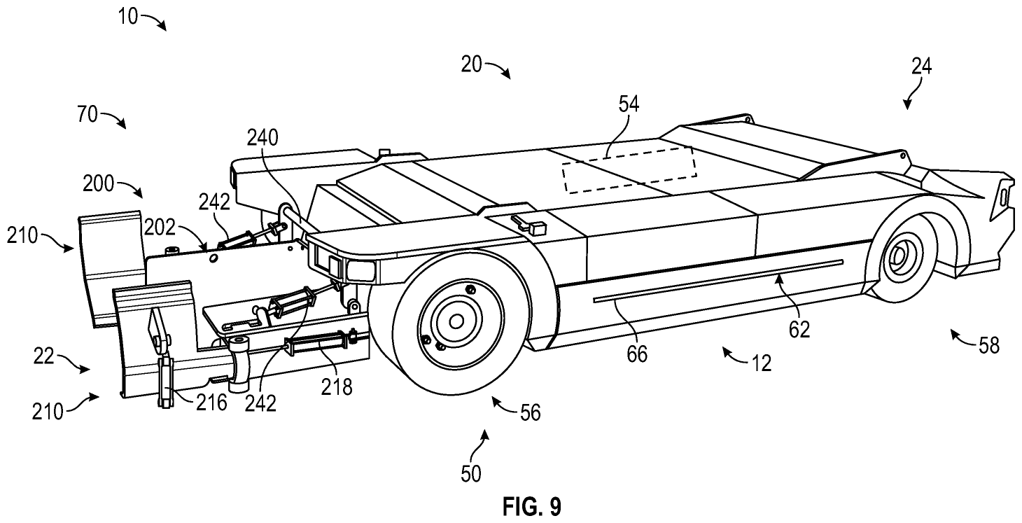

As shown in FIGS. 7, 8, 57, and 58, the right lighting element 66 is coupled, mounted, or otherwise affixed to the tractor 10 on a side surface (e.g., a right sidewall extending along the right side 28 between the front end 22 and the rear end 24) of the body 20 longitudinally between the front tractive assembly 56 and the rear tractive assembly 58. In some embodiments, the right lighting element 66 is otherwise mounted or otherwise affixed to the tractor 10 at or on other surfaces or components along a right half thereof (e.g., along a half of the tractor 10 proximate the right side 28 and defined by a plane extending through a lateral centerline of the body 20). As shown in FIGS. 9, 57, and 58, the left lighting element 64 is coupled, mounted, or otherwise affixed to the tractor 10 on a side surface (e.g., a left sidewall extending along the left side 26 between the front end 22 and the rear end 24) of the body 20 longitudinally between the front tractive assembly 56 and the rear tractive assembly 58. In some embodiments, the left lighting element 64 is otherwise mounted or otherwise affixed to the tractor 10 at or on other surfaces or components along a left half thereof (e.g., along a half of the tractor 10 proximate the left side 26 and defined by a plane extending through a lateral centerline of the body 20). In some embodiments, the left lighting element 64 and the right lighting element 66 are symmetric about a center plane (e.g., a plane extending through a lateral centerline of the body 20). In some embodiments, the left lighting element 64 and the right lighting element 66 each include a housing and a plurality of lighting elements disposed within the housing to form a light bar.

As shown in FIG. 36, the light system 62 is communicably coupled with the controller 402 and configured to execute commands received from the controller 402 (or the controller 805). Responsive to receiving a signal from the controller 402, the right lighting element 66 may emit lights in various patterns, with various colors, at various frequencies, and/or with varying intensities or brightness according to the signal independent of the left lighting element 64. Similarly, responsive to receiving a signal from the controller 402, the left lighting element 64 may emit lights in various patterns, with various colors, at various frequencies, and/or with varying intensities or brightness according to the signal independent of the right lighting element 66. By way of example, responsive to the first operator controls 40, the second operator controls 49, the controller 805, and/or any other component of the tractor 10 receiving an input (e.g., from a user), the controller 402 may transmit a signal commanding the left lighting element 64 and/or the right lighting element 66 to emit lights indicative of the received input. By way of another example, the left lighting element 64 and/or the right lighting element 66 may emit lights according to an operation of the tractor 10 (e.g., a travel direction of the tractor 10, a winching operation performed by the winch-capture system 72, a capture operation performed by the hands-free capture system 200, a remote control operation performed by the tractor 10, an autonomous operation performed by the tractor 10, etc.).

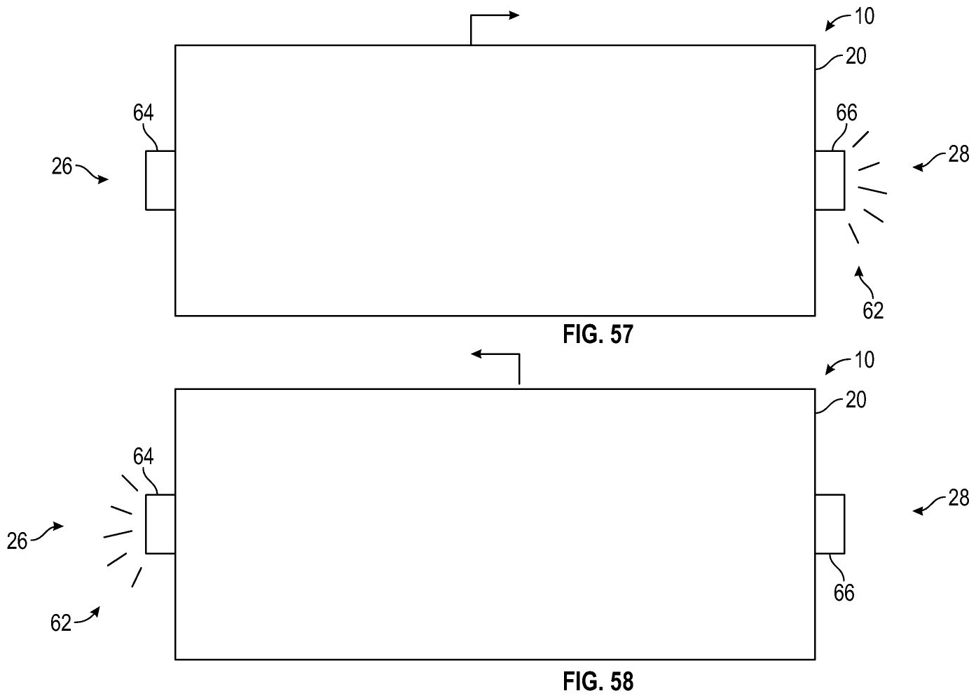

As shown in FIGS. 57 and 58, the left lighting element 64 and the right lighting element 66 are configured emit lights responsive to the tractor 10 turning. As shown in FIG. 57, when the tractor 10 turns right (e.g., when the front tractive assembly 56 and/or the rear tractive assembly 58 are steered to turn the tractor 10 to the right, as indicated by the arrow in FIG. 57), the right lighting element 66 is configured to emit light, thereby providing an indication that the tractor 10 is turning right. In some embodiments, the right lighting element 66 periodically flashes (e.g., every 0.5 seconds, every 1 second, etc.) to provide an indication (e.g., to a remote operator of the tractor 10, to one or more people surrounding the tractor 10, to a pilot operating the airplane 2, any other personnel at the airport, etc.) that the tractor 10 is turning right. In some embodiments, the right lighting element 66 emits a constant, bright light to illuminate an area surrounding the right side 28 of the tractor 10 (e.g., an area in the direction in which the tractor 10 is turning) so operators may be able to see an otherwise dark environment. By way of example, the right lighting element 66 may illuminate a foot path surrounding the tractor 10 so operators can see where they are walking around the tractor 10. In some embodiments, when the right lighting element 66 is emitting light indicative of the tractor 10 turning right, the left lighting element 64 does not emit light, or emits a light indicative of the tractor 10 not turning left.

As shown in FIG. 58, when the tractor 10 turns left (e.g., when the front tractive assembly 56 and/or the rear tractive assembly 58 are steered to turn the tractor 10 to the left, as indicated by the arrow in FIG. 58), the left lighting element 64 is configured to emit light, thereby providing an indication that the tractor 10 is turning left. In some embodiments, the left lighting element 64 periodically flashes (e.g., every 0.5 seconds, every 1 second, etc.) to provide an indication (e.g., to the operator of the tractor 10, to one or more people surrounding the tractor 10, to a pilot operating the airplane 2, any other personnel at the airport, etc.) that the tractor 10 is turning. In some embodiments, the left lighting element 64 emits a constant, bright light to illuminate an area surrounding the left side 26 of the tractor 10 (e.g., an area in the direction in which the tractor 10 is turning) so operators may be able to see an otherwise dark environment. By way of example, the right lighting element 66 may illuminate a foot path surrounding the tractor 10 so operators can see where they are walking around the tractor 10. In some embodiments, when the left lighting element 64 is emitting light indicative of the tractor 10 turning left, the right lighting element 66 does not emit light, or emits a light indicative of the tractor 10 not turning right.

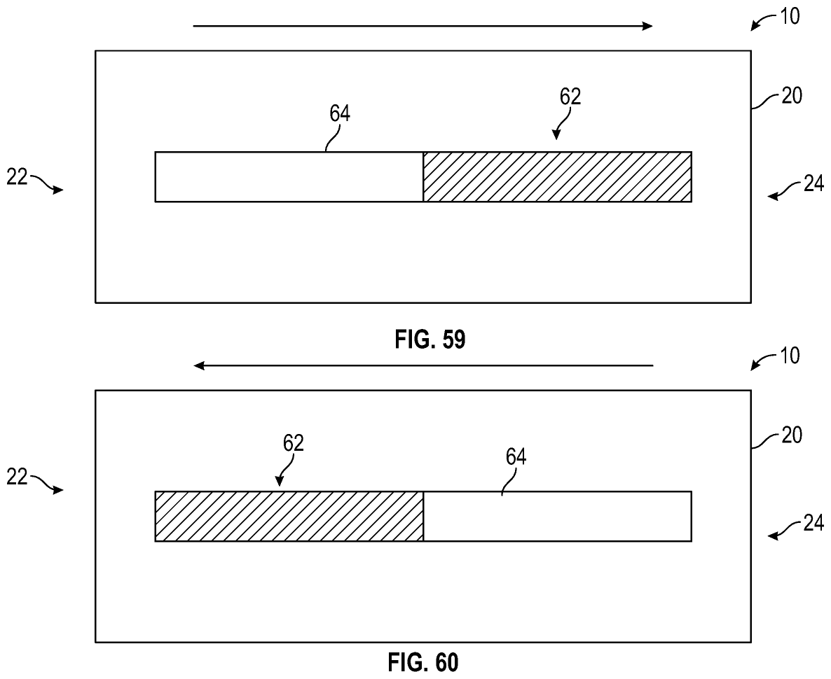

As shown in FIGS. 59 and 60, the left lighting element 64 is configured emit lights responsive to a direction of travel of the tractor 10. As shown in FIG. 59, when the tractor 10 travels in a generally backward direction (e.g., during reversing operations, during towing operations, etc.), a rear portion of the left lighting element 64 (e.g., a portion of the left lighting element 64 closest to the rear end 24, a rear half, a rear third, a rear three-quarters, etc.) is configured to emit light (e.g., as indicated by the cross-hatchings of FIG. 59), while a front portion of the left lighting element 64 (e.g., a portion of the left lighting element 64 closest to the front end 22, a front half, a front third, a front three-quarters, etc.) does not emit light (e.g., as indicated by the lack of cross-hatchings of FIG. 59), thereby providing an indication that the tractor 10 is traveling backwards. As shown in FIG. 60, when the tractor 10 travels in a generally forward direction (e.g., during pushback operations, etc.), the front portion of the left lighting element 64 is configured to emit lights (e.g., as indicated by the cross-hatchings of FIG. 60), while the rear portion of the left lighting element 64 does not emit light (e.g., as indicated by the lack of cross-hatchings of FIG. 60), thereby providing an indication that the tractor 10 is traveling forwards. Similarly, the right lighting element 66 is configured to synchronize with the left lighting element 64 responsive to the direction of travel of the tractor 10. By way of example, when the tractor 10 travels in a generally backward direction a rear portion of the right lighting element 66 is configured to emit light, while a front portion of the right lighting element 66 does not emit lights, and when the tractor 10 travels in a generally forward direction the front portion of the right lighting element 66 is configured to emit light, while the rear portion of the right lighting element 66 does not emit lights.

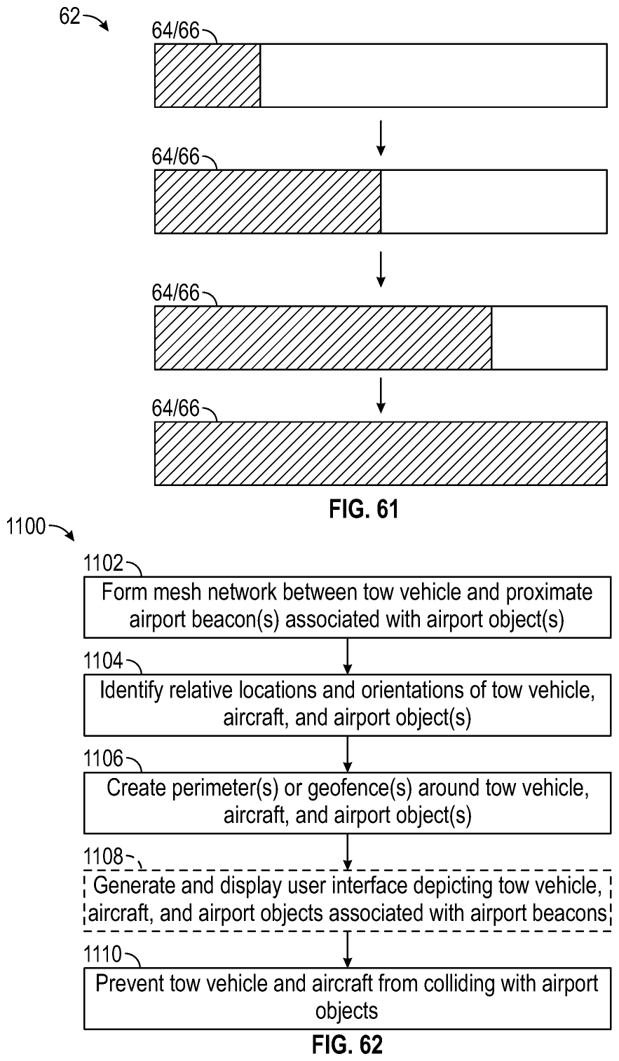

As shown in FIG. 61, the left lighting element 64 and/or the right lighting element 66 of the light system 62 are configured to progressively illuminate along a longitudinal length thereof to provide an indication of the direction of travel of the tractor 10. As shown in FIG. 61, an initial state of the light system 62 is shown where a first portion (e.g., one-quarter) of the left lighting element 64 and/or the right lighting element 66 emit light (e.g., as indicated by the cross-hatchings of FIG. 61) and the remaining portion thereof does not emit light (e.g., as indicated by the lack of cross-hatchings of FIG. 61). As indicated by the arrow below the initial state of the light system 62, the light system 62 transitions to a second state where a second portion (e.g., half, the second portion being larger than the first portion, etc.) of the left lighting element 64 and/or the right lighting element 66 emit light and the remaining portion thereof does not emit light. Next, the light system 62 transitions to a third state where a third portion (e.g., three-quarters, the third portion being larger than the second portion, etc.) of the left lighting element 64 and/or the right lighting element 66 emit light and the remaining portion thereof does not emit light. Finally, the light system 62 transitions to a fourth state where the entirety of the left lighting element 64 and/or the right lighting element 66 emits light. The light system 62 may transition to more or fewer than four states (e.g., two states, three states, five states, etc.) to progressively illuminate. In some embodiments, the portions of the light system 62 fade into each other during the transition between the states. Generally, the illuminated length of the light system 62 increases during the progressive illumination pattern incrementally over time until the entire left lighting element 64 and/or right lighting element 66 is fully illuminated. The progressive illumination pattern may then repeat. As viewed from FIG. 61, the left side illuminates first and the illuminated length of the light system 62 increases in a direction to the right. In some embodiments, the right side illuminates first and the illuminated length of the light system 62 increases in a direction to the left. By way of example, if the lighting element depicted in FIG. 61 is the left lighting element 64, the progression of illumination from the left to the right may be indicative of the tractor 10 traveling backwards. By way of another example, if the lighting element depicted in FIG. 61 is the right lighting element 66, the progression of illumination from the left to the right may be indicative of the tractor 10 traveling forwards.

In some embodiments, responsive to the controller 805 receiving an input (e.g., an input to the joysticks 842 of the controller 805), the controller 805 transmits a signal to the controller 402, which the controller 402 implement and action based on the signal and causes the left lighting element 64 and/or the right lighting element 66 to emit lights indicative of the input to the controller 805. By way of example, responsive to the operator providing an input to the joysticks 842 of the controller 805 to steer the front tractive assembly 56 and/or the rear tractive assembly 58 to turn the tractor 10 left or right, the controller 402 may transmit a signal commanding the left lighting element 64 or the right lighting element 66, respectively, to emit light indicative of the direction of the turn. By way of another example, responsive to the buttons 846 (e.g., an accelerator button) of the controller 805 receiving an input from the user, the controller 402 may transmit a signal commanding the left lighting element 64 and/or the right lighting element 66 to emit lights indicative of the tractor 10 traveling forwards (e.g., when the tractor 10 is in a drive mode, during pushback operations, etc.) or traveling backwards (e.g., when the tractor 10 is in a reverse mode, during towing operations, etc.). By way of yet another example, responsive to the buttons 846 (e.g., a brake button) of the controller 805 receiving an input from the user, the controller 402 may transmit a signal commanding the left lighting element 64 and/or the right lighting element 66 to emit lights indicative of the tractor 10 braking (e.g., a red light, a flashing pattern, etc.).

In embodiments where the tractor 10 is autonomously operated, remotely operated, and/or semi-autonomously operated (e.g., when the data captured by the vision system 450 is used to control driving operations of the tractor 10), the controller 402 automatically transmits a signal commanding the left lighting element 64 and/or the right lighting element 66 to emit lights indicative of the driving operation of the tractor 10. By way of example, responsive to the controller 402 transmitting signal commanding the front tractive assembly 56 and/or the rear tractive assembly 58 to steer to turn the tractor 10 left or right (e.g., responsive to following a predetermined route, responsive to avoiding a detected obstacle based on the data captured by the vision system 450, etc.), the controller 402 may transmit a signal commanding the left lighting element 64 or the right lighting element 66, respectively, to emit lights indicative of the direction of the turn. By way of another example, responsive to the controller 402 transmitting signal commanding the prime mover 52 to drive the front tractive assembly 56 and/or the rear tractive assembly 58 to drive the tractor 10 forwards or backwards (e.g., responsive to following a predetermined route, responsive to executing a pushback operation, a towing operation, a capture operation, etc.), the controller 402 may transmit a signal commanding the left lighting element 64 and/or the right lighting element 66 to emit lights indicative of whether the tractor 10 is traveling forwards or backwards. By way of yet another example, responsive to the controller 402 transmitting signals commanding the braking system 60 to engage with the front tractive assembly 56 and/or the rear tractive assembly 58 to brake (e.g., stop, slow, etc.) the tractor 10, the controller 402 may transmit a signal commanding the left lighting element 64 and/or the right lighting element 66 to emit lights indicative of the tractor 10 braking (e.g., a red light, a flashing pattern, etc.).

In embodiments where the operation of the tractor 10 is controlled remote therefrom by the controller 805, the operator providing inputs to the controller 805 may be standing outside of the tractor 10 (e.g., on a tarmac outside of the tractor 10, in a control tower at the airport, etc.). Similarly, in embodiments where the operation of the tractor 10 is controlled autonomously, the operator monitoring operation of the tractor 10 may be standing outside of the tractor 10. When the tractor 10 is driven away from the operator, the direction of travel of the tractor 10 may be difficult to see. By way of example, the tractor 10 may be positioned far away from the operator (e.g., the operator controlling operation thereof using the controller 805, the operator monitoring autonomous operation thereof, etc.) such that perceiving the direction of travel of the tractor 10 is difficult. By way of another example, when it is dark outside, it may be difficult for the operator to see the direction of travel of the tractor 10. Accordingly, the light system 62 facilitates providing indications (e.g., flashing lights, constant lights, etc.) to the operator indicative of the direction of travel of the tractor 10. That is, when the tractor 10 is far away from the operator and/or when it is dark outside, the light system 62 makes left and right turns and forward and backward travel of the tractor 10 perceivable to the operator and/or other persons operating or working around the airplane 2.

In some embodiments, responsive to the first operator controls 40 receiving an input (e.g., from a user), the controller 402 transmits a signal commanding the left lighting element 64 and/or the right lighting element 66 to emit lights indicative of the received input. By way of example, the operator interface 48 of the first operator controls 40 may include a turn signal stalk (e.g., a lever, a switch, etc.), and, responsive to the operator providing an input to the operator interface 48 indicative of the tractor 10 turning left or right, the controller 402 may transmit a signal commanding the left lighting element 64 or the right lighting element 66, respectively, to emit light indicative of the direction of the turn. By way of another example, responsive to the operator providing an input to the steering wheel 42 to steer the front tractive assembly 56 and/or the rear tractive assembly 58 to turn the tractor 10 left or right, the controller 402 may transmit a signal commanding the left lighting element 64 or the right lighting element 66, respectively, to emit lights indicative of the direction of the turn (e.g., determined based on a steered angle of the steering wheel 42, based on wheel angle data acquired by the sensors 434, etc.). In some embodiments, responsive to the accelerator 44 receiving an input from the user, the controller 402 transmits a signal commanding the left lighting element 64 and/or the right lighting element 66 to emit lights indicative of the tractor 10 traveling forwards (e.g., when the tractor 10 is in a drive mode, when operation of the tractor 10 is controlled using the forward travel compartment 32, during pushback operations, etc.) or traveling backwards (e.g., when the tractor 10 is in a reverse mode, when operation of the tractor 10 is controlled using the rearward travel compartment 34, during towing operations, etc.). In some embodiments, responsive to the brake 46 receiving an input from the user, the controller 402 transmits a signal commanding the left lighting element 64 and/or the right lighting element 66 to emit lights indicative of the tractor 10 braking (e.g., a red light, a flashing pattern, etc.).

In some embodiments, responsive to the second operator controls 49 receiving an input (e.g., from a user), the controller 402 transmits a signal commanding the left lighting element 64 and/or the right lighting element 66 to emit lights indicative of the received input. By way of example, responsive to the operator providing an input to the second operator controls 49 to control operation of the capture system 70 (e.g., to perform a winching operation, a capture operation, a lifting/lowing operation, etc.), the controller 402 may transmit a signal commanding the left lighting element 64 and/or the right lighting element 66 to emit light indicative of the operation of the capture system 70 (e.g., flashing yellow lights).

In some embodiments, the color of the left lighting element 64 and the right lighting element 66 is configured to indicate a mode of operation of the tractor 10. As one example, the left lighting element 64 and the right lighting element 66 may provide light in a first color when manually driven (e.g., yellow), a second color when remotely driven (e.g., purple), and a third color when autonomously driven (e.g., green). As another example, the left lighting element 64 and the right lighting element 66 may provide light in a first color when driving forward (e.g., green), a second color when driving rearward (e.g., blue), and a third color when the capture system 70 is in operation (e.g., yellow). As yet another example, the left lighting element 64 and the right lighting element 66 may provide light in a first color when accelerating (e.g., green) and a second color when decelerating (e.g., red).

In some embodiments, the color of the left lighting element 64 and the right lighting element 66 differ. By way of example, the left lighting element 64 may illuminate a first color (e.g., red) and the right lighting element 66 may illuminate a second color (e.g., green) such that a person observing the tractor 10 can identify which side of the tractor 10 they are viewing and, therefore, a direction of travel thereof.

### Collision Avoidance

In some embodiments, the tractor control system 400 may be configured to ensure that the tractor 10 and the airplane 2 (and/or various other airplanes or aircraft) are prevented from colliding with various other objects (e.g., light poles, boarding bridges, maintenance hangar walls or other features, and/or other ground support equipment). That is, in some embodiments, the tractor control system 400 functions as a collision avoidance system. As will be described below, the tractor control system 400 may be configured to utilize a variety of beacons (e.g., mesh network enabled devices, the controller 402) associated with or otherwise incorporated within objects (e.g., light poles, boarding bridges, various GSE, etc.) at an airport to prevent collisions between the tractor 10, the airplane 2, and the objects associated with the beacons.

According to an exemplary embodiment shown in FIG. 62, a method 1100 for collision avoidance may be implemented by the tractor control system 400. For example, as will be described below, the method 1100 may include (i) forming a mesh network between a tow vehicle (e.g., the tractor 10) and one or more proximate airport beacons (e.g., mesh-network-enabled devices) associated with one or more corresponding airport objects (e.g., cameras, light poles, boarding bridges, various GSE, aircrafts, etc.), at step 1102; (ii) identifying relative locations and orientations of (e.g., the relative positioning between) the tow vehicle, an aircraft (e.g., the airplane 2) being moved by the tow vehicle, and the one or more airport objects, at step 1104; (iii) creating perimeters or geofences around the tow vehicle, the aircraft, and/or the one or more airport objects, at step 1106; (iv) generating and displaying a user interface depicting the tow vehicle, the aircraft, and/or the one or more airport objects, at step 1108; and/or (v) preventing the tow vehicle and aircraft from colliding with the airport objects, at step 1110. It should be appreciated that the method 1100 is provided as an example. In some other embodiments, the method 1100 may include additional steps and/or omit various steps described herein.

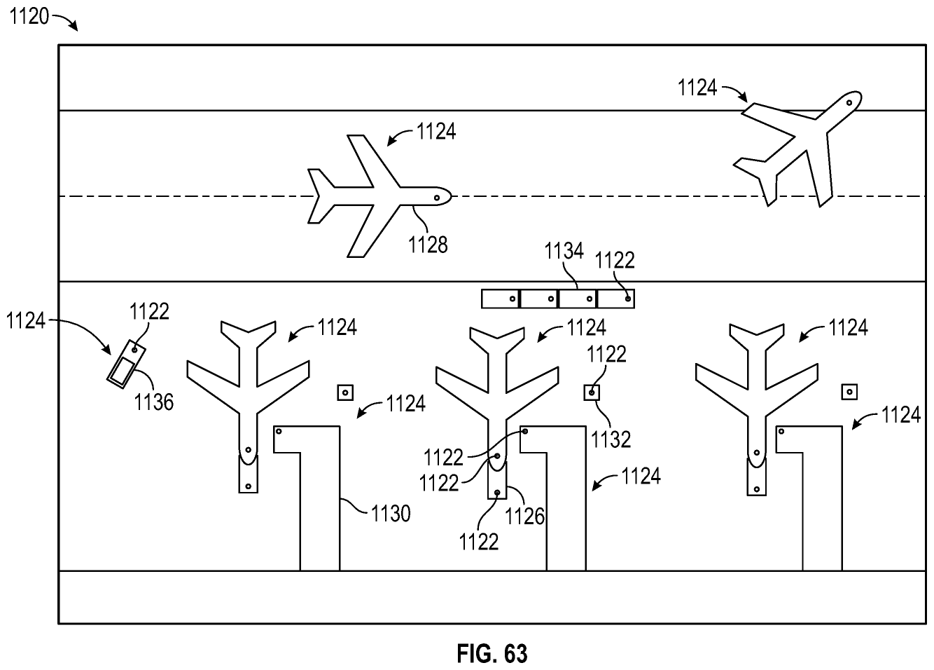

As shown in FIG. 62, the method 1100 begins with forming a mesh network or otherwise establishing a communication connection (e.g., a wireless communication connection) between the tow vehicle and the one or more proximate airport beacons, at step 1102. For example, with reference to FIG. 63, an exemplary embodiment of an airport environment 1120 includes a plurality of beacons 1122 associated with a plurality of airport objects 1124. The beacons 1122 can each include a controller (e.g., the controller 402 or a similar controller) having a corresponding processing circuit (e.g., the processing circuit 404 or a similar processing circuit), memory (e.g., the memory 406 or a similar memory), and a communications interface (e.g., the communications interface 408 or a similar communications interface) that are configured to collectively allow for the beacons 1122 to communicate and to create mesh networks (e.g., via various protocols stored or otherwise coded into the beacons 1122) with nearby devices (e.g., the controller 402 of the tractor 10, other beacons 1122).

As illustrated, the airport objects 1124 having corresponding beacons 1122 include various tow vehicles 1126 (e.g., the tractor 10 and/or other tow vehicles similar to the tractor 10), aircraft 1128 (e.g., the airplane 2 and/or other aircraft similar to the airplane 2), boarding bridges 1130, light poles 1132, luggage transport vehicles 1134, and other GSEs 1136 (e.g., a baggage loader, a cargo loader, a de-icer, a fueling truck, a food truck, a dolly, a stair truck, a passenger bus, etc.). It will be appreciated that, in other embodiments, a variety of additional or alternative airport objects may similarly include beacons. For example, in some instances, beacons may be installed in or along external walls of the airport, within cameras or other sensors associated with an airport (e.g., security cameras or other security sensors), within various hangar spaces, and/or within any other objects generally that may need to be avoided during transport, servicing, pre-flight preparation, and/or storage of aircraft.

Accordingly, as a tow vehicle (e.g., the tractor 10, any other tow vehicle 1126) tows, pushes, or otherwise moves an aircraft (e.g., the airplane 2), the controller 402 communicates and forms a mesh network with various proximate beacons (e.g., beacons 1122) within an airport environment (e.g., the airport environment 1120).

With reference again to FIG. 62, once the mesh network has been formed between the tow vehicle and the various proximate beacons, at step 1102, the relative locations, orientations, and movement information of (e.g., the relative positioning between) the tow vehicle, the aircraft being moved, and/or the airport objects associated with the proximate beacons connected to the mesh network are identified, at step 1104. For example, as the tow vehicle (e.g., the tractor 10, the tow vehicle 1126) moves the aircraft (e.g., the airplane 2, the aircraft 1128) through the airport environment and forms the mesh network with various beacons, the controller 402 is configured to continuously determine a distance and direction from the tow vehicle to each detected and connected beacon (e.g., beacons 1122). In some embodiments, in the case of beacons associated with moving objects (e.g., any of the vehicles and/or aircraft discussed herein), the controller 402 is further configured to continuously determine various movement information (e.g., speed, direction of travel, etc.) associated with the beacons. The controller 402 is further configured to determine a relative orientation of each beacon (e.g., the beacon 1122) and/or its corresponding object (e.g., the airport object 1124) with respect to the tow vehicle. The orientation with respect to the tow vehicle may include a respective rotational orientation and/or a respective height orientation (e.g., high or lower) with respect to the tow vehicle.

For example, in some instances, the controller 402 may communicate with one or more beacons (e.g., the beacons 1122) and/or a centralized database (e.g., an aircraft location database, the ADS-B database, the server 410) to determine the relative locations and orientations of (e.g., the relative positioning between) the beacons and/or their associated objects (e.g., the airport objects 1124). For example, each beacon may have a corresponding beacon identifier that may be communicated from the beacon to the tow vehicle (e.g., upon formation of the mesh network). The tow vehicle may then transmit (e.g., via the communications network 420) the beacon identifier to the centralized database to query the centralized database for a variety of locational and orientational information pertaining to the detected beacon and/or dimensional and shape information regarding the beacon's corresponding object.

In some instances, in addition or alternative to having a beacon identifier associated therewith, each beacon may be configured to store in memory and communicate to the tow vehicle (e.g., upon formation of the mesh network) the same or similar locational, orientational, dimensional, and/or shape information pertaining to the corresponding beacon and/or the beacon's corresponding object. In some instances, in addition to the locational, orientational, dimensional, and/or shape information, beacons associated with moving objects may additionally communicate real-time or near-real-time movement information (e.g., current speed, current direction, an intended travel route, etc.) to the tow vehicle.

Accordingly, in some embodiments, the controller 402 is configured to determine the relative location, orientation, and movement information of (e.g., the relative positioning between) each beacon and corresponding object by detecting the direction and distance from the tow vehicle to the beacon, detecting the speed and direction of movement of the beacon, and utilizing the locational, orientational, dimensional, and/or shape information obtained regarding the beacon and/or the corresponding object. In some embodiments, the tow vehicle may be additionally or alternatively configured to triangulate its position with respect to two or more meshed, stationary beacons based on the same or similar information.

In a similar manner to that described above, with respect to FIGS. 48 and 49 and the discussion surrounding aircraft recognition, the controller 402 can recognize the type of aircraft being moved thereby and utilize that information and/or a mesh network formed between beacons of the aircraft and tow vehicle (e.g., a beacon 1122 of the aircraft 1128 and a beacon 1122 of the tow vehicle 1126) and corresponding locational and orientational information pertaining to the beacons and/or dimensional and shape information pulled from the centralized database discussed above to determine the relative location, orientation, and movement information of the aircraft with respect to both the tow vehicle (e.g., based on any of the detected aspects and/or other sensor data described herein for determining the orientation of the airplane 2 with respect to the tractor 10) and the various beacons and/or corresponding objects associated with those beacons (e.g., based on the determined orientation of the airplane 2 with respect to the tractor 10 and the orientation of the beacons and/or objects with respect to the tractor 10).

Once the relative locations, orientations, and movement information of (e.g., the relative positioning between) the tow vehicle, the aircraft, and/or the airport objects associated with the beacons connected to the mesh network have been identified, at step 1104, various perimeters and/or geofences are created around the tow vehicle, the aircraft, and/or the various airport objects, at step 1106.

For example, based on the relative locations, the orientations, the dimensional, and/or the shape information associated with each of the tow vehicle, the aircraft, and/or the airport objects, the controller 402 and/or the server 410 automatically create perimeters or geofences using a determined outer profile (e.g., silhouette) of each of the tow vehicle 1126, the aircraft 1128, and/or the various other airport objects. In some embodiments, the perimeters or geofences may be created to fully envelop the corresponding object and may be a predetermined amount (e.g., one foot, five feet, twenty feet, five percent, ten percent) larger than the outer profile (e.g., extended outward from the outer profile) to provide a buffer area between the perimeter or geofence and the actual outer surface of the corresponding object. In some instances, the amount by which the size of the perimeter or geofence exceeds the outer profile of each object may be set or selected by a user (e.g., via the operator interface 48 or a user device associated with the server 410) having approved credentials to adjust the buffer area size. In some instances, the amount by which the size of the perimeter or geofence exceeds the outer profile of each object varies based on the object. For example, in some instances, the geofence for a more valuable or important object or vehicle may exceed its outer profile by more than the geofence for a less valuable or important object (e.g., greater for an aircraft 1128 than a light pole 1132).

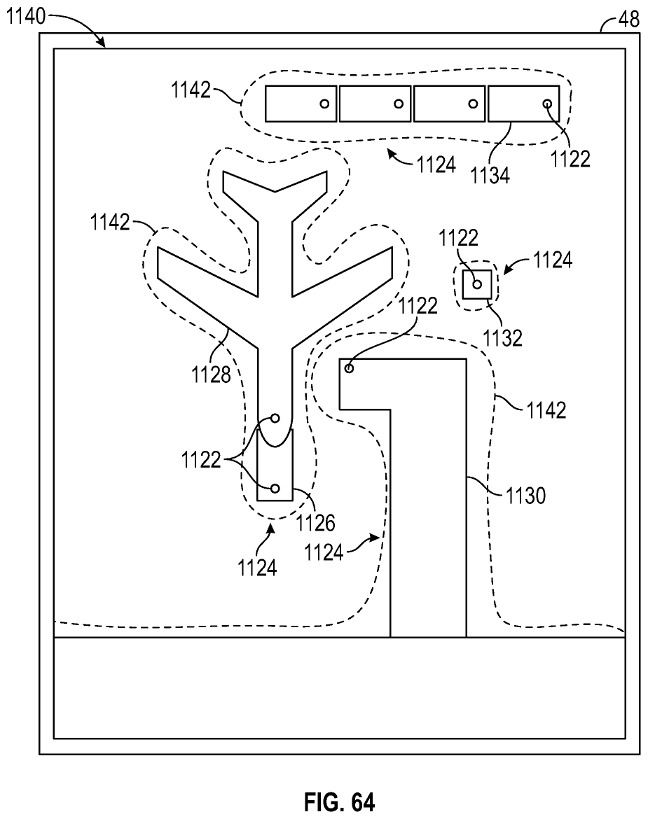

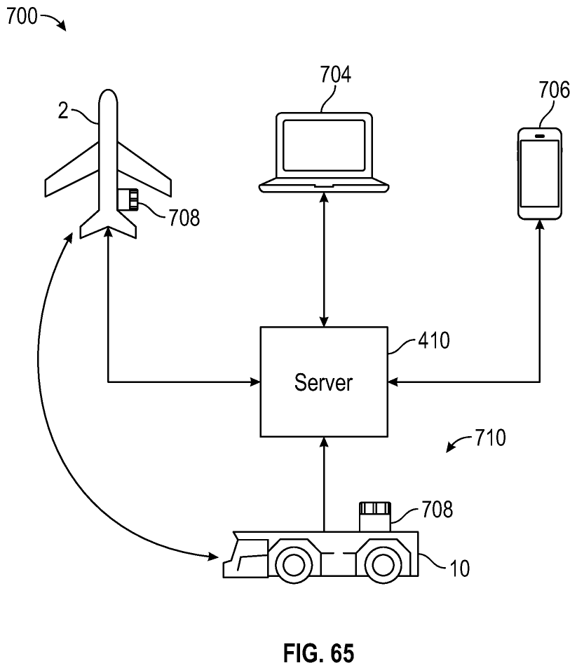

In some embodiments, a graphical user interface depicting the tow vehicle, the aircraft, and the airport objects is generated and displayed, at step 1108. For example, with reference to FIG. 64, an exemplary embodiment of a user interface 1140 is generated and displayed on a display of the operator interface 48. It should be appreciated that the same or a similar user interface may be generated and displayed on other devices (e.g., a device associated with the server 410, such as the node or portal 704 and/or the user device 706 described below, with reference to FIG. 65). It should also be appreciated that the user interface 1140 is provided as an example and is not meant to be limiting.

As illustrated, the user interface 1140 includes a depiction of a scene surrounding the tow vehicle 1126 (e.g., the tractor 10) including the various surrounding airport objects 1124. That is, by determining the distance and direction of each beacon and obtaining the corresponding locational, orientational, dimensional, and/or shape information associated with each of the beacons 1122 and their corresponding airport objects 1124, the controller 402 and/or the server 410 can generate a visual depiction of how the tow vehicle 1126 (e.g., the tractor 10) is situated (e.g., located, oriented, etc.) with respect to its surroundings and display the depiction via the user interface 1140. In some instances, the controller 402 and/or the server may further include depictions of the created perimeters or geofences 1142 around each of the tow vehicle 1126, the aircraft 1128, and the other corresponding airport objects.

With reference again to FIG. 62, once the perimeters or geofences have been created, at step 1106, and/or the user interface has been generated and displayed, at step 1108, the controller 402 and/or the server 410 at least partially control the tow vehicle (e.g., the tractor 10) to prevent or attempt to prevent the tow vehicle and the aircraft from colliding with any airport objects. For example, in some embodiments, the controller 402 and/or the server 410 are configured to constantly monitor the location, movement information, and created perimeter or geofence of the tow vehicle (e.g., the tractor 10) and the aircraft (e.g., the airplane 2) and, if either of the corresponding perimeter or geofence contacts or overlaps with or, based on the movement information associated with the tow vehicle, aircraft, and/or any other airport objects, will contact or overlap with any other perimeter or geofence of any other airport objects, the controller 402 and/or the server 410 is configured to perform one or more collision avoidance operations.

For example, in some instances, the controller 402 and/or the server 410 may automatically stop the tow vehicle (e.g., via the braking system 60) and/or autonomously guide the tow vehicle away from the other airport object (e.g., via activation of the prime mover 52 and/or automated control of the steering wheel 42). That is, the controller 402 and/or the server 410 may take full or partial control of the tow vehicle to prevent collisions. In some instances, the controller 402 and/or the server 410 may additionally or alternatively provide a notification to the user providing instructions for the user to follow to avoid a collision. For example, the notification may instruct the user to reduce the speed of the tow vehicle, to turn a specific direction, to follow a given travel path, etc. In some instances, the controller 402 and/or the server 410 may additionally or alternatively provide haptic feedback to the user (e.g., vibrating the steering wheel 42), audible feedback (e.g., an audible alarm, audible instructions), and/or visual feedback (e.g., a warning light, a displayed path on a display of the tow vehicle, etc.) to aid the user in avoiding collisions.

### GSE Coordination System

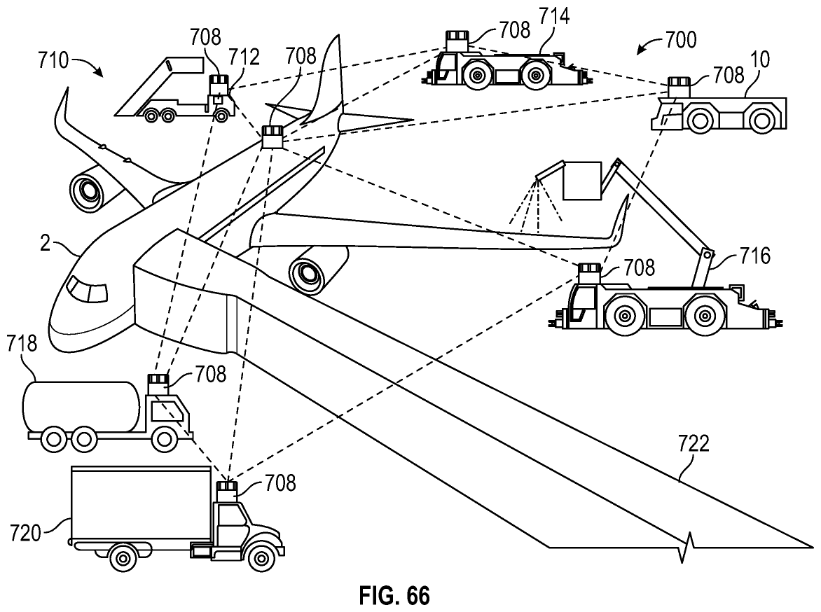

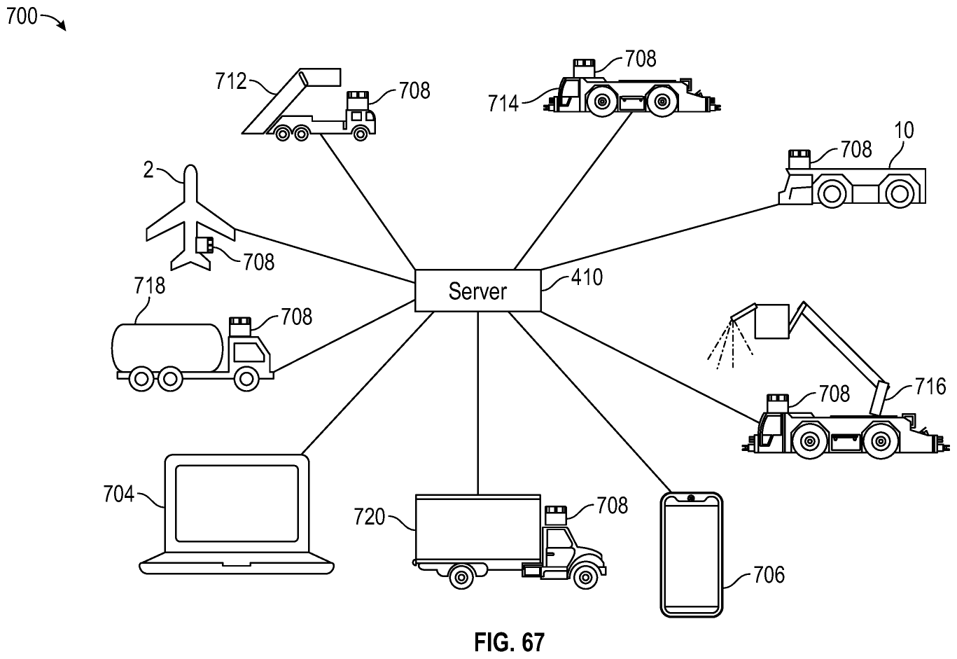

As shown in FIGS. 65-67, a vehicle coordination system, shown as GSE coordination system 700, is used to coordinate motion and procedures of vehicles, machines, and/or equipment, shown as GSE 710, used to service or support the airplane 2 and airport operations. The GSE coordination system 700 includes the airplane 2, a node or portal 704, a user device 706, beacon(s) 708, and the GSE 710. Referring to FIG. 65, the GSE 710 includes the tractor 10 with the beacon 708 coupled thereto. Although the GSE 710 is shown in FIG. 65 to include only the tractor 10 and the beacon 708, it should be appreciated that the GSE coordination system 700 may be used to facilitate communication between any of the GSE 710 used during service or support of the airplane 2 and airport operations (e.g., any of the plurality of vehicles shown in FIGS. 66 and 67). For example, the service or support of the airplane 2 and the airport operations may include any of passenger boarding, bridge docking, cargo loading/unloading, baggage loading/unloading, pushback, towing, de-icing, food delivery, fueling, etc. Accordingly, as shown in FIGS. 66 and 67, the GSE 710 can include any of the tractor 10, a cargo loader 712, a baggage tractor 714, a de-icing truck 716, a fueling truck 718, a food delivery truck 720, and/or a boarding bridge 722, among other possible GSE used to service or support the airplane 2 and airport operations (e.g., a dolly tractor, a dolly, a baggage loader, a stair truck, etc.).

As described above, the tractor 10 is used for one or more operations at an airport including pushing the airplane 2 during pushback operations (e.g., departing from a gate), towing the airplane 2 between locations (e.g., between gates, hangars, fueling areas, maintenance areas, de-icing areas, etc.), positioning the airplane 2 (e.g., into proper alignment at a gate with a bridge), and/or other operations. The cargo loader 712 is used to load and unload cargo, baggage, freight, etc., onto and off of the airplane 2. For example, the cargo loader 712 may include an extendable portion configured to reach a storage opening of the airplane 2 such that airport personnel and/or another facilitator of the aircraft servicing process can load cargo, baggage, freight, etc. onto the airplane 2 through the storage opening.

The baggage tractor 714 is used to transport cargo, baggage/baggage carts, freight, etc., around an airport during the aircraft servicing process. For example, the baggage tractor 714 may be used to transport baggage from the airplane 2 (e.g., baggage that was unloaded from the airplane 2 using the cargo loader 712) to a baggage claim at an airport terminal. The de-icing truck 716 is used to remove snow, ice, frost, etc. from the airplane 2 (e.g., from the wings, fuselage, control surfaces, etc.) prior to takeoff. The fueling truck 718 transports fuel between locations (e.g., from a fueling station to a departure gate) and provides the fuel to the airplane 2. The food delivery truck 720 is used to transport food, beverages, and other in-flight service items to the airplane 2. The food delivery truck 720 may arrive at the gate of the airplane 2 prior to takeoff to ensure that the airplane 2 is stocked with enough food, beverages, and other supplies to sustain passengers for a duration of an upcoming flight. The boarding bridge 722 is a covered walkway that connects the airplane 2 to an airport terminal. The boarding bridge 722 therefore allows passengers to enter the airport terminal from the airplane 2 without having to go outside or use stairs. In some implementations, the boarding bridge 722 is replaced with or supplemented by a stair truck.

As shown in FIGS. 65-67, the beacons 708 may be coupled to each of the GSE 710 and/or to the airplane 2. The beacons 708 may facilitate the coordination of the GSE 710 by transmitting data/information relating to the GSE 710 and/or the airplane 2 (e.g., a location, an operational status, an order of tasks in a servicing procedure, etc.) over the GSE coordination system 700 (e.g., via the server 410, directly between the beacons 708, etc.). For example, as shown in FIG. 65, data/information relating to the airplane 2 and the tractor 10 may be communicated via the server 410 and/or directly between the beacons 708 such that motion of the airplane 2 and the tractor 10 may be coordinated based on the data/information communicated over the GSE coordination system 700. That is, the coordination may include tracking a location of the tractor 10 relative to the airplane 2 via the beacons 708 such that the tractor 10 does not hit the airplane 2 (e.g., during approach for pushback operations). In some embodiments, the data/information may be communicated via the server 410 to the node or portal 704 and/or to the user device 706 such that the motion of the airplane 2 and/or the tractor 10 can be coordinated via the node or portal 704 and/or the user device 706. For example, a remote user may control one or more functions of the tractor 10 via the user device 706. As another example, the node or portal 704 may be configured to automatically initiate one or more functions of the tractor 10 based on the data/information communicated using the GSE coordination system 700. In embodiments where the beacons 708 communicate directly with one another rather than via the server 410 (e.g., as shown in FIG. 66), the beacons 708 may be configured to communicate with each other via a mesh communication network.

As shown in FIGS. 65 and 67, the GSE coordination system 700 may be configured to communicate information from each of the beacons 708 of the GSE 710 via the server 410. As described above, the server 410 may perform all or portions of the processes performed by the controller 402. For example, the server 410 may be configured to facilitate operator access to dashboards including the aircraft data, the tractor data, the image data, information available to the controller 402, etc. to manage and operate the tractor 10. In some embodiments, however, the processes described herein to manage and operate the tractor 10 may similarly be performed to manage and operate any of the GSE 710. That is, the server 410 may be used to coordinate the motion of the GSE 710 by communicating the motion, status, condition, etc. of the plurality of vehicles included in the GSE 710 amongst each other. For example, each of the plurality of vehicles included in the GSE 710 may include sensors (e.g., similar and/or identical to the sensors 430 and/or the vision system 450, as described above). Data from the sensors relating to each vehicle included in the GSE 710 may be communicated to other vehicles in the GSE 710 from the beacons 708 via the server 410 to coordinate the motion of the GSE 710.

Based on the data relating to the GSE 710 communicated via the server 410 (as shown in FIGS. 65 and 67) and/or the mesh communication network (e.g., as shown in FIGS. 65 and 66), the GSE coordination system 700 may be further configured to coordinate the motion of each of the plurality of vehicles included in the GSE 710. In some embodiments, the beacons 708 provide signals to at least one of the airplane 2, the node or portal 704, the user device 706, the tractor 10, and/or another observer. The signals indicate a status or condition of a vehicle (e.g., power on, power off, in operation, fuel level, electrical system state of charge, DTC, maintenance required, location, speed, direction of travel, etc.). In some embodiments, the status or condition may be communicated via the server 410. In some embodiments (e.g., when providing a signal to an observer), the beacon 708 may be a vehicle component or a separate device attached to the vehicle (e.g., a vehicle external light, a vehicle internal light, etc.). The beacon 708 may include a light (e.g., an incandescent light, a LED, a fixed beacon, a flashing beacon, a rotating beacon, a laser, a light array, etc.), a display device, a marker, etc. In some examples, the beacon 708 may incorporate an audible indicator of a vehicle status or condition. In such embodiments, the beacon 708 emits an audible signal indicating the vehicle status or condition, and the audible signal may be acquired by the sensors (e.g., similar and/or identical to the sensors 430, as described above) of each of the plurality of vehicles included in the GSE 710. For example, the sensors 430 may include a microphone configured to detect an audible signal emitted by the beacon 708.

The beacon 708 may be configured to generate a variety of visual signals. In some examples, the variety of visual signals comprises one or more colors, patterns, and combinations of colors and patterns. In some examples, the beacon 708 is configured to generate visual signals observable as a light or one or more light patterns. In some examples, the light patterns generated by the beacon 708 can be varied in any optical characteristic (e.g. color, wavelength, intensity, pulse duration, direction, etc.). The visual signals generated by the beacon 708 show various states, conditions, and criteria of the GSE 710 to which the beacon 708 is coupled (e.g., the airplane 2, the tractor 10, any of the other GSE 710 depicted in FIGS. 66 and 67, etc.). The visual signals may indicate, for example, that one or more vehicles involved in the aircraft servicing process have completed a designated task. In other examples, the visual signals generated by the beacon 708 indicate predefined or user configurable vehicle conditions for the local identification of that condition. For example, a fueling truck (e.g., fueling truck 718) may cause the beacon 708 to emit a visual signal indicating that it requires a refill of fuel. In some embodiments, the visual signal may be initiated in response to a command entered by a user at the user device 706, a remote user command, a vehicle-to-vehicle command, a condition or state detected by a vehicle sensor (e.g., the sensors 430, the vision system 450, etc.), or a controller 402 logic determination. The visual signals emitted by the beacon 708 may be acquired by the sensors (e.g., similar and/or identical to the sensors 430 and/or the vision system 450, as described above) of each of the plurality of vehicles included in the GSE 710. For example, the sensors 430 may include a camera configured to detect a visual signal emitted by the beacon 708.

In some embodiments, the vehicle sensors detect a state or condition of a vehicle (e.g., the GSE 710). The GSE coordination system 700 determines a command via the server 410 and/or directly via the GSE 710 (e.g., via the mesh communication network) for the beacon 708 to display one or more visual signals. In some embodiments, the beacon 708 illuminates a colored light signal corresponding to the vehicle state or condition. For example, a GSE supervisor may select green to indicate that a vehicle in the GSE 710 has completed its respective task, and yellow to indicate that a vehicle in the GSE 710 is in the process of completing its respective task. In another example, a service technician may transmit a wireless command to all vehicles included in the GSE 710 to flash a red light if the server 410 and/or the beacons 708 receives an indication of a malfunction of any vehicle included in the GSE 710. In some embodiments, motion of a remainder of the GSE 710 may be coordinated based on the signal transmitted by the beacon 708 of a particular component of the GSE 710. For example, in response to a signal from one component of the GSE 710 that the one component is in the process of completing its respective task, the remainder of the GSE 710 may be programmed (e.g., remotely via the node or portal 704 and/or user device 706, locally via a controller located internal to the GSE 710, etc.) to perform respective tasks in a particular order following the completion of the task by the one component of the GSE 710. In some embodiments, each of the respective tasks may be automatically initiated according to the particular order.

Each of the plurality of vehicles included in the GSE 710 may be configured to respond to a signal received from the beacons 708 and/or to the information received via the server 410 by coordinating motion/operation accordingly. For example, the signal and/or the information may include location information, movement information, task status or progress information, etc. of one or more other vehicles in the GSE 710. Based on the location information, movement information, task status or progress information, etc., the remainder of the vehicles in the GSE 710 may be configured to coordinate movement to avoid collisions with and/or obstructions to the one or more other vehicles during aircraft servicing and to perform the servicing in the most efficient manner possible.

In some embodiments, operational assistance is provided (e.g., to an operator via the operator interface 48, to the controller 402) to direct the GSE 710 on specific paths to perform respective tasks during the aircraft servicing without obstructing any other vehicles in the GSE 710. Additionally or alternatively, the operational assistance is provided with instructions regarding when a respective vehicle in the GSE 710 can perform its respective task and/or move around the airplane 2 without obstructing other vehicles and/or in accordance with an aircraft servicing plan, strategy, or protocol. In some embodiments, instructions are provided to a user/operator of a respective vehicle of the GSE 710 and/or personnel involved in the aircraft servicing (e.g., via the operator interface 48, the user device 706, etc.). In some embodiments, the instructions are configured to cause a respective vehicle of the GSE 710 to autonomously or semi-autonomously operate according to the instructions (e.g., the vehicle may automatically embark on the designated path, automatically move at a time specified by the instructions, perform an instructed task, etc.). The operational assistance may be further configured to prevent movement/operation of a vehicle in response to the signal received from the beacon 708 and/or to the information received via the server 410. In some embodiments, a vehicle in the GSE 710 may be locked, turned off, and/or otherwise prevented from moving/operating in a vicinity of another vehicle in the GSE 710. For example, the baggage tractor 714 may be prevented from moving proximate the airplane 2 while the de-icing truck 716 is in operation.

Accordingly, the GSE coordination system 700 is configured to coordinate the various airport operations of the GSE 710 that need to be performed to service and prepare an aircraft for a flight (e.g., including passenger boarding, bridge docking, cargo loading/unloading, baggage loading/unloading, pushback, towing, de-icing, food delivery, fueling, etc.) to facilitate efficient servicing of the aircraft. Such coordination may cause the GSE 710 to follow certain paths to facilitate collision avoidance and facilitate efficient movements, perform tasks at certain designated times according to a servicing protocol (e.g., certain tasks may need to be performed before others), and minimize the amount of time necessary to service the aircraft by continuously monitoring task progress and understanding where and when each vehicle of the GSE 710 should be at all times. In some embodiments, the vehicle-to-vehicle mesh network communication via the beacons 708 is utilized to coordinate motions between the GSE 710 for collision avoidance purposes, while the server 410 manages the overall aircraft servicing plans and transmits task specific instructions to each GSE 710 (e.g., a certain path to take, a certain time to start task, etc.). The GSE coordination system 700 may, therefore, minimize the amount of time required to service an aircraft, allowing more flight departures to be on time and lead to enhanced customer satisfaction. Also, the GSE coordination system 700 may prevent or minimize collisions between the GSE 710 and/or with the airplane 2, reducing vehicle/aircraft downtime and repair/maintenance expenses.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the tractor 10 and the systems and components thereof as shown in the various exemplary embodiments is illustrative only. Additionally, any element disclosed in one embodiment may be incorporated or utilized with any other embodiment disclosed herein.

1. A vehicle for towing an airplane, the vehicle comprising:
a chassis;
a body coupled to the chassis, the body and the chassis having a first side and a second side opposite the first side;
a tractive assembly;
a tow mechanism configured to engage with a nose landing gear of the airplane;
a light system including:
a first lighting element positioned along the first side; and
a second lighting element positioned along the second side; and
a control system configured to:
monitor a direction of travel of the vehicle; and
control operation of the light system to selectively illuminate the first lighting element and the second lighting element to provide an indication of the direction of travel of the vehicle, thereby making the direction of travel of the vehicle perceivable to an operator positioned outside of the vehicle.

2. The vehicle of claim 1, wherein the tractive assembly includes a front tractive assembly and a rear tractive assembly, and wherein the first lighting element and the second lighting element extend longitudinally between the front tractive assembly and the rear tractive assembly.

3. The vehicle of claim 1, wherein each of the first lighting element and the second lighting element include a housing and a plurality of lights disposed within the housing to form a light bar.

4. The vehicle of claim 1, wherein the first lighting element defines a first length, wherein the second lighting element defines a second length, and wherein the control system is configured to control operation of the light system to progressively illuminate the first lighting element and the second lighting element along the first length and the second length, respectively, to provide the indication of the direction of travel of the vehicle.

5. The vehicle of claim 1, wherein the first lighting element includes a first front portion and a first rear portion, wherein the second lighting element includes a second front portion and a second rear portion, wherein the control system is configured to control operation of the light system to illuminate at least one of the first front portion of the first lighting element or the second front portion of the second lighting element to provide the indication of the vehicle traveling forwards, and wherein the control system is configured to control operation of the light system to illuminate at least one of the first rear portion of the first lighting element or the second rear portion of the second lighting element to provide the indication of the vehicle traveling backwards.

6. The vehicle of claim 1, wherein the indication is a first indication, and wherein the control system is configured to control operation of the light system to selectively illuminate the first lighting element and the second lighting element to provide a second indication indicative of a mode of operation of the vehicle.

7. The vehicle of claim 1, wherein the indication is a first indication, wherein the control system is configured to control operation of the light system to selectively illuminate the first lighting element and the second lighting element to provide a second indication, wherein the control system is configured to control the vehicle in a first mode of operation and the second indication is indicative of the first mode of operation, wherein the control system is configured to control the vehicle in a second mode of operation, and wherein the control system is configured to control operation of the light system to selectively illuminate the first lighting element and the second lighting element to provide a third indication indicative of the second mode of operation, the third indication different from the second indication.

8. The vehicle of claim 7, wherein the first lighting element and the second lighting element are configured to illuminate in (i) a first color or pattern to provide the second indication (ii) a second color or pattern to provide the third indication, the second color or pattern different from the first color or pattern.

9. The vehicle of claim 1, further comprising a user interface, wherein the control system is configured to control operation of the light system to selectively illuminate the first lighting element and the second lighting element in response to receiving an input to the user interface.

10. The vehicle of claim 9, wherein the user interface includes a steering wheel configured to steer the tractive assembly, wherein the control system is configured to control operation of the light system to illuminate the first lighting element in response to a first input to the steering wheel to steer the vehicle in a first direction, and wherein the control system is configured to control operation of the light system to illuminate the second lighting element in response to a second input to the steering wheel to steer the vehicle in a second direction.

11. The vehicle of claim 1, wherein the control system is configured to control operation of the light system to selectively illuminate the first lighting element in a first color or pattern to provide the indication, and wherein the control system is configured to control operation of the light system to selectively illuminate the second lighting element in a second color or pattern to provide the indication, the second color or pattern different from the first color or pattern.

12. A vehicle system comprising:
one or more processing circuits configured to:
monitor a direction of travel of a tow vehicle configured to tow an airplane, the tow vehicle including a body having a first side and a second side opposite the first side, a first lighting element positioned along or proximate the first side of the body, and a second lighting element positioned along or proximate the second side of the body; and
selectively illuminate the first lighting element and the second lighting element to provide a first indication of the direction of travel of the tow vehicle and a second indication of a mode of operation of the tow vehicle.

13. The vehicle system of claim 12, wherein the mode of operation includes at least one of an autonomous driving mode, a remote control mode, or a manual drive mode.

14. The vehicle system of claim 12, wherein the first lighting element defines a first length, wherein the second lighting element defines a second length, and wherein the one or more processing circuits are configured to progressively illuminate the first lighting element and the second lighting element along the first length and the second length, respectively, to provide the first indication of the direction of travel of the tow vehicle.

15. The vehicle system of claim 12, wherein the first lighting element includes a first front portion and a first rear portion, wherein the second lighting element includes a second front portion and a second rear portion, wherein the one or more processing circuits are configured to selectively illuminate at least one of the first front portion of the first lighting element or the second front portion of the second lighting element to provide the first indication of the tow vehicle traveling forwards, and wherein the one or more processing circuits are configured to selectively illuminate at least one of the first rear portion of the first lighting element or the second rear portion of the second lighting element to provide the first indication of the tow vehicle traveling backwards.

16. The vehicle system of claim 12, wherein the one or more processing circuits are configured to selectively illuminate the first lighting element in a first color or pattern to provide the first indication, and wherein the one or more processing circuits are configured to selectively illuminate the second lighting element in a second color or pattern to provide the first indication, the second color or pattern different from the first color or pattern.

17. The vehicle system of claim 12, wherein the one or more processing circuits are configured to selectively illuminate the first lighting element and the second lighting element in a first color or pattern to provide the first indication, and wherein the one or more processing circuits are configured to selectively illuminate the first lighting element and the second lighting element in a second color or pattern to provide the second indication, the second color or pattern different from the first color or pattern.

18. The vehicle system of claim 12, wherein the one or more processing circuits include at least one of (i) a first processing circuit located on the tow vehicle or (ii) a second processing circuit located remote from the tow vehicle.

19. An airport ground support equipment comprising:
a chassis;
a body coupled to the chassis, the body and the chassis having a first side and a second side opposite the first side;
a front tractive assembly;
a rear tractive assembly, wherein at least one of the front tractive assembly or the rear tractive assembly is a steerable tractive assembly;
a light system including:
a first lightbar extending longitudinally along the first side between the front tractive assembly and the rear tractive assembly, the first lightbar including a first housing and a first plurality of lights disposed within the first housing; and
a second lightbar extending longitudinally along the second side between the front tractive assembly and the rear tractive assembly, the second lightbar including a second housing and a second plurality of lights disposed within the second housing; and
a control system configured to:
monitor a direction of travel of the airport ground support equipment; and
control operation of the light system to selectively illuminate the first lightbar in a first color or pattern and the second lightbar in a second color or pattern to provide an indication of the direction of travel of the airport ground support equipment.

20. The airport ground support equipment of claim 19, wherein the indication is a first indication, wherein the control system is configured to control the airport ground support equipment in an autonomous mode of operation, wherein the control system is configured to control operation of the light system to selectively illuminate the first lightbar and the second lightbar to provide a second indication indicative of the autonomous mode of operation, wherein the control system is configured to control the airport ground support equipment in a remote control mode of operation, wherein the control system is configured to control operation of the light system to selectively illuminate the first lightbar and the second lightbar to provide a third indication indicative of the remote control mode of operation, wherein the control system is configured to control the airport ground support equipment in a manual drive mode, wherein the control system is configured to control operation of the light system to selectively illuminate the first lightbar and the second lightbar to provide a fourth indication indicative of the manual drive mode, and wherein the second indication, the third indication, and the fourth indication each being different from each other.
